(19) United States
(12) Patent Application Publication
(10) Pub. No.: US 2013/0195188 A1
(43) Pub. Date: Aug. 1, 2013

(54) IMAGE CODING METHOD, IMAGE CODING APPARATUS, IMAGE DECODING METHOD, IMAGE DECODING APPARATUS, AND IMAGE CODING AND DECODING APPARATUS

(71) Applicant: PANASONIC CORPORATION, Osaka (JP)

(72) Inventors: Toshiyasu SUGIO, Osaka (JP); Takahiro NISHI, Nara (JP); Youji SHIBAHARA, Osaka (JP); Kyoko TANIKAWA, Osaka (JP); Hisao SASAI, Osaka (JP); Toru MATSUNOBU, Osaka (JP); Kengo TERADA, Osaka (JP)

(73) Assignee: PANASONIC CORPORATION, Osaka (JP)

(21) Appl. No.: 13/749,012

(22) Filed: Jan. 24, 2013

Related U.S. Application Data
(60) Provisional application No. 61/590,928, filed on Jan. 26, 2012.

(51) Int. Cl. H04N 7/26

(52) U.S. Cl. CPC H04N 19/00721
USPC 375/240.14

(57) ABSTRACT

An image coding method with increased coding efficiency using a limited memory bandwidth includes: determining blocks usable for merging as merging candidates; determining a block to be used for coding a current block to be coded from the merging candidates; and attaching a merging candidate index indicating the determined merging candidate to the bitstream. In the determining of a block, when a motion compensation size of the current block is a bi-prediction-prohibited size and the merging candidates include a merging candidate coded using bi-prediction, a prediction image of the current block is generated using coding information for uni-prediction instead of coding information for the bi-prediction of the merging candidate coded using bi-prediction.

### CROSS REFERENCE TO RELATED APPLICATION

The present application claims the benefit of U.S. Provisional Patent Application No. 61/590,928 filed Jan. 26, 2012. The entire disclosure of the above-identified application, including the specification, drawings and claims are incorporated herein by reference in their entirety.

### FIELD

The present disclosure relates to an image coding method and an image decoding method.

### BACKGROUND

Generally, in coding processing of a moving picture, the amount of information is reduced by compression for which temporal redundancy and spatial redundancy in the moving picture is utilized. Generally, transform into frequency domain is performed as a method in which spatial redundancy is utilized, and coding using prediction between pictures (the prediction is hereinafter referred to as inter prediction) is performed as a method of compression for which temporal redundancy is utilized. In the inter prediction coding, a current picture is coded using a coded picture preceding or following the current picture in display order as a reference picture. A motion vector is derived by estimating a motion of the current picture with respect to the reference picture. Then, difference between image data of the current picture and prediction image data obtained by motion compensation based on the derived motion vector is calculated to reduce temporal redundancy (see Non-patent Literature 1 for an example). In the motion estimation, difference values between a current block in the current picture and blocks in the reference picture are calculated, and a block having the smallest difference value in the reference picture is determined as a reference block. Then, a motion vector is derived using the current block and the reference block.

### CITATION LIST

### Non Patent Literature

[Non-patent Literature 1] ITU-T Recommendation H.264 “Advanced video coding for generic audiovisual services”, March 2010

### SUMMARY

### Technical Problem

In recent years, broadcasting or distribution of high-resolution content having a resolution of 4K×2K has been being planned, which requires coding efficiency higher than those of image coding schemes already standardized.

In view of this, non-restrictive and exemplary embodiments are described herein to provide an image coding method and an image decoding method by which coding efficiency in image coding and image decoding is increased.

### Solution to Problem

An image coding method according to an aspect of the present disclosure is an image coding method of merging, into coding information of a current block to be coded in a moving picture, coding information of a coded block which is one of blocks in the moving picture and is other than the current block, to code the current block, the coding information including a motion vector and a reference picture index. The method includes: determining one or more blocks usable for the merging as one or more merging candidates, based on a spatial position or a temporal position of the current block; generating, for each of the merging candidates, a prediction image of the current block using coding information of the merging candidate and comparing costs of the prediction images to determine a block to be used for coding the current block from the one or more merging candidates; coding the current block using the coding information of the block determined in the generating of a prediction image to generate a bitstream including the coded current block; and attaching, to the bitstream, a merging candidate index indicating the block determined in the generating of a prediction image, wherein in the generating of a prediction image, when a motion compensation size of the current block is a bi-prediction-prohibited size and the one or more merging candidates include a merging candidate coded using bi-prediction with reference to two pictures, the prediction image of the current block is generated using coding information for uni-prediction of the merging candidate coded using bi-prediction instead of coding information for the bi-prediction of the merging candidate coded using bi-prediction, the uni-prediction being performed with reference to one picture.

It should be noted that these general or specific aspects can be implemented as a system, a method, an integrated circuit, a computer program, a computer-readable recording medium such as a compact disc read-only memory (CD-ROM), or as any combination of a system, a method, an integrated circuit, a computer program, and a computer-readable recording medium.

Additional benefits and advantages of the disclosed embodiments will be apparent from the Specification and Drawings. The benefits and/or advantages may be individually obtained from the various embodiments and features disclosed in the Specification and Drawings, which need not all be provided in order to obtain one or more of such benefits and/or advantages.

### Advantageous Effects

According to an aspect of the present disclosure, coding efficiency can be achieved.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1A is a diagram for illustrating an exemplary reference picture list for a B-picture.

FIG. 1B shows an example of a reference picture list 0 for a prediction direction 0 of a B-picture.

FIG. 1C shows an example of a reference picture list 1 for a prediction direction 1 of a B-picture.

FIG. 2 is a diagram for illustrating motion vectors for use in the temporal motion vector prediction mode.

FIG. 3 shows an exemplary motion vector of a neighboring block for use in the merging mode.

FIG. 4 is a diagram for illustrating an exemplary merging block candidate list.

FIG. 5 shows a relationship between the size of a merging block candidate list and bit sequences assigned to merging block candidate indices.

FIG. 6 is a flowchart showing an example of a process for coding of a current block using the merging mode.

FIG. 7 shows an exemplary configuration of an image coding apparatus which codes images using the merging mode.

FIG. 8 is a flowchart showing an example of a process for decoding using the merging mode.

FIG. 9 shows an exemplary configuration of an image decoding apparatus which decodes images coded using the merging mode.

FIG. 10 shows syntax for attachment of a merging block candidate index to a bitstream.

FIG. 11 is a block diagram showing a configuration of an image coding apparatus according to Embodiment 1.

FIG. 12 is a flowchart showing processing operations of the image coding apparatus according to Embodiment 1.

FIG. 13 shows an exemplary merging block candidate list according to Embodiment 1.

FIG. 14 is a flowchart showing details of a process performed by a bi-prediction-prohibited size determination unit according to Embodiment 1.

FIG. 15 is a flowchart showing details of the process in Step S102 in FIG. 12 according to Embodiment 1.

FIG. 16 is a flowchart showing details of a process in Step S121 in FIG. 15 according to Embodiment 1.

FIG. 17 is a flowchart showing details of a process in Step S124 in FIG. 15 according to Embodiment 1.

FIG. 18 is a flowchart showing details of a process in Step S103 in FIG. 12 according to Embodiment 1.

FIG. 19 is a flowchart showing details of a process in Step S153 in FIG. 18 according to Embodiment 1.

FIG. 20 is a flowchart showing details of a process in Step S153 in FIG. 18 according to Embodiment 1.

FIG. 21 is a block diagram showing a configuration of an image decoding apparatus according to Embodiment 2.

FIG. 22 is a flowchart showing processing operations of the image decoding apparatus according to Embodiment 2.

FIG. 23 is a flowchart showing details of a process in Step S203 in FIG. 22 according to Embodiment 2.

FIG. 24 is a flowchart showing details of a process in Step S205 in FIG. 22 according to Embodiment 2.

FIG. 25 is a flowchart showing details of a process in Step S206 in FIG. 22 according to Embodiment 2.

FIG. 26 shows exemplary syntax for attachment of a merging block candidate index to a bitstream according to Embodiment 2.

FIG. 27 shows exemplary syntax in the case where the size of a merging block candidate list is fixed at a maximum value of the total number of merging block candidates according to Embodiment 2.

FIG. 28 is a block diagram showing a configuration of an image coding apparatus according to Embodiment 3.

FIG. 29 is a flowchart showing processing operations of the image coding apparatus according to Embodiment 3.

FIG. 30 is a flowchart showing details of the process in Step S172 in FIG. 29 according to Embodiment 3.

FIG. 31 is a flowchart showing details of the process in Step S182 in FIG. 30 according to Embodiment 3.

FIG. 32 is a flowchart showing details of the process in Step S182 in FIG. 30 according to Embodiment 3.

FIG. 33 is a block diagram showing a configuration of an image decoding apparatus according to Embodiment 4.

FIG. 34 is a flowchart showing processing operations of the image decoding apparatus according to Embodiment 4.

FIG. 35A is a block diagram showing a configuration of an image coding apparatus according to an aspect of the present disclosure.

FIG. 35B is a flowchart showing processing performed by the image coding apparatus according to an aspect of the present disclosure.

FIG. 36A is a block diagram showing a configuration of an image decoding apparatus according to an aspect of the present disclosure.

FIG. 36B is a flowchart showing processing performed by the image coding apparatus according to an aspect of the present disclosure.

FIG. 37 shows an overall configuration of a content providing system for implementing content distribution services.

FIG. 38 shows an overall configuration of a digital broadcasting system.

FIG. 39 shows a block diagram illustrating an example of a configuration of a television.

FIG. 40 shows a block diagram illustrating an example of a configuration of an information reproducing/recording unit that reads and writes information from and on a recording medium that is an optical disk.

FIG. 41 shows an example of a configuration of a recording medium that is an optical disk.

FIG. 42A shows an example of a cellular phone.

FIG. 42B is a block diagram showing an example of a configuration of a cellular phone.

FIG. 43 illustrates a structure of multiplexed data.

FIG. 44 schematically shows how each stream is multiplexed in multiplexed data.

FIG. 45 shows how a video stream is stored in a stream of PES packets in more detail.

FIG. 46 shows a structure of TS packets and source packets in the multiplexed data.

FIG. 47 shows a data structure of a PMT.

FIG. 48 shows an internal structure of multiplexed data information.

FIG. 49 shows an internal structure of stream attribute information.

FIG. 50 shows steps for identifying video data.

FIG. 51 shows an example of a configuration of an integrated circuit for implementing the moving picture coding method and the moving picture decoding method according to each of embodiments.

FIG. 52 shows a configuration for switching between driving frequencies.

FIG. 53 shows steps for identifying video data and switching between driving frequencies.

FIG. 54 shows an example of a look-up table in which video data standards are associated with driving frequencies.

FIG. 55A is a diagram showing an example of a configuration for sharing a module of a signal processing unit.

FIG. 55B is a diagram showing another example of a configuration for sharing a module of the signal processing unit.

### DESCRIPTION OF EMBODIMENTS

### (Underlying Knowledge Forming Basis of the Present Disclosure)

In a moving picture coding scheme already standardized, which is referred to as H.264, three picture types of I-picture, P-picture, and B-picture are used for reduction of the amount of information by compression.

The I-picture is not coded using inter prediction. Specifically, the I-picture is coded using prediction within the picture (this way of prediction is hereinafter referred to as intra prediction). The P-picture is coded using inter prediction with reference to one previously coded picture preceding or following the current picture in display order. The B-picture is coded using inter prediction with reference to two previously coded pictures preceding and following the current picture in display order.

In coding using inter prediction, a reference picture list for indicating a reference picture is generated. In the reference picture list, reference picture indices are assigned to coded reference pictures to be referenced in inter prediction. For example, two reference picture lists (L0, L1) are generated for a B-picture because it can be coded with reference to two pictures.

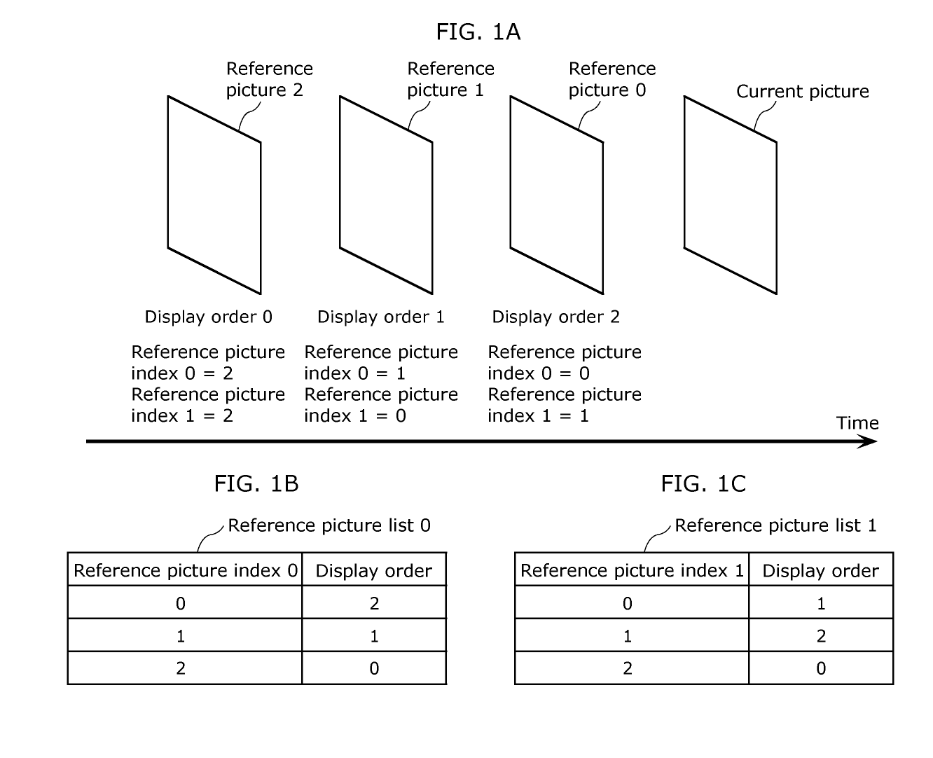

FIG. 1A is a diagram for illustrating an exemplary reference picture list for a B-picture. FIG. 1B shows an example of a reference picture list 0 (L0) for a prediction direction 0 in bi-directional prediction. In the reference picture list 0, the reference picture index 0 having a value of 0 is assigned to a reference picture 0 with a display order number 2. The reference picture index 0 having a value of 1 is assigned to a reference picture 1 with a display order number 1. The reference picture index 0 having a value of 2 is assigned to a reference picture 2 with a display order number 0. In other words, a reference picture temporally closer to the current picture in display order is assigned with a reference picture index having a smaller value.

FIG. 1C shows an example of a reference picture list 1 (L1) for a prediction direction 1 in bi-directional prediction. In the reference picture list 1, the reference picture index 1 having a value of 0 is assigned to a reference picture 1 with a display order number 1. The reference picture index 1 having a value of 1 is assigned to a reference picture 0 with a display order number 2. The reference picture index 2 having a value of 2 is assigned to a reference picture 2 with a display order number 0.

In this manner, it is possible to assign reference picture indices having different values between prediction directions to a reference picture (the reference pictures 0 and 1 in FIG. 1A) or to assign the reference picture indices having the same value for both directions to a reference picture (the reference picture 2 in FIG. 1A).

In the moving picture coding method referred to as H.264 (see Non-patent Literature 1), a motion vector estimation mode is available as a coding mode for inter prediction of each current block in a B-picture. In the motion vector estimation mode, a difference value between image data of a current block and prediction image data and a motion vector used for generating the prediction image data are coded. In addition, in the motion vector estimation mode, bi-directional prediction and uni-directional prediction can be selectively performed. Bi-directional prediction is also referred to as bi-prediction. In bi-prediction, a prediction image is generated with reference to two coded pictures one of which precedes a current picture to be coded and the other of which follows the current picture. In other words, bi-prediction involves reference to two pictures. More specifically, bi-prediction is to perform motion compensation using two motion vectors in order to generate a prediction image of a current block to be coded or decoded. Uni-directional prediction is also referred to as uni-prediction. In uni-prediction, a prediction image is generated with reference to one coded picture preceding or following a current picture to be coded. In other words, uni-prediction involves reference to one picture. More specifically, uni-prediction is to perform motion compensation using one motion vector in order to generate a prediction image of a current block to be coded or decoded.

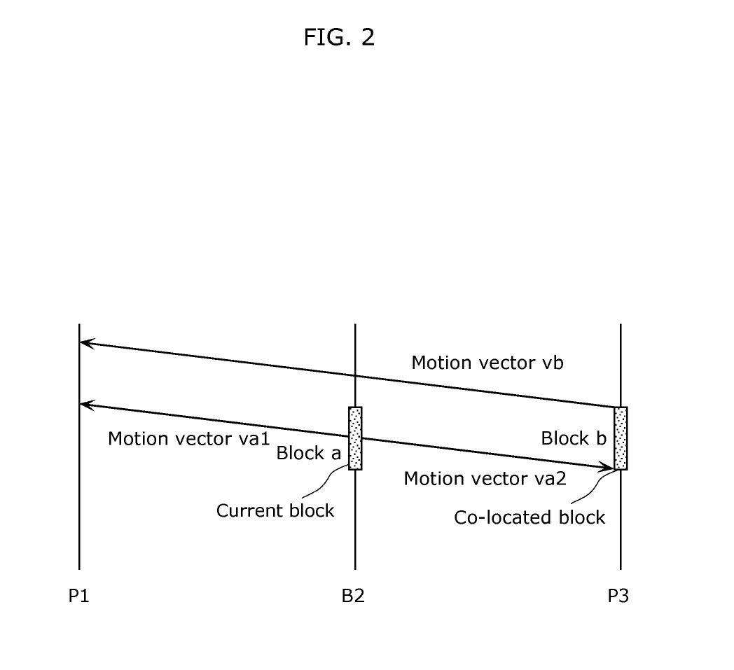

Furthermore, in the moving picture coding method referred to as H.264, a coding mode referred to as a temporal motion vector prediction mode can be selected for derivation of a motion vector in coding of a B-picture. The inter prediction coding method performed in temporal motion vector prediction mode will be described below using FIG. 2.

FIG. 2 is a diagram for illustrating motion vectors for use in the temporal motion vector prediction mode. Specifically, FIG. 2 shows a case where a block a in a picture B2 is coded in temporal motion vector prediction mode.

In the coding, a motion vector vb is used which has been used for coding of a block b in a picture P3. The picture P3 is a reference picture following the picture B2. The position of the block b in the picture P3 is the same as the position of the block a in the picture B2 (the block b is hereinafter referred to as a “co-located block” of the block a). The motion vector vb has been used for coding the block b with reference to the picture P1.

Motion vectors parallel to the motion vector vb are used for obtaining two reference blocks for the block a are obtained from a forward reference picture and a backward reference picture, that is, a picture P1 and a picture P3. Then, the block a is coded using bi-prediction based on the two obtained reference blocks. Specifically, one motion vector used for coding the block a is a motion vector va1 for the picture P1, and the other vector is a motion vector va2 for the picture P3.

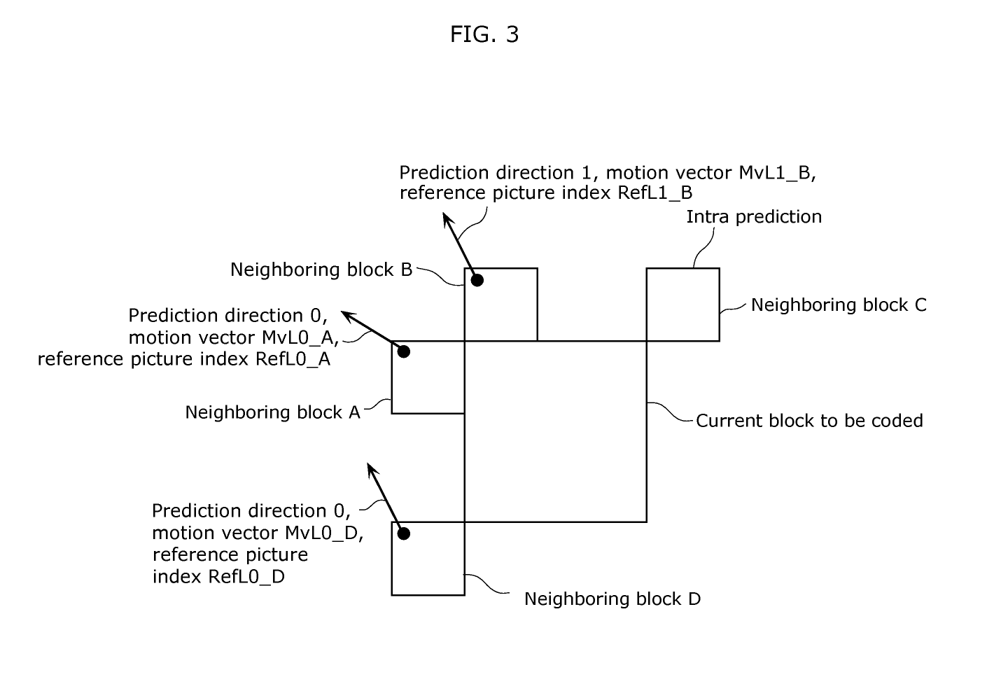

Merging mode has been being proposed as an inter prediction mode for each current block to be coded in a B-picture or a P-picture. In the merging mode, a current block is coded using a prediction direction, a motion vector, and a reference picture index which are copies of those used for coding a neighboring block of the current block. In the coding of the current block, the index and the like of the neighboring block from which those are copied are attached to a bitstream. This makes it possible to select, in decoding of the current block, the prediction direction, motion vector, and reference picture index used for the coding of the neighboring block. A concrete example is given below with reference to FIG. 3.

FIG. 3 shows an exemplary motion vector of a neighboring block for use in the merging mode. In FIG. 3, a neighboring block A is a coded block located to the immediate left of a current block. A neighboring block B is a coded block located immediately above the current block. A neighboring block C is a coded block located immediately above to the right of the current block. A neighboring block D is a coded block located immediately below to the left of the current block.

The neighboring block A is a block coded using uni-prediction in the prediction direction 0. The neighboring block A has a motion vector MvL0_A in the prediction direction 0, which is a motion vector to a reference picture indicated by a reference picture index RefL0_A for the prediction direction 0. Here, MvL0 represents a motion vector which references a reference picture indicated in a reference picture list 0 (L0). MvL1 represents a motion vector which references a reference picture indicated in a reference picture list 1 (L1).

The neighboring block B is a block coded using uni-prediction in the prediction direction 1. The neighboring block B has a motion vector MyL1_B in the prediction direction 1, which is a motion vector to a reference picture indicated by a reference picture index RefL1_B for the prediction direction 1.

The neighboring block C is a block coded using intra prediction.

The neighboring block D is a block coded using uni-prediction in the prediction direction 0. The neighboring block D has a motion vector MvL0_D in the prediction direction 0, which is a motion vector to a reference picture indicated by a reference picture index RefL0_D for the prediction direction 0.

In this case, for example, a set of a prediction direction, a motion vector, and a reference picture index with which the current block can be coded with the highest coding efficiency is selected as a set of a prediction direction, a motion vector, and a reference picture index of the current block from among the sets of prediction directions, motion vectors, and reference picture indices of the neighboring blocks A to D and the set of a prediction direction, a motion vector, and a reference picture index which are calculated using a co-located block in temporal motion vector prediction mode. Then, a merging block candidate index indicating a block having the selected set of a prediction direction, a motion vector, and a reference picture index is attached to a bitstream.

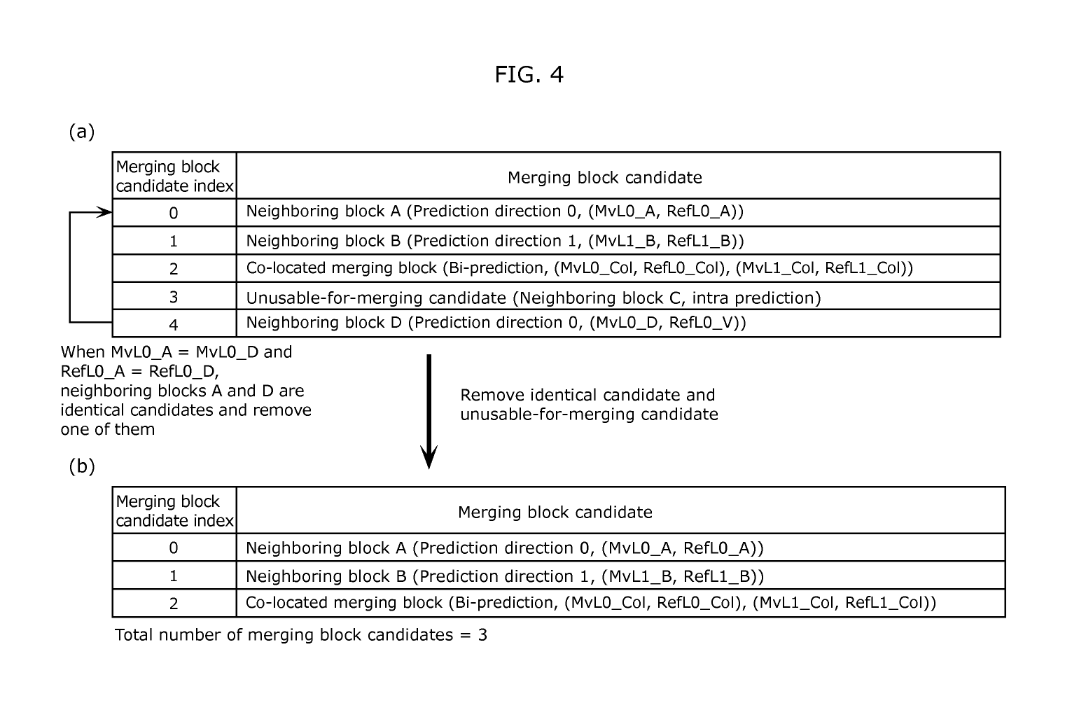

For example, when the neighboring block A is selected, the current block is coded using the motion vector MvL0_A in the prediction direction 0 and the reference picture index RefL0_A. Then, only the merging block candidate index having a value of 0 which indicates use of the neighboring block A as shown in FIG. 4 is attached to a bitstream. The amount of information on a prediction direction, a motion vector, and a reference picture index is thereby reduced.

Furthermore, in the merging mode, a candidate which cannot be used for coding (hereinafter referred to as an “unusable-for-merging candidate”), and a candidate having a set of a prediction direction, a motion vector, and a reference picture index identical to a set of a prediction direction, a motion vector, and a reference picture index of any other merging block candidate (hereinafter referred to as an “identical candidate”) are removed from the merging block candidates as shown in (a) and (b) in FIG. 4.

In this manner, the total number of merging block candidates is reduced so that the amount of code assigned to merging block candidate indices can be reduced. Here, “a block is unusable for merging” means (1) that the merging block candidate has been coded using intra prediction, (2) that the merging block candidate is outside the boundary of a slice including the current block or the boundary of a picture including the current block, or (3) that the merging block candidate is yet to be coded.

In the example shown in FIG. 4, the neighboring block C is a block coded using intra prediction. The merging block candidate having the merging block candidate index 3 is thus an unusable-for-merging candidate and removed from the merging block candidate list. The neighboring block D and the neighboring block A has an identical set of a prediction direction, a motion vector, and a reference picture index. The merging block candidate having the merging block candidate index 4 is thus removed from the merging block candidate list. As a result, the total number of the merging block candidates is three, and the size of the merging block candidate list is set at three.

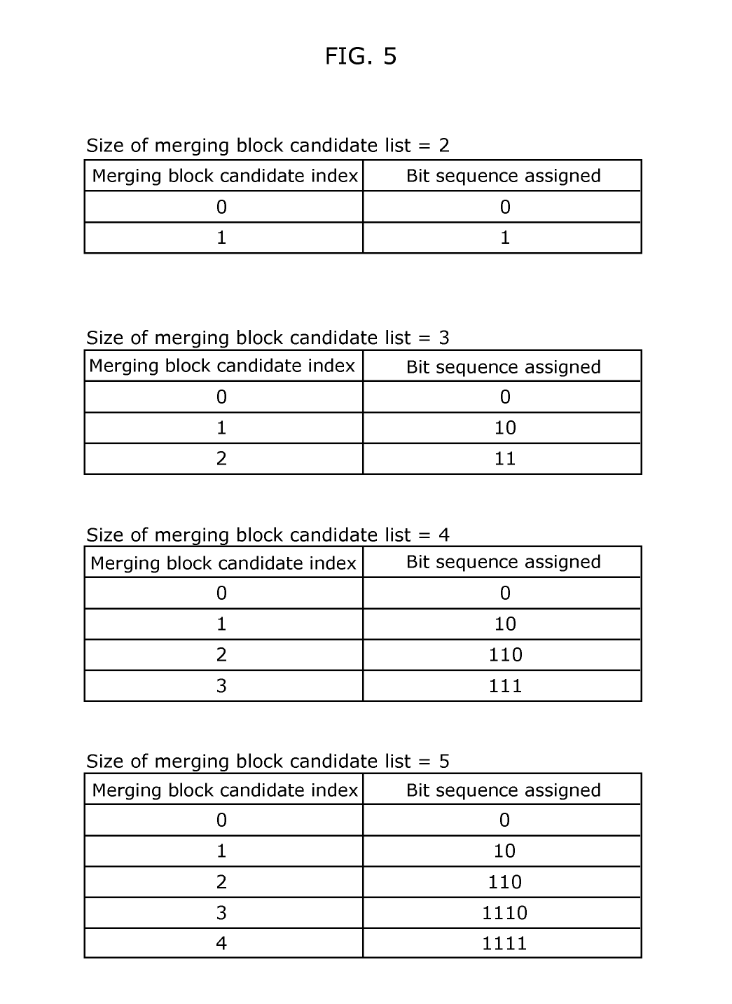

Merging block candidate indices are coded by variable-length coding which is performed by assigning bit sequences to the merging block candidate indices according to the size of each merging block candidate list as shown in FIG. 5. Thus, in the merging mode, the length of bit sequences assigned to merging mode indices depends on the size of each merging block candidate list so that the amount of code can be reduced.

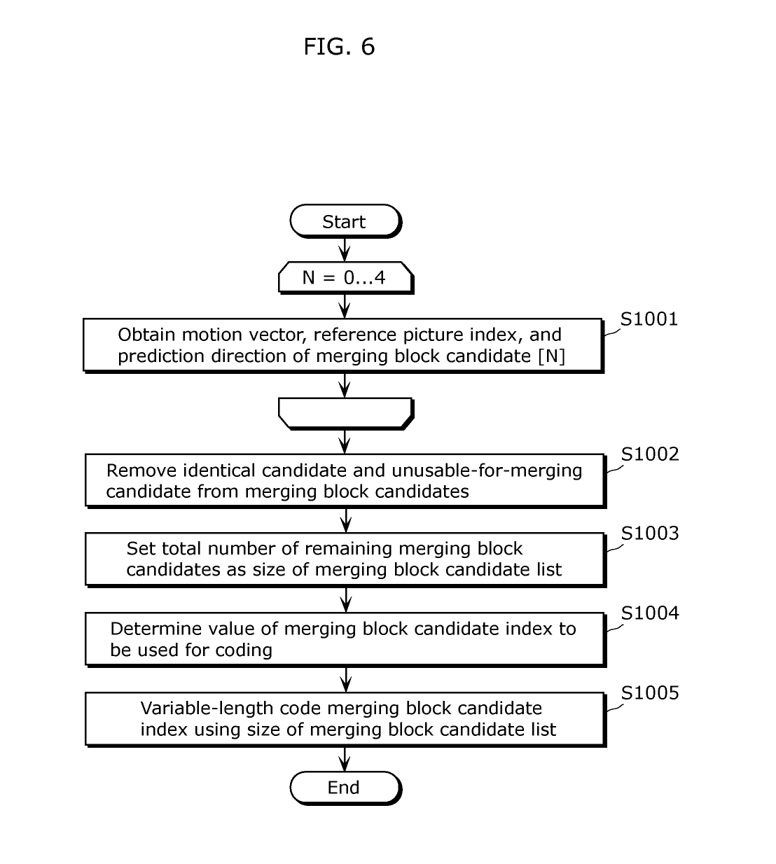

FIG. 6 is a flowchart showing an example of a process for coding using the merging mode. In Step S1001, sets of a motion vector, a reference picture index, and a prediction direction of merging block candidate are obtained from neighboring blocks and a co-located block. In Step S1002, identical candidates and unusable-for-merging candidates are removed from the merging block candidates. In Step S1003, the total number of the merging block candidates after the removing is set as the size of the merging block candidate list. In Step S1004, the merging block candidate index to be used in coding of the current block is determined. In Step S1005, the determined merging block candidate index is coded in bit sequence by performing variable-length coding using the size of the merging block candidate list.

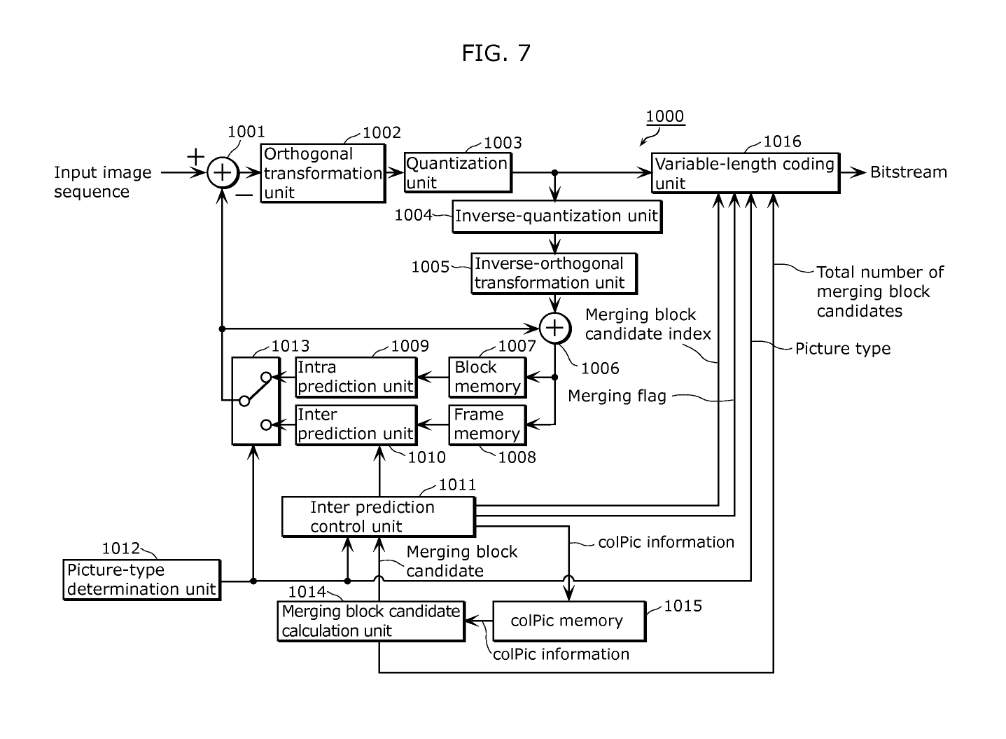

FIG. 7 shows an exemplary configuration of an image coding apparatus 1000 which codes images using the merging mode. The image coding apparatus 1000 includes a subtractor 1001, an orthogonal transformation unit 1002, a quantization unit 1003, an inverse-quantization unit 1004, an inverse-orthogonal transformation unit 1005, an adder 1006, block memory 1007, frame memory 1008, an intra prediction unit 1009, an inter prediction unit 1010, an inter prediction control unit 1011, a picture-type determination unit 1012, a switch 1013, a merging block candidate calculation unit 1014, colPic memory 1015, and a variable-length coding unit 1016.

In FIG. 7, the merging block candidate calculation unit 1014 calculates merging block candidates. Then, the merging block candidate calculation unit 1014 transmits the total number of the calculated merging block candidates to the variable-length coding unit 1016. The variable-length coding unit 1016 sets the total number of the merging block candidates as the size of the merging block candidate list which is a coding parameter. Then, the variable-length coding unit 1016 performs variable-length coding on a bit sequence by assigning a bit sequence according to the size of the merging block candidate list to a merging block candidate index to be used for coding.

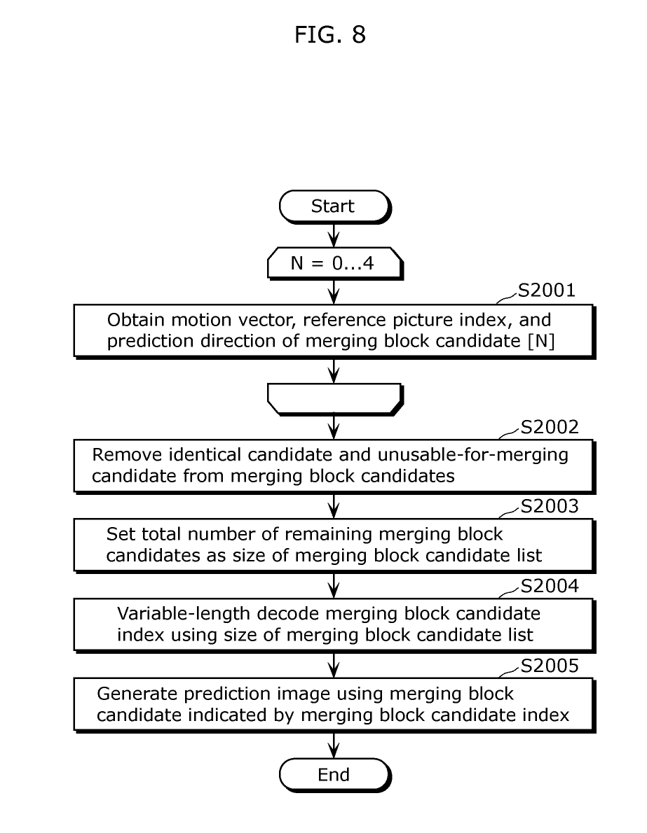

FIG. 8 is a flowchart showing an example of a process for decoding using the merging mode. In Step S2001, sets of a motion vector, a reference picture index, and a prediction direction of merging block candidate are obtained from neighboring blocks and a co-located block. In Step S2002, identical candidates and unusable-for-merging candidates are removed from the merging block candidates. In Step S2003, the total number of the merging block candidates after the removing is set as the size of the merging block candidate list. In Step S2004, the merging block candidate index to be used in decoding of a current block is decoded from a bitstream using the size of the merging block candidate list. In Step S2005, the current block is decoded by generating a prediction image using the merging block candidate indicated by the decoded merging block candidate index.

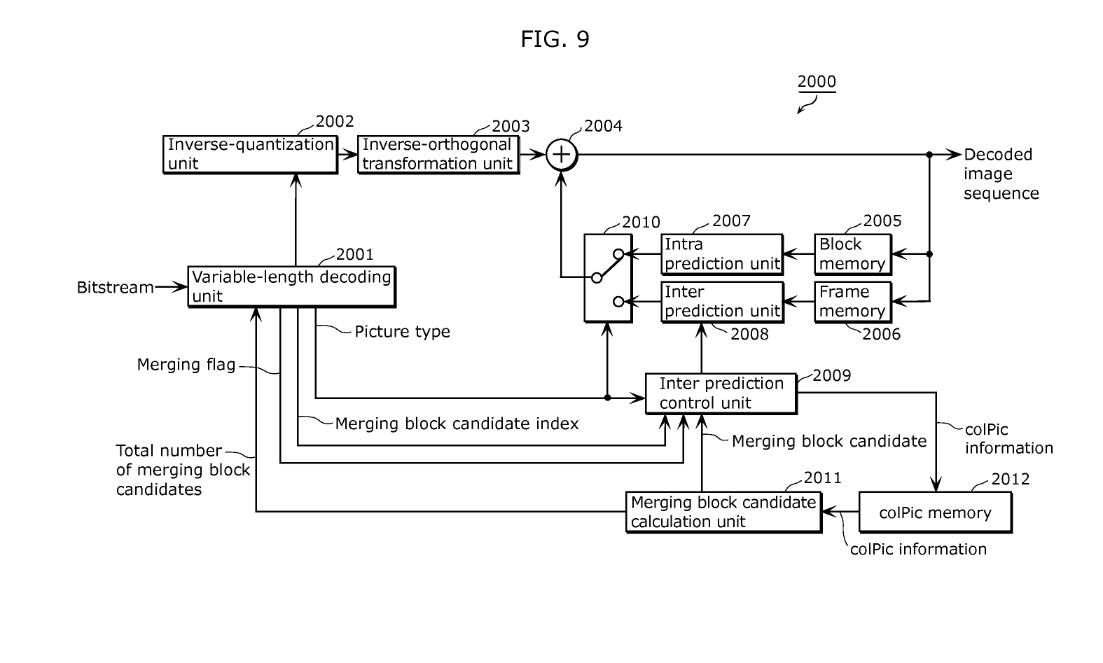

FIG. 9 shows an exemplary configuration of an image decoding apparatus 2000 which decodes coded images using the merging mode. The image decoding apparatus 2000 includes a variable-length decoding unit 2001, an inverse-quantization unit 2002, an inverse-orthogonal-transformation unit 2003, an adder 2004, block memory 2005, frame memory 2006, an intra prediction unit 2007, an inter prediction unit 2008, an inter prediction control unit 2009, a switch 2010, a merging block candidate calculation unit 2011, and colPic memory 2012.

In FIG. 9, the merging block candidate calculation unit 2011 calculates merging block candidates. Then, the merging block candidate calculation unit 2011 transmits the calculated total number of the merging block candidates to the variable-length decoding unit 2001. The variable-length decoding unit 2001 sets the total number of the merging block candidates as the size of the merging block candidate list which is a decoding parameter. Then, the variable-length decoding unit 2001 decodes a merging block candidate index from the bitstream using the size of the merging block candidate list.

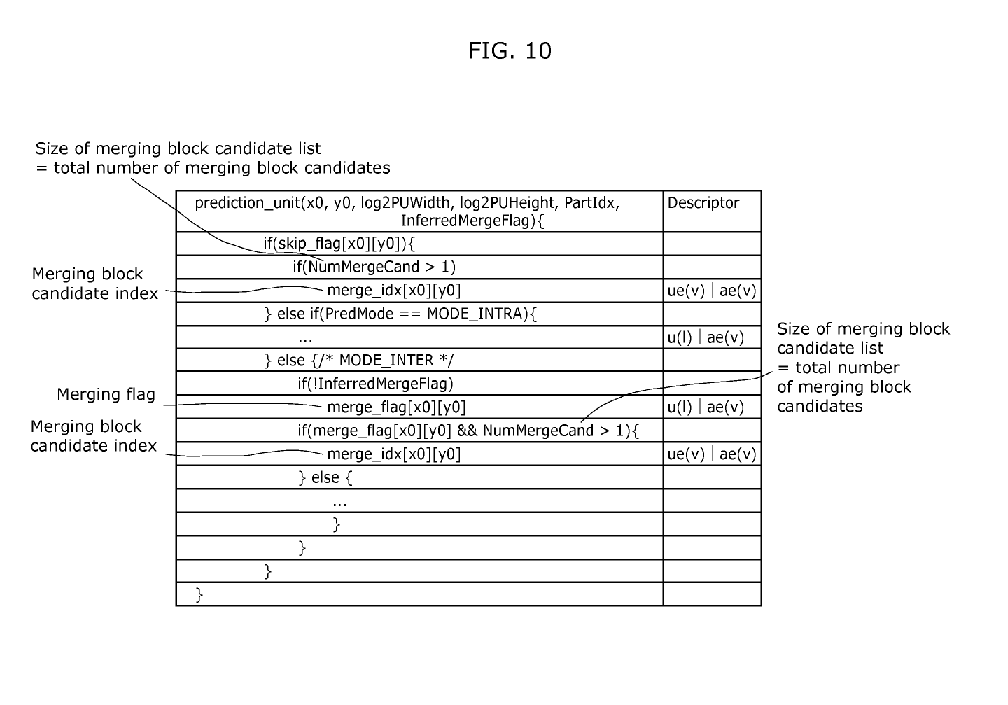

FIG. 10 shows syntax for attachment of a merging block candidate index to a bitstream. In FIG. 10, merge_idx represents a merging block candidate index, and merge_flag represents a merging flag. NumMergeCand represents the size of a merging block candidate list. NumMergeCand is set at the total number of merging block candidates after unusable-for-merging candidates and identical candidates are removed from the merging block candidates.

Coding or decoding of an image is performed using the merging mode in the above-described manner.

However, there is a problem that use of the merging mode in the conventional manner to increase coding efficiency requires memory of a large memory bandwidth. To be specific, when using the merging mode to increase coding efficiency, an image coding apparatus needs to generate a prediction image for each merging block candidate of a current block using a set of a prediction direction, a motion vector, and a reference picture index of the merging block candidate. In generation of a prediction image of a merging block candidate coded using uni-prediction, only an image of a region of one reference picture specified by one motion vector is read from frame memory. In contrast, in generation of a prediction image of a merging block candidate coded using bi-prediction, it is necessary to read images of regions of two respective reference pictures specified by motion vectors corresponding to the two respective reference pictures from frame memory. Accordingly, a large memory bandwidth is required when a merging block candidate is coded using bi-prediction. Furthermore, this influence of bi-prediction of merging block candidates on memory bandwidth is greater for a current block having a smaller size.

It may be possible to limit memory bandwidth by prohibiting coding of current blocks having a certain size or smaller, such as a pixel size for motion compensation of 8×4, 4×8, and 4×4, using bi-prediction. In the conventional merging mode, however, each current block is coded using a prediction direction or prediction directions which are used for coding of a merging block candidate. It is therefore impossible to prohibit coding of a current block using bi-prediction in the conventional merging mode when all merging block candidates such as neighboring blocks are coded using bi-prediction. As a result, coding efficiency decreases because the merging mode cannot be an option when memory bandwidth needs to be limited.

Conceived to address the problem, an image coding method according to an aspect of the present disclosure is an image coding method of merging, into coding information of a current block to be coded in a moving picture, coding information of a coded block which is one of blocks in the moving picture and is other than the current block, to code the current block, the coding information including a motion vector and a reference picture index.

The method includes: determining one or more blocks usable for the merging as one or more merging candidates, based on a spatial position or a temporal position of the current block; generating, for each of the merging candidates, a prediction image of the current block using coding information of the merging candidate and comparing costs of the prediction images to determine a block to be used for coding the current block from the one or more merging candidates; coding the current block using the coding information of the block determined in the generating of a prediction image to generate a bitstream including the coded current block; and attaching, to the bitstream, a merging candidate index indicating the block determined in the generating of a prediction image, wherein in the generating of a prediction image, when a motion compensation size of the current block is a bi-prediction-prohibited size and the one or more merging candidates include a merging candidate coded using bi-prediction with reference to two pictures, the prediction image of the current block is generated using coding information for uni-prediction of the merging candidate coded using bi-prediction instead of coding information for the bi-prediction of the merging candidate coded using bi-prediction, the uni-prediction being performed with reference to one picture.

With this, when the motion compensation size of a current block to be coded is a bi-prediction-prohibited size (bi-direction-prediction-prohibited size) and the one or more merging candidates include a merging candidate (merging block candidate) coded using bi-prediction (bi-direction prediction), the prediction image of the current block is generated using coding information for uni-prediction (uni-direction prediction) of the merging candidate coded using bi-prediction instead of coding information for the bi-prediction of the merging candidate coded using bi-prediction. For example, when the motion compensation size of a current block to be coded is a minimum size, only a motion vector and a reference picture index for the prediction direction 0 (that is, those in the reference picture list L0) included in coding information for bi-prediction of a merging candidate are used for generation of a prediction image of the current block. In other words, the motion vectors and reference picture indices for the prediction direction 1 (that is, those in the reference picture list L1) included in the coding information for bi-prediction of the merging candidate are not used for generation of a prediction image of the current block. As a result, memory bandwidth can be limited and coding efficiency can be increased by using the merging mode.

Furthermore, in the determining of one or more blocks as one or more merging candidates, a list which lists coding information of each of the one or more determined merging candidates may be generated, and in the generating of a prediction image, when the one or more determined merging candidates include a merging candidate coded using uni-prediction, the prediction image of the current block may be generated using the coding information which is listed in the list and is for the uni-prediction of the merging candidate coded using uni-prediction, and when the one or more determined merging candidates include a merging candidate coded using bi-prediction, the coding information which is listed in the list and is for the bi-prediction of the merging candidate coded using bi-prediction may be converted into coding information for uni-prediction of the merging candidate coded using bi-prediction, and the prediction image of the current block may be generated using the coding information for uni-prediction of the merging candidate coded using bi-prediction.

With this, motion vectors and reference picture indices used for coding of merging candidates can be appropriately managed using the list (merging block candidate list).

Furthermore, in the determining of one or more blocks as one or more merging candidates, when the determined one or more merging candidates include a merging candidate coded using bi-prediction, coding information for the bi-prediction of the merging candidate coded using bi-prediction may be converted into coding information for uni-prediction of the merging candidate coded using bi-prediction to generate a list which lists coding information of each of the one or more determined merging candidates and in which the coding information for the bi-prediction is not included, and in the generating of a prediction image, the prediction image of the current block may be generated for each of the merging candidates using the coding information of the merging candidate listed in the list.

As a result, the list lists only coding information for uni-prediction out of coding information for bi-prediction so that the data amount of the list can be reduced.

Furthermore, when the uni-prediction is available in two types of first uni-prediction and second uni-prediction distinguished according to a predetermined condition, the coding information for the bi-prediction of the merging candidate coded using bi-prediction may include coding information for the first uni-prediction and coding information for the second uni-prediction, and when the one or more merging candidates includes a plurality of the merging candidates coded using bi-prediction, in the determining of one or more blocks or in the generating of a prediction image, only the coding information for the first uni-prediction or the coding information for the second uni-prediction of included in coding information for bi-prediction of the plurality of the merging candidates may be used for the generating of the prediction images of the current block.

This prevents mixture of coding information for the first uni-prediction (uni-prediction for the prediction direction 0) and coding information for the second uni-prediction (uni-prediction for prediction direction 1), so that processing using the coding information can be simplified, and coding efficiency can be further increased.

Furthermore, the image coding method may further include determining whether it is true or false that the motion compensation size of the current block is the bi-prediction-prohibited size and the one or more merging candidates include a merging candidate coded using bi-prediction, wherein in the determining of whether it is true or false, it may be determined that the motion compensation size of the current block is the bi-prediction-prohibited size when the motion compensation size of the current block is smaller than or equal to a predetermined size.

With this, any size smaller than or equal to the predetermined size is handled as a bi-prediction-prohibited size. This provides the motion compensation size of a current block to be coded with a range, so that memory bandwidth can be further limited.

Furthermore, in the determining of whether it is true or false, it may be determined that the motion compensation size of the current block is the bi-prediction-prohibited size when a sum of a width and a height of the current block is equal to a predetermined value. For example, it is determined that the motion compensation size of the current block is the bi-prediction-prohibited size when the motion compensation size of the current block is a size of 4×8 pixels or a size of 8×4 pixels.

With this, it is possible to easily and appropriately determine whether or not the motion compensation size of a current block to be coded is a bi-prediction-prohibited size.

Furthermore, an image decoding method according to an aspect of the present disclosure is an image decoding method of merging, into coding information of a current block to be decoded in a bitstream, coding information of a decoded block which is one of blocks in the bitstream and is other than the current block, to decode the current block, the coding information including a motion vector and a reference picture index. The method includes: extracting a merging candidate index from the bitstream; determining one or more blocks usable for the merging as one or more merging candidates, based on a spatial position or a temporal position of the current block; determining, from the one or more determined merging candidates, a block indicated by the merging candidate index extracted in the extracting; generating a prediction image of the current block using coding information of the block determined in the determining of a block, and decoding the current block using the prediction image to generate a decoded image including the decoded current block, wherein in the generating of a prediction image, when a motion compensation size of the current block is a bi-prediction-prohibited size and the block determined in the determining of a block has been decoded using bi-prediction with reference to two pictures, the prediction image of the current block is generated using coding information for uni-prediction of the block decoded using bi-prediction instead of coding information for the bi-prediction of the block decoded using bi-prediction, the uni-prediction being performed with reference to one picture.

In this manner, it is possible to appropriately decode a bitstream coded with increased coding efficiency using a limited memory bandwidth.

These general and specific aspects can be implemented as a system, a method, an integrated circuit, a computer program, a computer-readable recording medium such as a CD-ROM, or as any combination of a system, a method, an integrated circuit, a computer program, and a computer-readable recording medium.

An image coding apparatus and an image decoding apparatus according to an aspect of the present disclosure will be specifically described below with reference to the drawings.

Each of the exemplary embodiments described below shows a general or specific example. The numerical values, shapes, materials, constituent elements, the arrangement and connection of the constituent elements, processing steps, the order of the steps etc. shown in the following exemplary embodiments are mere examples, and therefore do not limit the scope of claims. Therefore, among the constituent elements in the following exemplary embodiments, constituent elements not recited in any one of the independent claims are described as optional constituent elements.

### Embodiment 1

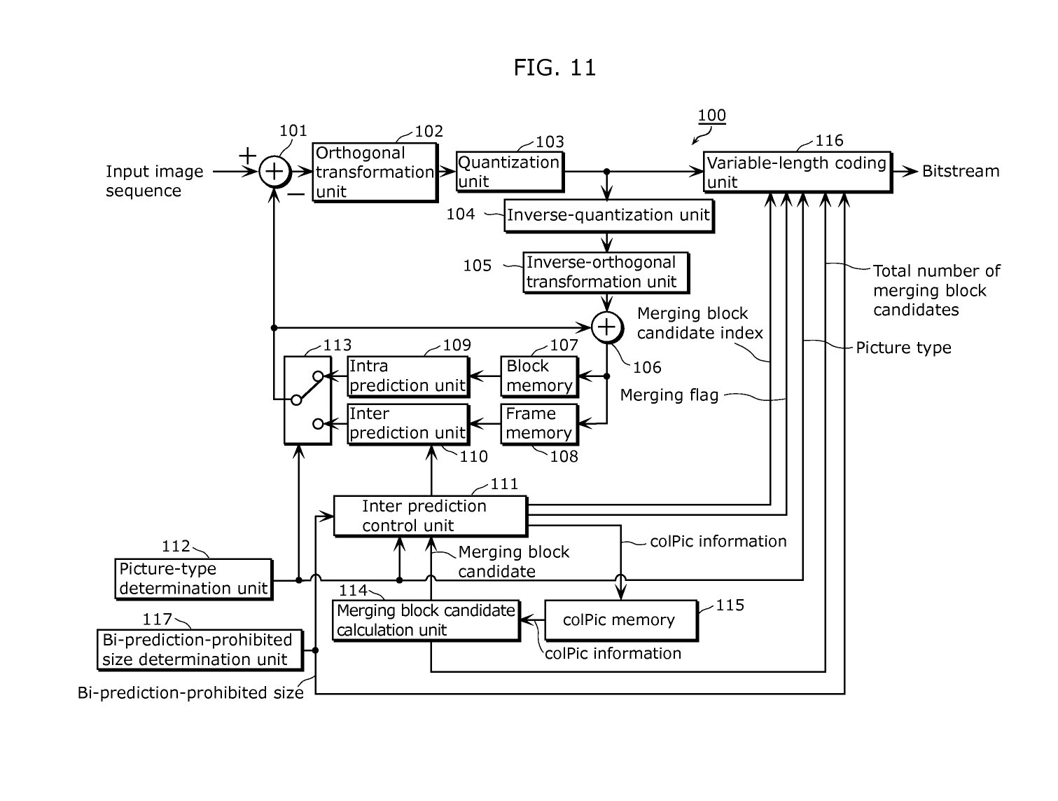

FIG. 11 is a block diagram showing a configuration of an image coding apparatus 100 according to Embodiment 1. The image coding apparatus 100 codes a picture on a block-by-block basis to generate a bitstream.

As shown in FIG. 11, the image coding apparatus 100 includes a subtractor 101, an orthogonal transformation unit 102, a quantization unit 103, an inverse-quantization unit 104, an inverse-orthogonal-transformation unit 105, an adder 106, block memory 107, frame memory 108, an intra prediction unit 109, an inter prediction unit 110, an inter prediction control unit 111, a picture-type determination unit 112, a switch 113, a merging block candidate calculation unit 114, colPic memory 115, a variable-length coding unit 116, and a bi-prediction-prohibited size determination unit 117.

The subtractor 101 subtracts, on a block-by-block basis, prediction image data from input image data included in an input image sequence to generate prediction error data.

The orthogonal transformation unit 102 transforms the generated prediction error data from picture domain into frequency domain.

The quantization unit 103 quantizes the prediction error data transformed into the frequency domain.

The inverse-quantization unit 104 inverse-quantizes the prediction error data quantized by the quantization unit 103.

The inverse-orthogonal-transformation unit 105 transforms the inverse-quantized prediction error data from frequency domain into picture domain.

The adder 106 generates reconstructed image data by adding, on a block-by-block basis, prediction image data and the prediction error data inverse-quantized by the inverse-orthogonal-transformation unit 105.

The block memory 107 stores the reconstructed image data in units of a block.

The frame memory 108 stores the reconstructed image data in units of a frame.

The picture-type determination unit 112 determines in which of the picture types of I-picture, B-picture, and P-picture the input image data is to be coded. Then, the picture-type determination unit 112 generates picture-type information indicating the determined picture type.

The intra prediction unit 109 generates intra prediction image data of a current block by performing intra prediction using reconstructed image data stored in the block memory 107 in units of a block.

The inter prediction unit 110 generates inter prediction image data (prediction image) of a current block by performing inter prediction using reconstructed image data stored in the frame memory 108 in units of a frame and a motion vector derived by a process including motion estimation.

When a current block is coded using intra prediction, the switch 113 outputs intra prediction image data generated by the intra prediction unit 109 as prediction image data of the current block to the subtractor 101 and the adder 106. When a current block is coded using inter prediction, the switch 113 outputs inter prediction image data generated by the inter prediction unit 110 as prediction image data of the current block to the subtractor 101 and the adder 106.

The bi-prediction-prohibited size determination unit 117 determines a motion compensation size of current blocks for which use of bi-prediction is prohibited, and outputs the determined size as a bi-prediction-prohibited size to the inter prediction control unit 111 and the variable-length coding unit 116. The determination is made using a method described later.

The merging block candidate calculation unit 114 derives merging block candidates for merging mode using motion vectors and others of neighboring blocks of the current block and a motion vector and others of the co-located block (colPic information) stored in the colPic memory 115. Then, the merging block candidate calculation unit 114 calculates the total number of usable-for-merging candidates using a method described later.

Furthermore, the merging block candidate calculation unit 114 assigns merging block candidate indices each having a different value to the derived merging block candidates. Then, the merging block candidate calculation unit 114 transmits the merging block candidates and merging block candidate indices to the inter prediction control unit 111. Furthermore, the merging block candidate calculation unit 114 transmits the calculated total number of usable-for-merging candidates to the variable-length coding unit 116.

The inter prediction control unit 111 selects a prediction mode using which prediction error is smaller from a prediction mode in which a motion vector derived by motion estimation is used (motion estimation mode) and a prediction mode in which a motion vector derived from a merging block candidate according to a bi-prediction-prohibited size is used (merging mode). Furthermore, the inter prediction control unit 111 transmits a merging flag indicating whether or not the selected prediction mode is the merging mode to the variable-length coding unit 116. Furthermore, the inter prediction control unit 111 transmits a merging block candidate index corresponding to the determined merging block candidates to the variable-length coding unit 116 when the selected prediction mode is the merging mode. Furthermore, the inter prediction control unit 111 transmits colPic information including a motion vector of the current block to the colPic memory 115.

The variable-length coding unit 116 generates a bitstream by performing variable-length coding on the quantized prediction error data, the bi-prediction-prohibited size, the merging flag, and the picture-type information. The variable-length coding unit 116 also sets the total number of usable-for-merging candidates as the size of the merging block candidate list. Furthermore, the variable-length coding unit 116 performs variable-length coding on a merging block candidate index to be used in coding, by assigning, to the merging block candidate index, a bit sequence according to the size of the merging block candidate list.

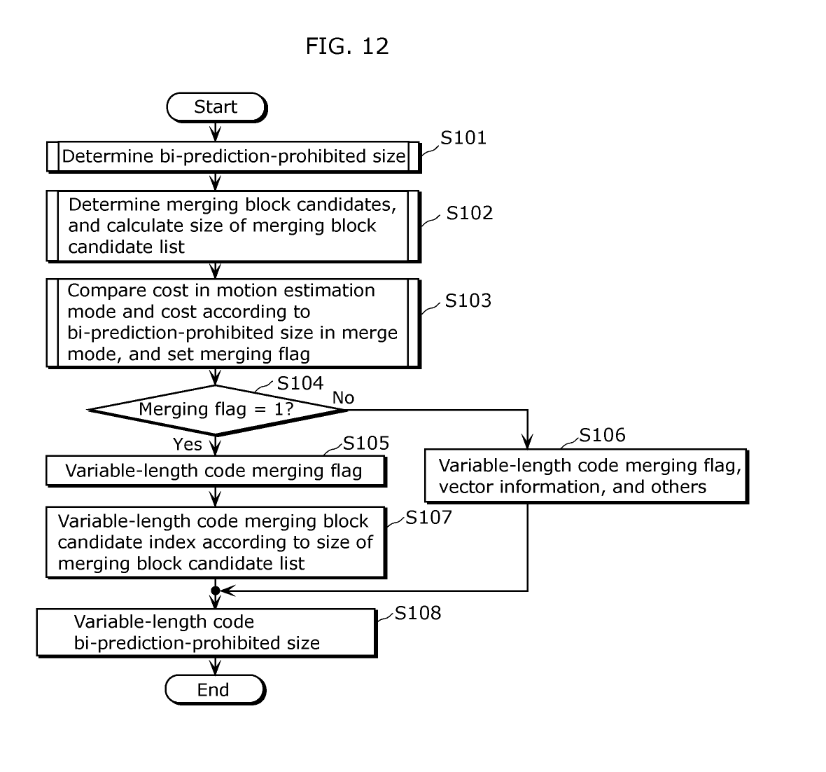

FIG. 12 is a flowchart showing processing operations of the image coding apparatus 100 according to Embodiment 1.

In Step S101, the bi-prediction-prohibited size determination unit 117 determines a motion compensation size for which use of bi-prediction is prohibited. This determination is made using a method described later.

In Step S102, the merging block candidate calculation unit 114 derives merging block candidates from neighboring blocks and a co-located block of a current block. Furthermore, the merging block candidate calculation unit 114 calculates the size of a merging block candidate list using a method described later.

For example, in the case shown in FIG. 3, the merging block candidate calculation unit 114 selects the neighboring blocks A to D as merging block candidates. Furthermore, the merging block candidate calculation unit 114 calculates, as a merging block candidate, a co-located merging block having a motion vector, a reference picture index, and a prediction direction which are calculated from the motion vector of a co-located block using the time prediction mode.

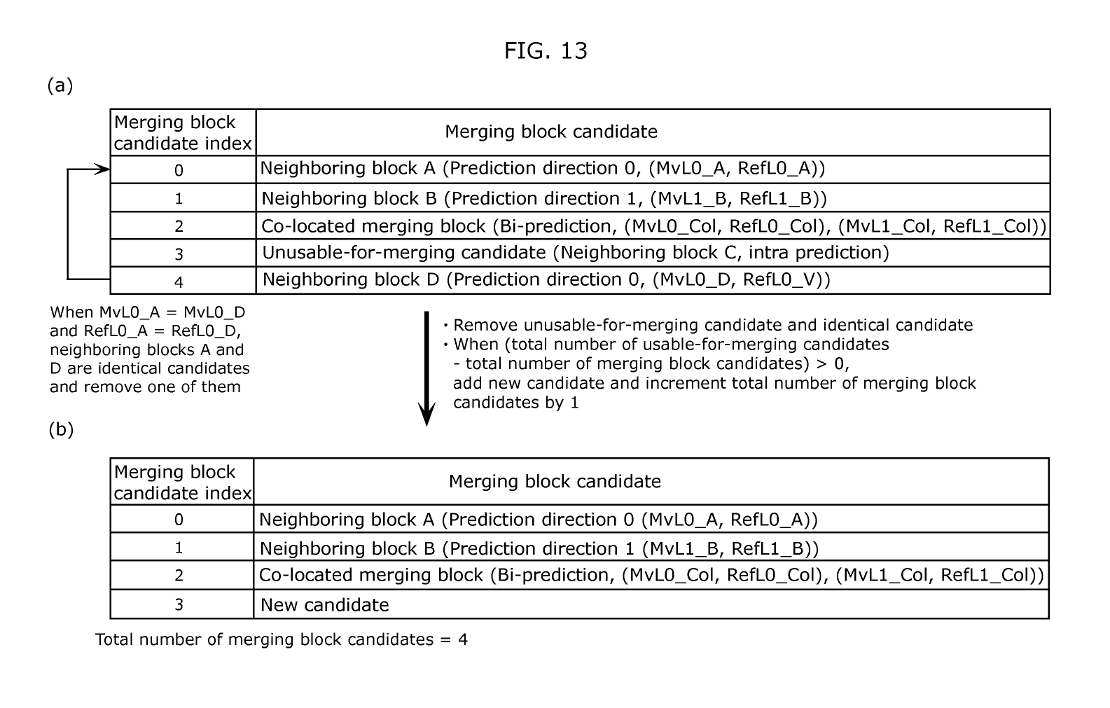

The merging block candidate calculation unit 114 assigns merging block candidate indices to the respective merging block candidates as shown in (a) in FIG. 13. Next, the merging block candidate calculation unit 114 removes unusable-for-merging candidates and identical candidates and adding new candidates using a method described later to calculate a merging block candidate list as shown in (b) in FIG. 13 and the size of the merging block candidate list.

Shorter codes are assigned to merging block candidate indices of smaller values. In other words, the smaller the value of a merging block candidate index, the smaller the amount of information necessary for indicating the merging block candidate index.

On the other hand, the larger the value of a merging block candidate index, the larger the amount of information necessary for the merging block candidate index. Therefore, coding efficiency increases when merging block candidate indices of smaller values are assigned to merging block candidates which are more likely to have motion vectors for higher accuracy and reference picture indices for higher accuracy.

For this purpose, the merging block candidate calculation unit 114 may count the total number of times of selection of each merging block candidate as a merging block, and assign a merging block candidate index of a smaller value to a block with a larger total number of the times of selection. Specifically, this can be achieved by specifying a merging block selected from neighboring blocks of a current block and assigning a merging block candidate index of a smaller value to the specified merging block when the current block is coded.

When a merging block candidate does not have information such as a motion vector (for example, when the merging block is a block coded by intra prediction, it is located outside a boundary of a picture or a boundary of a slice, or it is yet to be coded), the merging block candidate is unusable for coding.

In Embodiment 1, such a merging block candidate unusable for coding is referred to as an unusable-for-merging candidate, and a merging block candidate usable for coding is referred to as a usable-for-merging candidate. In addition, among plural merging block candidates, a merging block candidate identical in motion vector, reference picture index, and prediction direction with any other merging block is referred to as an identical candidate.

In the case shown in FIG. 3, the neighboring block C is an unusable-for-merging candidate because it is a block coded by intra prediction. The neighboring block D is an identical candidate because it is identical in motion vector, reference picture index, and prediction direction to the neighboring block A.

In Step S103, the inter prediction control unit 111 selects a prediction mode based on comparison, using a method described later, between prediction error of a prediction image generated using a motion vector derived by motion estimation and prediction error of a prediction image generated using a motion vector obtained from a merging block candidate according to a bi-prediction-prohibited size. When the selected prediction mode is the merging mode, the inter prediction control unit 111 sets the merging flag to 1, and when not, the inter prediction control unit 111 sets the merging flag to 0.

In Step S104, whether or not the merging flag is 1 (that is, whether or not the selected prediction mode is the merging mode) is determined.

When the result of the determination in Step S104 is true (S104, Yes), the variable-length coding unit 116 attaches the merging flag to a bitstream in Step S105. Subsequently, in Step S107, the variable-length coding unit 116 assigns a bit sequence according to the size of the merging block candidate list as shown in FIG. 5 to the merging block candidate index of a merging block candidate to be used for coding. Then, the variable-length coding unit 116 performs variable-length coding on the assigned bit sequence.

On the other hand, when the result of the determination in Step S104 is false (S104, No), the variable-length coding unit 106 attaches information on a merging flag and a motion estimation vector mode to a bitstream in Step S106.

In Step S108, the variable-length coding unit 116 performs variable-length coding on the bi-prediction-prohibited size and attaches the bi-prediction-prohibited size to the bitstream. The bi-prediction-prohibited size is attached as size information to an SPS, a PPS, a slice header or the like in a bitstream. The bi-prediction-prohibited size to be attached to an SPS, a PPS, a slice header or the like in a bitstream may be information in any form which indicates a motion compensation size for which bi-prediction is prohibited.

In Embodiment 1, a merging block candidate index having a value of “0” is assigned to the neighboring block A as shown in (a) in FIG. 13. A merging block candidate index having a value of “1” is assigned to the neighboring block B. A merging block candidate index having a value of “2” is assigned to the co-located merging block. A merging block candidate index having a value of “3” is assigned to the neighboring block C. A merging block candidate index having a value of “4” is assigned to the neighboring block D.

It should be noted that the merging block candidate indices having such a value may be assigned otherwise. For example, when a new candidate is added using a method described later, the variable-length coding unit 116 may assign smaller values to preexistent merging block candidates and a larger value to the new candidate. In other words, the variable-length coding unit 116 may assign a merging block candidate index of a smaller value to a preexistent merging block candidate in priority to a new candidate.

Furthermore, merging block candidates are not limited to the blocks at the positions of the neighboring blocks A, B, C, and D. For example, a neighboring block located above the lower left neighboring block D can be used as a merging block candidate. Furthermore, it is not necessary to use all the neighboring blocks as merging block candidates. For example, it is also possible to use only the neighboring blocks A and B as merging block candidates.

Furthermore, although the variable-length coding unit 116 attaches a merging block candidate index to a bitstream in Step S107 in FIG. 12 in Embodiment 1, attaching such a merging block candidate index to a bitstream is not always necessary. For example, the variable-length coding unit 116 need not attach a merging block candidate index to a bitstream when the size of the merging block candidate list is “1”. The amount of information on the merging block candidate index is thereby reduced.

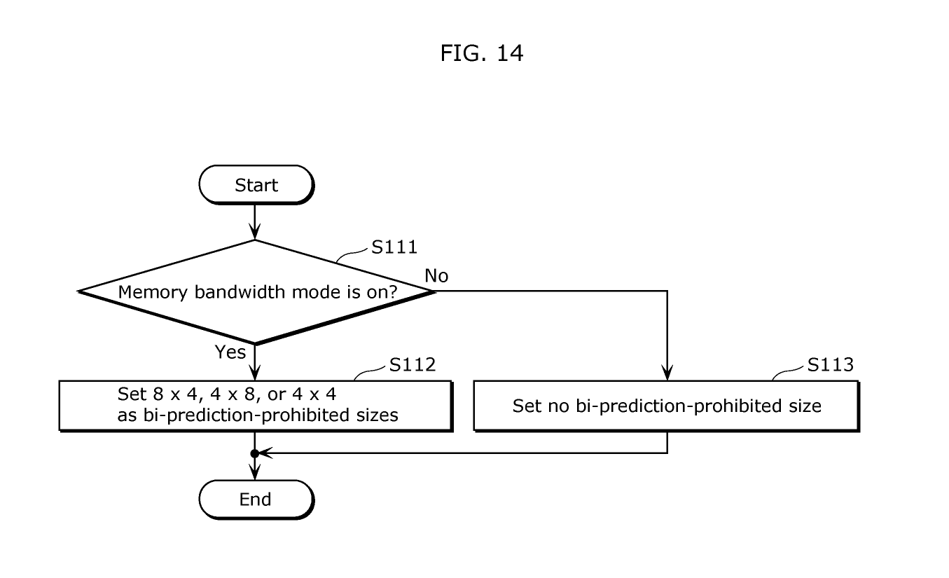

FIG. 14 is a flowchart showing details of the process performed by the bi-prediction-prohibited size determination unit 117. This flowchart specifically shows the process in Step S101 in FIG. 12.

First, in Step S111, the bi-prediction-prohibited size determination unit 117 determines whether or not the limited memory bandwidth mode is on. For example, increase in memory bandwidth is a significant problem when an image of 1920×1080 pixels or larger is coded. The limited memory bandwidth mode is used in order to solve this problem. When the limited memory bandwidth mode is on, the memory bandwidth is limited by prohibiting use of bi-prediction for coding of blocks having a motion compensation size or smaller.

In bi-prediction, it is generally necessary to read two reference pictures from frame memory. Required memory bandwidth can be therefore limited by prohibiting use of bi-prediction for coding of blocks having a certain size or smaller.

It should be noted that the example described in Embodiment 1 is not limiting in which the limited memory bandwidth mode is used. For example, the determination in Step S111 may be made based on a profile or a level. For example, the image coding apparatus 100 may prohibit use of bi-prediction for coding of block having a certain size or smaller when performing coding according to a profile or a level which supports coding of images of 1920×1080 pixels or larger.

When the result of the determination is true in Step S111 (S111, Yes), the bi-prediction-prohibited size determination unit 117 sets, for example, 8×4 pixels, 4×8 pixels, or 4×4 pixels as bi-prediction-prohibited sizes. The bi-prediction-prohibited size is thereby determined. Generally, reduction in the required memory bandwidth is larger when use of bi-prediction is prohibited for a smaller motion compensation size.

When the result of the determination is false in Step S111 (S111, No), the bi-prediction-prohibited size determination unit 117 sets no bi-prediction-prohibited size in Step S113.

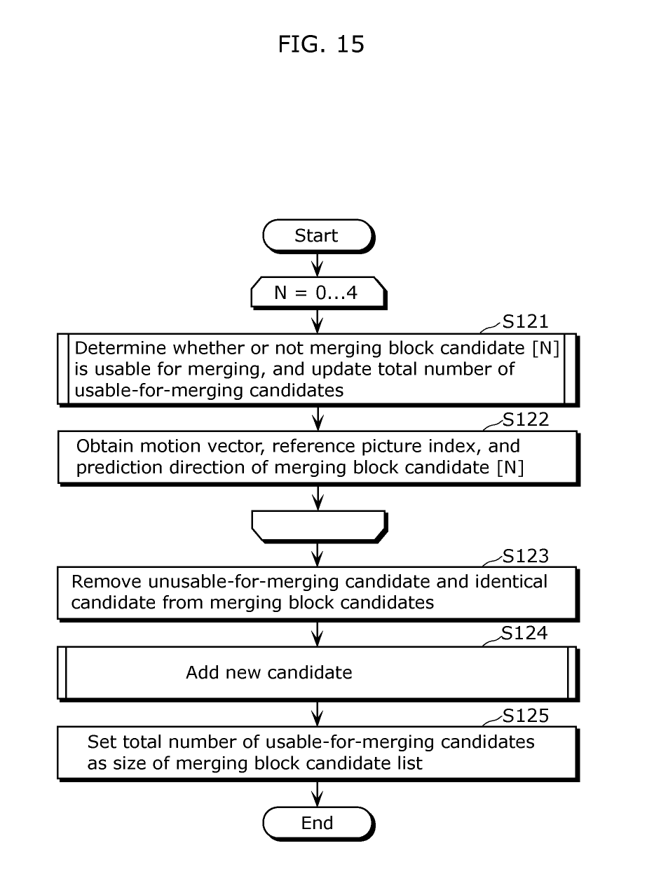

FIG. 15 is a flowchart showing details of the process in Step S102 in FIG. 12. Specifically, FIG. 15 illustrates a method of calculating merging block candidates and the size of a merging block candidate list. FIG. 15 will be described below.

In Step S121, the merging block candidate calculation unit 114 determines whether or not a merging block candidate [N] is a usable-for-merging candidate using a method described later. Then, the merging block candidate calculation unit 114 updates the total number of usable-for-merging candidates according to the result of the determination.

Here, N denotes an index value indicating a merging block candidate. In Embodiment 1, N takes values from 0 to 4. Specifically, the neighboring block A in FIG. 3 is assigned to a merging block candidate [0]. The neighboring block B in FIG. 3 is assigned to a merging block candidate [1]. The co-located merging block is assigned to a merging block candidate [2]. The neighboring block C in FIG. 3 is assigned to a merging block candidate [3]. The neighboring block D in FIG. 3 is assigned to a merging block candidate [4].

In Step S122, the merging block candidate calculation unit 114 obtains the motion vector, reference picture index, and prediction direction of the merging block candidate [N], and adds them to a merging block candidate list.

In Step S123, the merging block candidate calculation unit 114 searches the merging block candidate list for an unusable-for-merging candidate and an identical candidate, and removes the unusable-for-merging candidate and the identical candidate from the merging block candidate list as shown in FIG. 13.

In Step S124, the merging block candidate calculation unit 114 adds a new candidate to the merging block candidate list using a method described later. Here, when a new candidate is added, the merging block candidate calculation unit 114 may reassign merging block candidate indices so that the merging block candidate indices of smaller values are assigned to preexistent merging block candidates in priority to the new candidate. In other words, the merging block candidate calculation unit 114 may reassign the merging block candidate indices so that a merging block candidate index of a larger value is assigned to the new candidate. The amount of codes for merging block candidate indices is thereby reduced.

In Step S125, the merging block candidate calculation unit 114 sets the total number of usable-for-merging candidates calculated in Step S121 as the size of the merging block candidate list. In the example shown in FIG. 13, the calculated number of usable-for-merging candidates is “4”, and the size of the merging block candidate list is set at “4”.

The new candidate in Step S124 is a candidate newly added to merging block candidates using a method described later when the total number of merging block candidates is smaller than the total number of usable-for-merging candidates. Examples of such a new candidate include a neighboring block located above the lower-left neighboring block D in FIG. 3 and a block corresponding to any of neighboring blocks A, B, C, and D for a co-located block. Furthermore, examples of such a new candidate further include a block having a motion vector, a reference picture index, a prediction direction, and the like which are statistically obtained from the whole or a certain region of a reference picture. Thus, when the total number of merging block candidates is smaller than the total number of usable-for-merging candidates, the merging block candidate calculation unit 114 adds a new candidate having a new motion vector, a new reference picture index, and a new prediction direction so that coding efficiency can be increased.

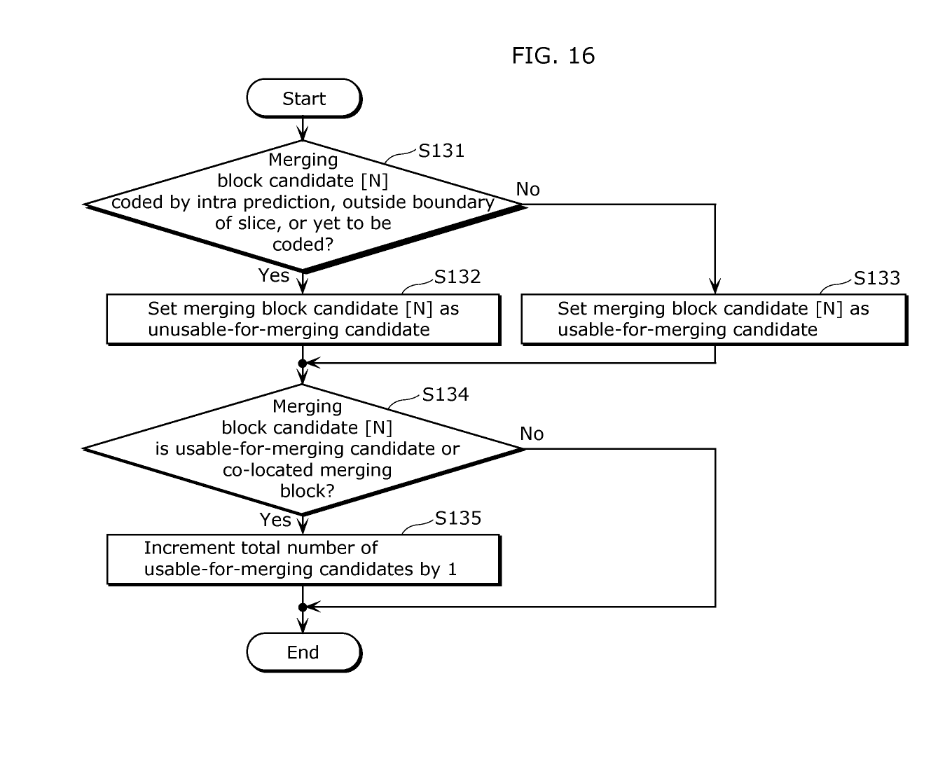

FIG. 16 is a flowchart showing details of the process in Step S121 in FIG. 15. Specifically, FIG. 16 illustrates a method of determining whether or not a merging block candidate [N] is a usable-for-merging candidate and updating the total number of usable-for-merging candidates. FIG. 16 will be described below.

In Step S131, the merging block candidate calculation unit 114 determines whether it is true or false that (1) a merging block candidate [N] has been coded by intra prediction, (2) the merging block candidate [N] is a block outside the boundary of a slice including the current block or the boundary of a picture including the current block, or (3) the merging block candidate [N] is yet to be coded.

When the result of the determination in Step S131 is true (S131, Yes), the merging block candidate calculation unit 114 sets the merging block candidate [N] as an unusable-for-merging candidate in Step S132. When the result of the determination in Step S131 is false (S131, No), the merging block candidate calculation unit 114 sets the merging block candidate [N] as a usable-for-merging candidate in Step S133.

In Step S134, the merging block candidate calculation unit 114 determines whether it is true or false that the merging block candidate [N] is either a usable-for-merging candidate or a co-located merging block candidate. Here, when the result of the determination in Step S134 is true (S134, Yes), the merging block candidate calculation unit 114 updates the total number of merging block candidates by incrementing it by one in Step S135. When the result of the determination in Step S134 is false (S134, No), the merging block candidate calculation unit 114 does not update the total number of usable-for-merging candidates.

Thus, when a merging block candidate is a co-located merging block, the merging block candidate calculation unit 114 increments the total number of usable-for-merging candidate by one regardless of whether the co-located block is a usable-for-merging candidate or an unusable-for-merging candidate. This prevents discrepancy of the numbers of usable-for-merging candidates between the image coding apparatus and the image decoding apparatus even when information on a co-located merging block is lost due to an incident such as packet loss.

The total number of usable-for-merging candidates is set as the size of the merging block candidate list in Step S125 shown in FIG. 15. Furthermore, the size of the merging block candidate list is used in variable-length coding of merging block candidate index in Step S107 shown in FIG. 12. This makes it possible for the image coding apparatus 100 to generate a bitstream which can be normally decoded so that merging block candidate index can be obtained even when information on a reference picture including a co-located block is lost.

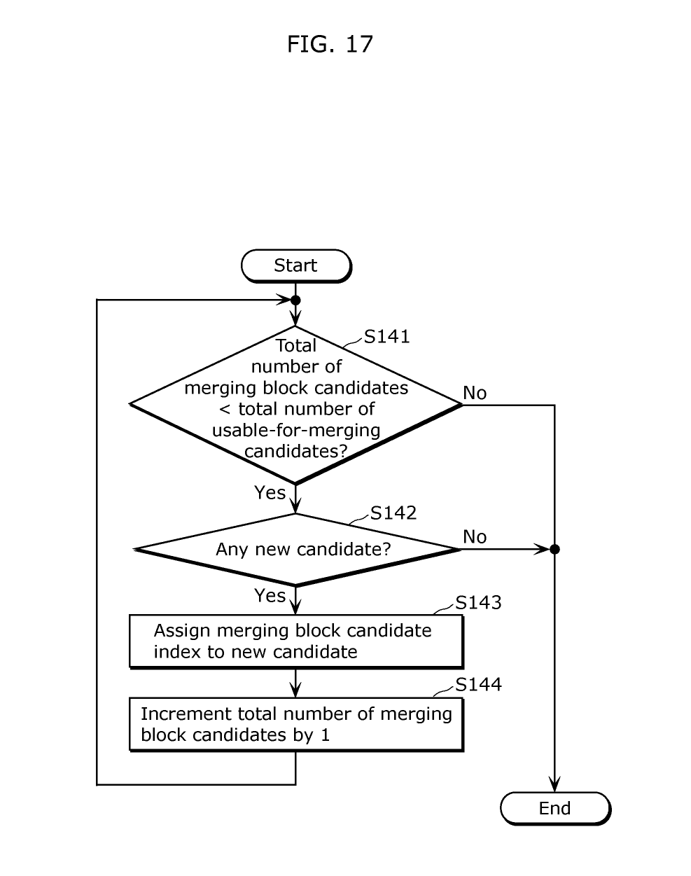

FIG. 17 is a flowchart showing details of the process in Step S124 in FIG. 15. Specifically, FIG. 17 illustrates a method of adding a new candidate. FIG. 17 will be described below.

In Step S141, the merging block candidate calculation unit 114 determines whether or not the total number of merging block candidates is smaller than the total number of usable-for-merging candidates. In other words, the merging block candidate calculation unit 114 determines whether or not the total number of merging block candidate is still below the total number of usable-for-merging candidates.

Here, when the result of the determination in Step S141 is true (S141, Yes), in Step S142, the merging block candidate calculation unit 114 determines whether or not there is a new candidate which can be added as a merging block candidate to the merging block candidate list. Here, when the result of the determination in Step S142 is true (S142, Yes), the merging block candidate calculation unit 114 assigns a merging block candidate index having a value to the new candidate and adds the new candidate to the merging block candidate list in Step S143. Furthermore, in Step S144, the merging block candidate calculation unit 114 increments the total number of merging block candidates by one.

When the result of the determination in Step S141 or in Step S142 is false (S141 or S142, No), the process for adding a new candidate ends. In other words, the process for adding a new candidate ends when the total number of merging block candidates reaches the total number of usable-for-merging candidates or when there is no new candidate.

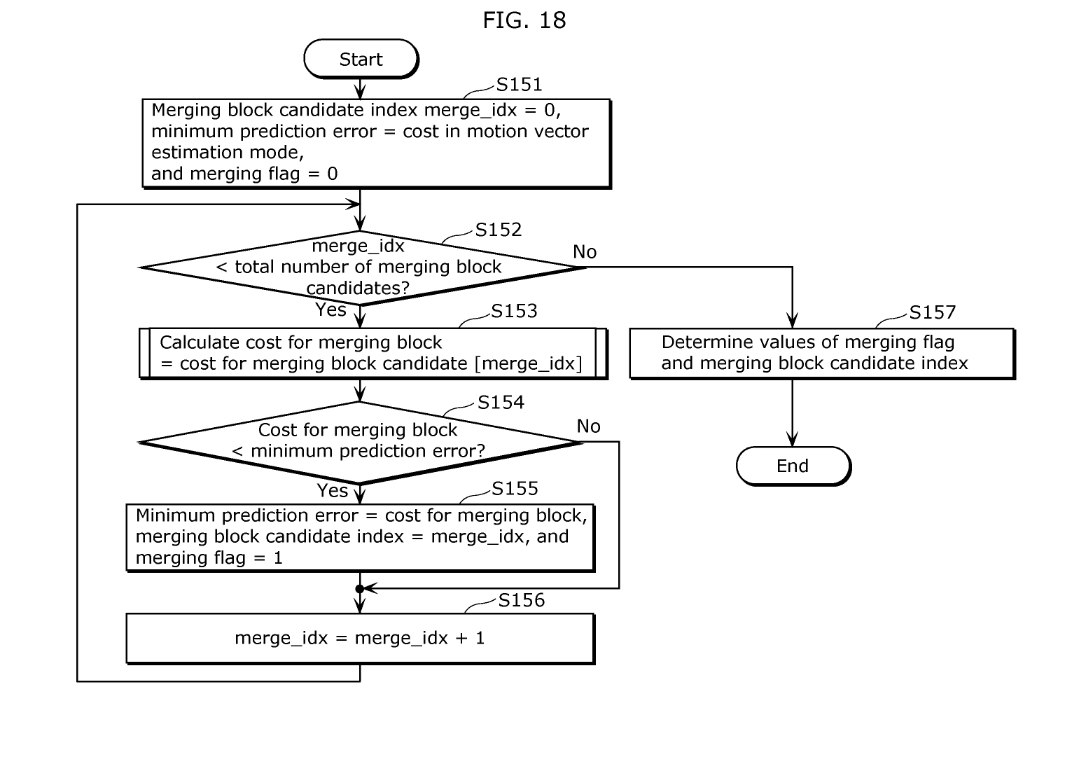

FIG. 18 is a flowchart showing details of the process in Step S103 shown in FIG. 12. Specifically, FIG. 18 illustrates a process for selecting a merging block candidate. FIG. 18 will be described below.

In Step S151, the inter prediction control unit 111 sets a merging block candidate index at 0, the minimum prediction error at the prediction error (cost) in the motion vector estimation mode, and a merging flag at 0. The cost is calculated using the following equation for an R-D optimization model, for example.

Cost=D+λR (EQ. 1)

In Equation 1, D denotes coding distortion. For example, D is the sum of absolute differences between original pixel values of a current block to be coded and pixel values obtained by coding and decoding of the current block using a prediction image generated using a motion vector. R denotes the amount of generated codes. For example, R is the amount of codes necessary for coding a motion vector used for generation of a prediction image. A denotes an undetermined Lagrange multiplier.

In Step S152, the inter prediction control unit 111 determines whether or not the value of a merging block candidate index is smaller than the total number of merging block candidates of a current block. In other words, the inter prediction control unit 111 determines whether or not there is still a merging block candidate on which the process from Step S153 to Step S155 has not been performed yet.

When the result of the determination in Step S152 is true (S152, Yes), in Step S153, the inter prediction control unit 111 calculates cost for a merging candidate to which a merging candidate index is assigned using a method described later according to a bi-prediction-prohibited size. Then, in Step S154, the inter prediction control unit 111 determines whether or not the calculated cost for a merging block candidate is smaller than the minimum prediction error.

Here, when the result of the determination in Step S154 is true (S154, Yes), the inter prediction control unit 111 updates the minimum prediction error, the merging block candidate index, and the value of the merging flag in Step S155. On the other hand, when the result of the determination in Step S154 is false (S154, No), the inter prediction control unit 111 does not update the minimum prediction error, the merging block candidate index, or the value of the merging flag.

In Step S156, the inter prediction control unit 111 increments the merging block candidate index by one, and repeats from Step S152 to Step S156.

When the result of the determination in Step S152 is false (S152, No), that is, when there is no more unprocessed merging block candidate, the inter prediction control unit 111 finally settles the values of the merging flag and merging block candidate index in Step S157.

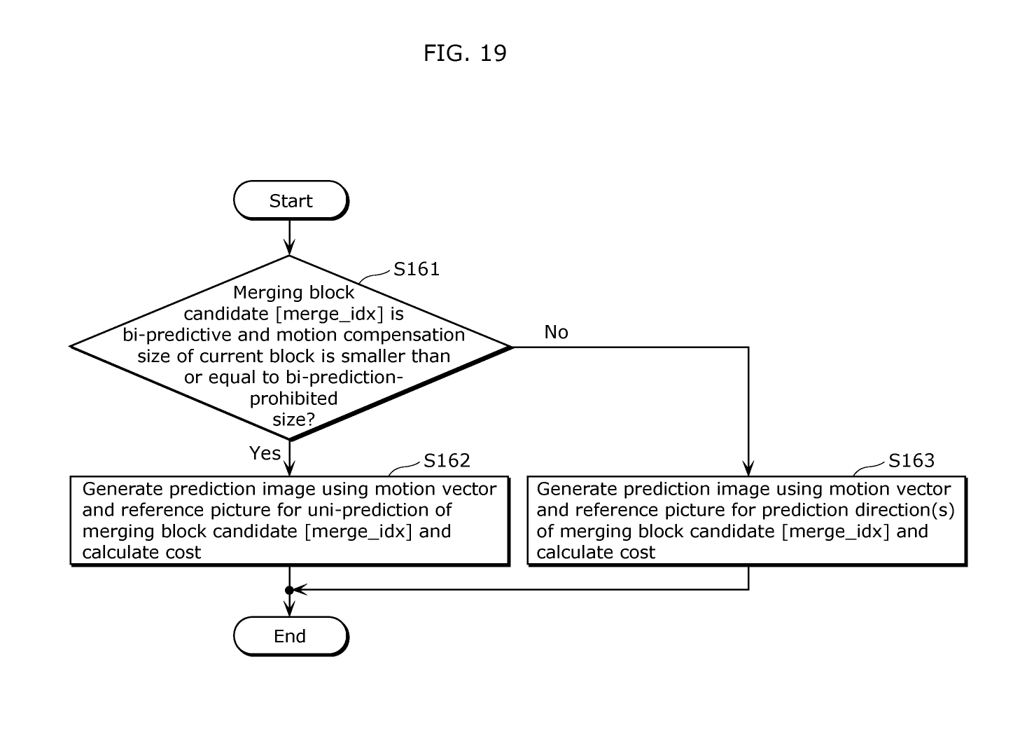

FIG. 19 is a flowchart showing details of the process in Step S153 shown in FIG. 18. Specifically, FIG. 19 illustrates a method of calculating a merging block candidate. FIG. 19 will be described below.

In Step S161, the inter prediction control unit 111 determines whether it is true or false that the merging block candidate assigned with the merging block candidate index merge_idx is bi-predictive and the motion compensation size of the current block is smaller than or equal to a bi-prediction-prohibited size. When the merging block candidate has been coded using bi-prediction, it is determined that the prediction direction of the merging block candidate is bi-predictive.

When the result of the determination in Step S161 is true (S161, Yes), in Step S162, the inter prediction control unit 111 causes the inter prediction unit 110 to generate a prediction image using a motion vector and a reference picture index for uni-prediction of the merging block candidate assigned with the merging block candidate index merge_idx (for example, a motion vector and a reference picture index for uni-prediction for the prediction direction 0), and calculates a cost for the merging block candidate. A motion vector and a reference picture index for the prediction direction 1 may be used as the motion vector and reference picture index for uni-prediction instead of the motion vector and reference picture index for the prediction direction 0.

When the result of the determination in Step S161 is false (S161, No), in Step S163, the inter prediction control unit 111 causes the inter prediction unit 110 to generate a prediction image using a motion vector and a reference picture index for uni-prediction (or motion vectors and reference picture indices for bi-prediction) of the merging block candidate assigned with the merging block candidate index merge_idx, and calculates a cost for the merging block candidate.

Specifically, when the merging block candidate is bi-predictive, the inter prediction control unit 111 causes the inter prediction unit 110 to generate a prediction image using motion vectors and reference picture indices for bi-prediction. When the merging block candidate is uni-predictive, the inter prediction control unit 111 causes the inter prediction unit 110 to generate a prediction image using a motion vector and a reference picture index for uni-prediction. Then, the inter prediction control unit 111 calculates cost for the generated prediction image using the R-D optimization model.

In this manner, when the motion compensation size of a current block is smaller than or equal to a bi-prediction-prohibited size, the image coding apparatus 100 in Embodiment 1 generates a prediction image using a motion vector and a reference picture index for uni-prediction of a merging block candidate regardless of whether the merging block candidate is bi-predictive or uni-predictive. By doing this, the image coding apparatus 100 is capable of coding images with increased coding efficiency using limited memory bandwidth.

A block coded based on a prediction image thus generated using a motion vector and a reference picture index for uni-prediction instead of those for bi-prediction may be used as a neighboring block of a following block to be coded. In this case, the image coding apparatus 100 keeps motion vectors and reference picture indices for bi-prediction of the neighboring block so that coding efficiency can be further increased.

Optionally, the image coding apparatus 100 may perform following steps in the process on an assumption that the block coded using a motion vector and a reference picture index for uni-prediction instead of those for bi-prediction as described above has only the motion vector and reference picture index for uni-prediction.

For example, the image coding apparatus 100 calculates a deblocking filter intensity in deblocking on an assumption that a block coded using a motion vector and a reference picture index for uni-prediction has only the motion vector and reference picture index for uni-prediction. As a result, the image coding apparatus 100 calculates the filter intensity based on the motion vector and reference picture index for uni-prediction.

It should be noted that the case described in Embodiment 1 is not limiting in which a prediction image is generated using a motion vector and a reference picture index for uni-prediction of a merging block candidate when the merging block candidate is bi-predictive and the motion compensation size of a current block is smaller than or equal to a bi-prediction-prohibited size as shown in FIG. 19.

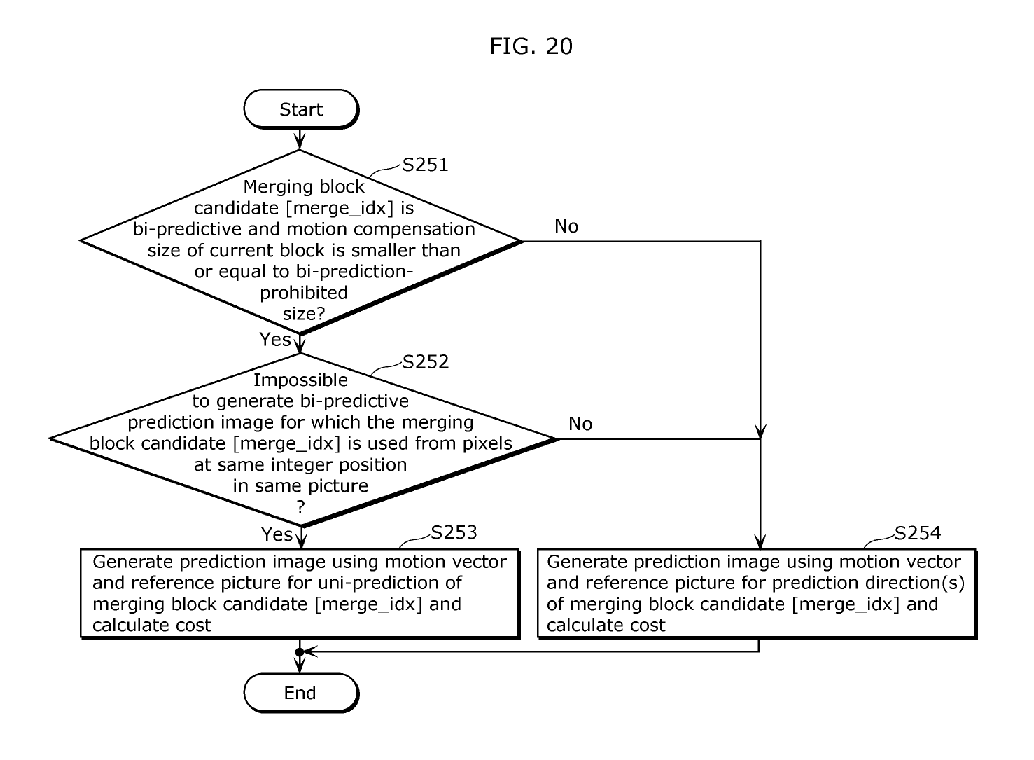

FIG. 20 is a flowchart showing details of the process in Step S153 in FIG. 18 performed in a different way. Specifically, FIG. 19 illustrates another method of calculating a cost for a merging block candidate. FIG. 20 will be described below.

In Step S251, the inter prediction control unit 111 determines whether it is true or false that the merging block candidate is bi-predictive and the motion compensation size of the current block is smaller than or equal to a bi-prediction-prohibited size.

When the result of the determination in Step S251 is true (S251, Yes), in Step S252, the inter prediction control unit 111 determines whether it is true or false that it is impossible to generate, from values of pixels at the same integer position in the same picture, a bi-predictive prediction image for which the merging block candidate is used. When the result of the determination in Step S252 is true (S252, Yes), in S253, the inter prediction control unit 111 causes the inter prediction unit 110 to generate a prediction image using a motion vector and a reference picture index for uni-prediction of the merging block candidate.

When the result of the determination either in Step S251 or in Step S252 is false (S251, No; or S252, No), the inter prediction control unit 111 may cause the inter prediction unit 110 to generate a prediction image using a motion vector and a reference picture index for uni-prediction (or motion vectors and reference picture indices for bi-prediction) of the merging block candidate.

Generally, when it is possible to generate a prediction image for each of the two prediction directions of bi-prediction from values of pixels at the same integer position in the same picture using a motion compensation filter, the prediction image can be generated using a reference picture for uni-prediction read from memory. When this is the case, coding efficiency can be increased while memory bandwidth is being limited without prohibiting bi-prediction.

In Embodiment 1, the total number of usable-for-merging candidates can be calculated by incrementing the total number of usable-for-merging candidates by one each time a merging block candidate is determined as a co-located merging block, regardless of whether or not the co-located merging block is a usable-for-merging candidate. Then, bit sequences to be assigned to merging block candidate indices are determined according to the total number of usable-for-merging candidates calculated in this manner. Alternatively, for example, the total number of usable-for-merging candidates may be calculated by incrementing the total number of usable-for-merging candidates by one for each merging block candidate regardless of whether or not the merging block candidate is a co-located merging block in Step S134 in FIG. 16. In this case, bit sequences are assigned to merging block candidate indices using the total number of usable-for-merging candidates fixed at a maximum value N of the total number of merging block candidates.

In other words, merging block candidate indices may be coded using the size of a merging block candidate list fixed at a maximum value N of the total number of merging block candidates on the assumption that merging block candidates are all usable-for-merging candidates.

For example, in the case shown in Embodiment 1, when the maximum value N of the total number of merging block candidates is five (the neighboring block A, neighboring block B, co-located merging block, neighboring block C, and neighboring block D), the merging block candidate indices may be coded using the size of the merging block candidate list fixedly set at five.

For a further example, when the maximum value N of the total number of merging block candidates is four (the neighboring block A, neighboring block B, neighboring block C, and neighboring block D), the merging block candidate indices may be coded using the size of the merging block candidate list fixedly set at four.

In this manner, the size of the merging block candidate list may be determined according to a maximum value of the total number of merging block candidates.

In this manner, it is possible to generate a bitstream from which a variable-length decoding unit of an image decoding apparatus can decode a merging block candidate index in the bitstream without referencing information on a neighboring block or on a co-located block, so that computational complexity for the variable-length decoding unit can be reduced.

For a further example, a maximum value N of the total number of motion vector predictor candidates may be embedded in a sequence parameter set (SPS), a picture parameter set (PPS), a slice header, or the like.

This makes it possible to change a maximum number N of the total number of motion vector predictor candidates for each picture to be coded so that computational complexity can be reduced and coding efficiency can be increased.

For example, when a current picture to be coded is a picture for which no co-located block is referenced (a B-picture or a P-picture for which an I-picture is referenced), a maximum value of a total number of motion vector predictor candidates is set at four (a neighboring block A, a neighboring block B, a neighboring block C, and a neighboring block D). When a current picture to be coded is a picture for which a co-located block is referenced, a maximum value of a total number of motion vector predictor candidates is set at five (a neighboring block A, a neighboring block B, a co-located block, a neighboring block C, and a neighboring block D). Then, for example, the maximum value may be embedded in a sequence parameter set (SPS), a picture parameter set (PPS), a slice header, or the like.

It should be noted that the example described in Embodiment 1 is not limiting in which merging flag is always attached to a bitstream in merging mode. For example, the merging mode may be forcibly selected depending on a block shape for use in inter prediction of a current block. In this case, the amount of information may be reduced by attaching no merging flag to a bitstream.

It should be noted that the example described in Embodiment 1 is not limiting in which the merging mode is used in which a current block is coded using a prediction direction, a motion vector, and a reference picture index copied from a neighboring block of the current block. For example, a skip merging mode may be used. In the skip merging mode, a current block is coded in the same manner as in the merging mode, using a prediction direction, a motion vector, and a reference picture index copied from a neighboring block of the current block with reference to a merging block candidate list created as shown in (b) in FIG. 13. When all resultant prediction errors are zero for the current block, a skip flag set at 1 and the skip flag and a merging block candidate index are attached to a bitstream. When all of the resultant prediction errors are non-zero, a skip flag is set at 0 and the skip flag, a merging flag, a merging block candidate index, and data of the prediction errors are attached to a bitstream.

It should be noted that the example described in Embodiment 1 is not limiting in which the merging mode is used in which a current block is coded using a prediction direction, a motion vector, and a reference picture index copied from a neighboring block of the current block. For example, a motion vector in the motion vector estimation mode may be coded using a merging block candidate list created as shown in (b) in FIG. 13. Specifically, a difference is calculated by subtracting a motion vector of a merging block candidate indicated by a merging block candidate index from a motion vector in the motion vector estimation mode. Then, the calculated difference and the merging block candidate index are attached to a bitstream.

Alternatively, a difference may be calculated by scaling a motion vector MV_Merge of a merging block candidate using a reference picture index RefIdx_ME in the motion estimation mode and a reference picture index RefIdx_Merge of the merging block candidate and subtracting a motion vector scaledMV_Merge of the merging block candidate obtained by the scaling from the motion vector in the motion estimation mode. Then, the calculated difference and the merging block candidate index are attached to a bitstream. The following is an exemplary formula for the scaling.

scaledMV_Merge=MV_Merge×(POC(RefIdx_ME)−curPOC)/(POC(RefIdx_Merge)−curPOC) (EQ. 2)

Here, POC (RefIdx_ME) denotes the display order of a reference picture indicated by a reference picture index RefIdx_ME. POC (RefIdx_Merge) denotes the display order of a reference picture indicated by a reference picture index RefIdx_Merge. curPOC denotes the display order of a current picture to be coded.

### Embodiment 2

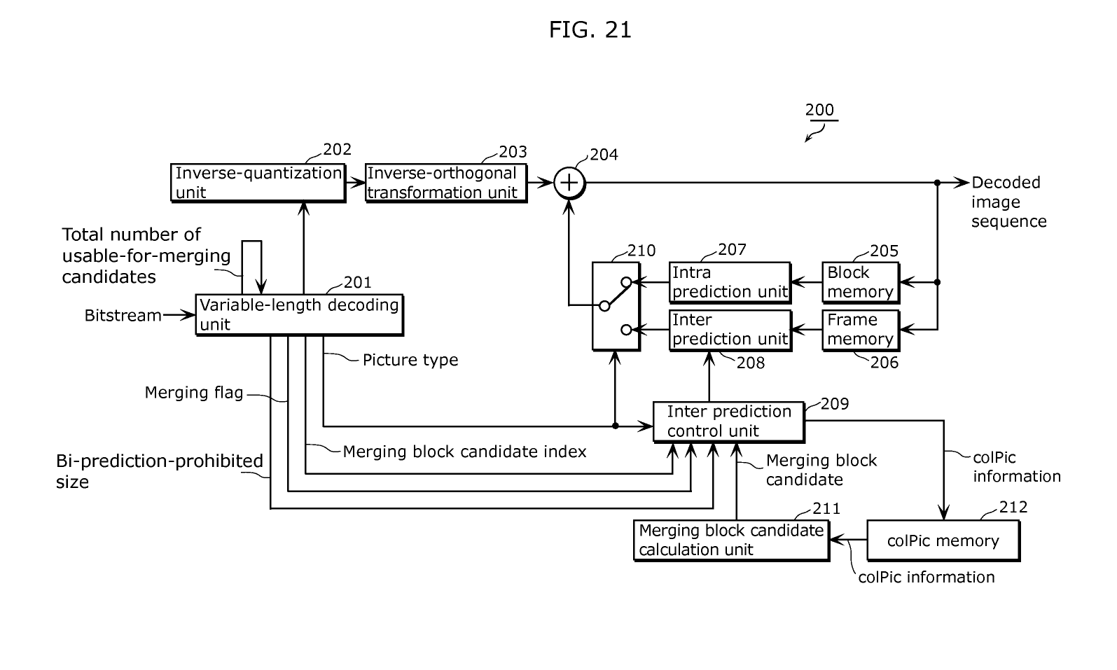

FIG. 21 is a block diagram showing a configuration of an image decoding apparatus 200 according to Embodiment 2. The image decoding apparatus 200 is an apparatus corresponding to the image coding apparatus 100 according to Embodiment 1. Specifically, for example, the image decoding apparatus 200 decodes, on a block-by-block basis, coded images included in a bitstream generated by the image coding apparatus 100 according to Embodiment 1.

As shown in FIG. 21, the image decoding apparatus 200 includes a variable-length decoding unit 201, an inverse-quantization unit 202, an inverse-orthogonal transformation unit 203, an adder 204, block memory 205, frame memory 206, an intra prediction unit 207, an inter prediction unit 208, an inter prediction control unit 209, a switch 210, a merging block candidate calculation unit 211, and colPic memory 212.

The variable-length decoding unit 201 generates picture-type information, a merging flag, a quantized coefficient, and a bi-prediction-prohibited size by performing variable-length decoding on an input bitstream. Furthermore, the variable-length decoding unit 201 obtains a merging block candidate index by performing variable-length decoding using a total number of usable-for-merging candidates described below.

The inverse-quantization unit 202 inverse-quantizes the quantized coefficient obtained by the variable-length decoding.

The inverse-orthogonal-transformation unit 203 generates prediction error data by transforming an orthogonal transform coefficient obtained by the inverse quantization from frequency domain into picture domain.

The block memory 205 stores, in units of a block, decoded image data generated by adding the prediction error data and prediction image data.

The frame memory 206 stores decoded image data in units of a frame.

The intra prediction unit 207 generates prediction image data of a current block to be decoded, by performing intra prediction using the decoded image data stored in the block memory 205 in units of a block.

The inter prediction unit 208 generates inter prediction image data (prediction image) of a current block to be decoded, by performing inter prediction using the decoded image data stored in the frame memory 206 in units of a frame.

When a current block is decoded by intra prediction decoding, the switch 210 outputs intra prediction image data generated by the intra prediction unit 207 as prediction image data of the current block to the adder 204. When a current block is decoded by inter prediction decoding, the switch 210 outputs inter prediction image data generated by the inter prediction unit 208 as prediction image data of the current block to the adder 204.

The merging block candidate calculation unit 211 derives merging block candidates for the merging mode from motion vectors and others of neighboring blocks of a current block and a motion vector and others of a co-located block (colPic information) stored in the colPic memory 212, using a method described later. Furthermore, the merging block candidate calculation unit 211 assigns merging block candidate indices each having a different value to the derived merging block candidates. Then, the merging block candidate calculation unit 211 transmits the merging block candidates and merging block candidate indices to the inter prediction control unit 209.

When the merging flag decoded is “0”, the inter prediction control unit 209 causes the inter prediction unit 208 to generate an inter prediction image using information for motion vector estimation mode. When the merging flag is “1”, the inter prediction control unit 209 determines, based on decoded merging block candidate indices, motion vectors, reference picture indices, and prediction directions of a plurality of merging block candidates for use in inter prediction. Then, the inter prediction control unit 209 causes the inter prediction unit 208 to generate an inter prediction image using the determined motion vector, reference picture index, and prediction direction in a manner according to the bi-prediction-prohibited size, which will be described later. Furthermore, the inter prediction control unit 209 transfers colPic information including the motion vector of the current block to the colPic memory 212.

Finally, the adder 204 generates decoded image data by adding prediction image data and prediction error data.

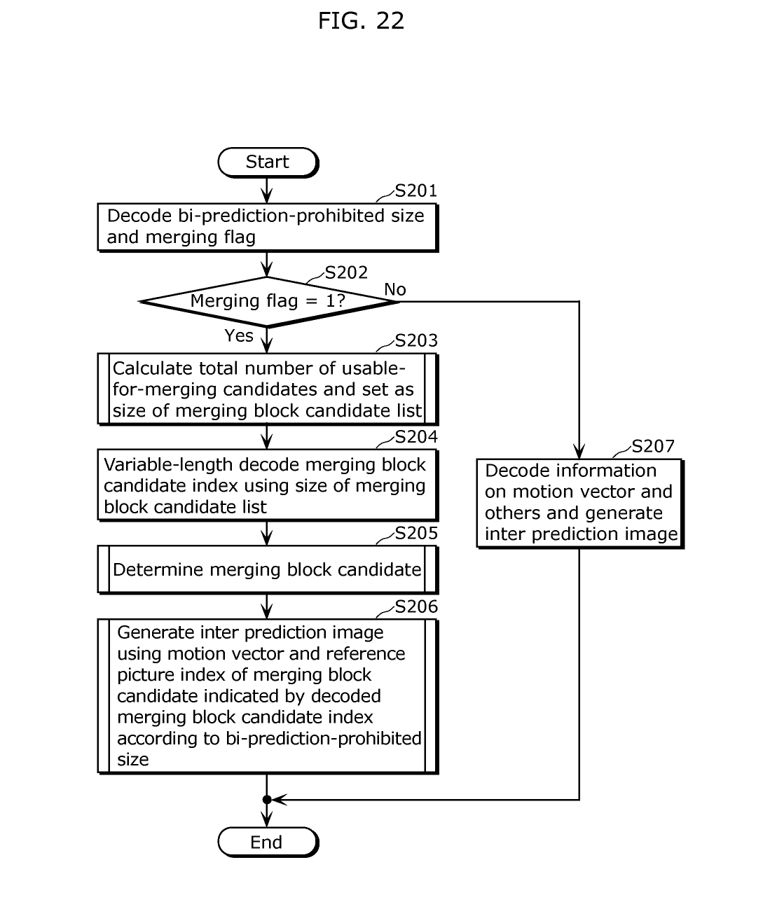

FIG. 22 is a flowchart showing processing operations of the image decoding apparatus 200 according to Embodiment 2.

In Step S201, the variable-length decoding unit 201 decodes a bi-prediction-prohibited size and a merging flag.

When the merging flag is “1” in Step S202 (S202, Yes), in Step S203, the merging block candidate calculation unit 211 calculates the total number of usable-for-merging candidates using a method described later. Then, the merging block candidate calculation unit 211 sets the calculated total number of usable-for-merging candidates as the size of a merging block candidate list.

In Step S204, the variable-length decoding unit 201 performs variable-length decoding on a merging block candidate index included in a bitstream using the size of the merging block candidate list.

In Step S205, the merging block candidate calculation unit 211 generates merging block candidates from neighboring blocks and a co-located block of a current block to be decoded using a method described later.

In Step S206, the inter prediction control unit 209 causes the inter prediction unit 208 to generate an inter prediction image using a decoded bi-prediction-prohibited size and the motion vector, reference picture index, and prediction direction of the merging block candidate indicated by the merging block candidate index.

When the merging flag is “0” in Step S202 (S202, No), in Step S207, the inter prediction unit 208 generates an inter prediction image using information for motion vector estimation mode decoded by the variable-length decoding unit 201.

Alternatively, when the size of a merging block candidate list calculated in Step S203 is “1”, a merging block candidate index may be estimated to be “0” without being decoded.

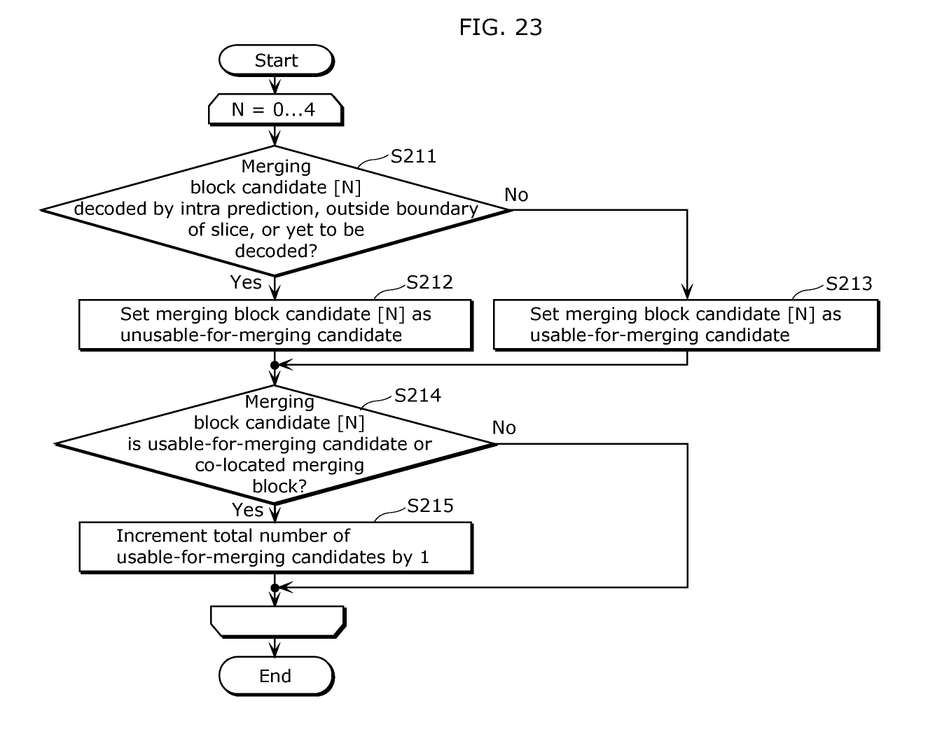

FIG. 23 is a flowchart showing details of the process in Step S203 shown in FIG. 22. Specifically, FIG. 23 illustrates a method of determining whether or not a merging block candidate [N] is a usable-for-merging candidate and calculating the total number of usable-for-merging candidates. FIG. 23 will be described below.

In Step S211, the merging block candidate calculation unit 211 determines whether it is true or false that (1) a merging block candidate [N] has been decoded by intra prediction, (2) the merging block candidate [N] is a block outside the boundary of a slice including the current block or the boundary of a picture including the current block, or (3) the merging block candidate [N] is yet to be decoded.

When the result of the determination in Step S211 is true (S211, Yes), the merging block candidate calculation unit 211 sets the merging block candidate [N] as an unusable-for-merging candidate in Step S212. When the result of the determination in Step S211 is false (S211, No), the merging block candidate calculation unit 211 sets the merging block candidate [N] as a usable-for-merging candidate in Step S213.

In Step S214, the merging block candidate calculation unit 211 determines whether it is true or false that the merging block candidate [N] is either a usable-for-merging candidate or a co-located merging block candidate. Here, when the result of the determination in Step S214 is true (S214, Yes), the merging block candidate calculation unit 211 updates the total number of merging block candidates by incrementing it by one in Step S215. When the result of the determination in Step S214 is false (S214, No), the merging block candidate calculation unit 311 does not update the total number of usable-for-merging candidates.

Thus, when a merging block candidate is a co-located merging block, the merging block candidate calculation unit 211 increments the total number of usable-for-merging candidates by one regardless of whether the co-located block is a usable-for-merging candidate or an unusable-for-merging candidate. This prevents discrepancy of the numbers of usable-for-merging candidates between the image coding apparatus and the image decoding apparatus even when information on a co-located merging block is lost due to an incident such as packet loss.

The total number of usable-for-merging candidates is set as the size of a merging block candidate list in Step S203 shown in FIG. 22. Furthermore, the size of the merging block candidate list is used in variable-length decoding of merging block candidate indices in Step S204 shown in FIG. 22. This makes it possible for the image decoding apparatus 200 to decode merging block candidate indices normally even when information on reference picture including a co-located block is lost.

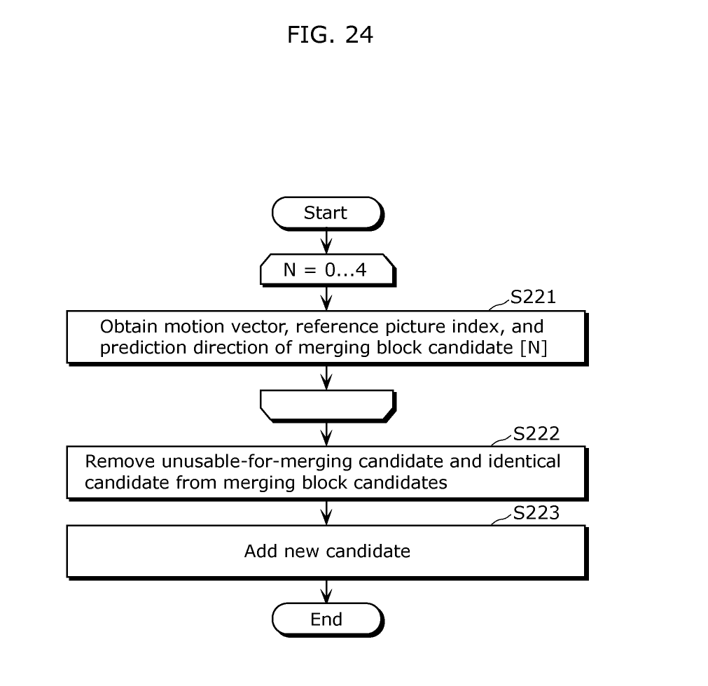

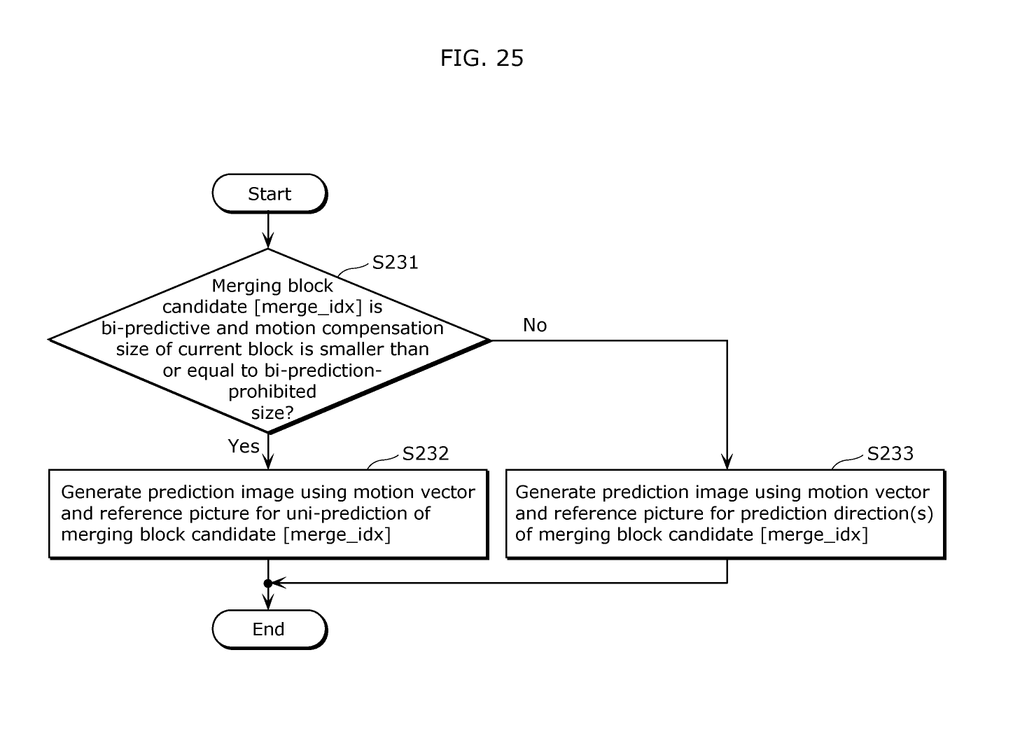

FIG. 24 is a flowchart showing details of the process in Step S205 shown in FIG. 22. Specifically, FIG. 24 illustrates a method of calculating a merging block candidate. FIG. 24 will be described below.

In Step S221, the merging block candidate calculation unit 211 obtains a set of a motion vector, a reference picture index, and a prediction direction of a merging block candidate [N], and adds it to a merging block candidate list.

In Step S222, the merging block candidate calculation unit 211 searches the merging block candidate list for an unusable-for-merging candidate and an identical candidate, and removes the unusable-for-merging candidate and the identical candidate from the merging block candidate list as shown in FIG. 13.

In Step S223, the merging block candidate calculation unit 211 adds a new candidate to the merging block candidate list in the same manner as shown in FIG. 17.

FIG. 25 is a flowchart showing details of the process in Step S206 in FIG. 22. Specifically, FIG. 25 illustrates a method of generating a prediction image according to a bi-prediction-prohibited size. FIG. 25 will be described below.

In Step S231, the inter prediction control unit 209 determines whether it is true or false that the merging block candidate assigned with the merging block candidate index merge_idx is bi-predictive and the motion compensation size of the current block to be decoded is smaller than or equal to a bi-prediction-prohibited size.

When the result of the determination in Step S231 is true (S231, Yes), in Step S232, the inter prediction control unit 209 causes the inter prediction unit 208 to generate a prediction image using a motion vector and a reference picture index for uni-prediction of the merging block candidate assigned with the merging block candidate index merge_idx (for example, a motion vector and a reference picture index for the prediction direction 0). A motion vector and a reference picture index for the prediction direction 1 can be used as a motion vector and a reference picture index for uni-prediction instead of the motion vector and reference picture index for the prediction direction 0.

When the result of the determination in Step S231 is false (S231, No), in Step S233, the inter prediction control unit 209 causes the inter prediction unit 208 to generate a prediction image using a motion vector and a reference picture index for uni-prediction (or motion vectors and reference picture indices for bi-prediction) of the merging block candidate assigned with the merging block candidate index merge_idx. Specifically, when the merging block candidate is bi-predictive, the inter prediction control unit 209 causes the inter prediction unit 208 to generate a prediction image using motion vectors and reference picture indices for two directions. When the merging block candidate is uni-predictive, the inter prediction control unit 209 causes the inter prediction unit 110 to generate a prediction image using uni-prediction.

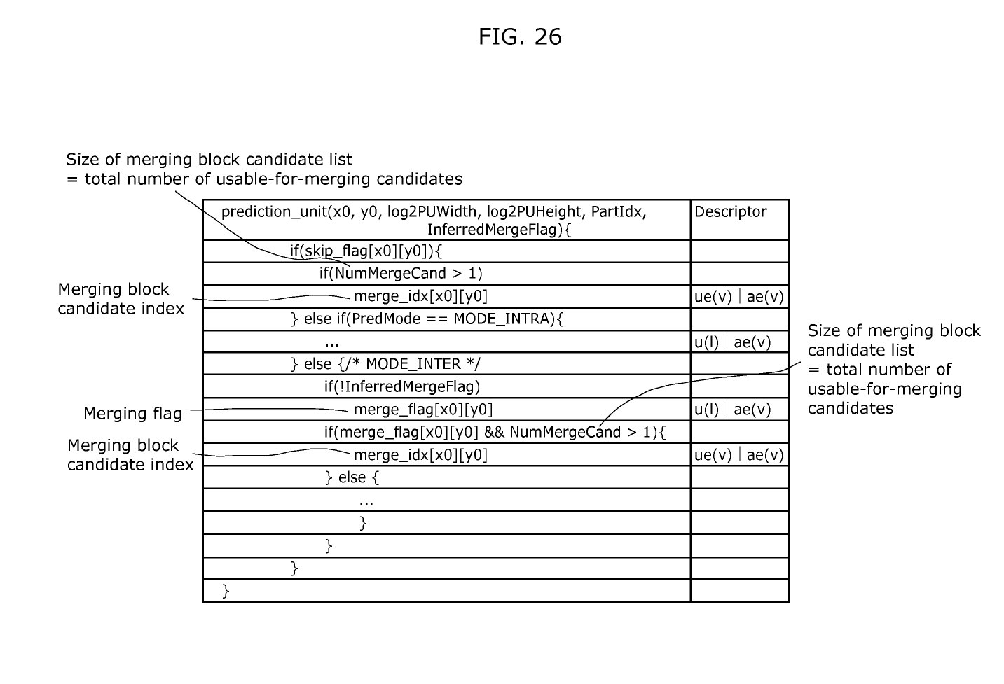

FIG. 26 shows exemplary syntax for attachment of a merging block candidate index to a bitstream. In FIG. 26, merge_idx represents a merging block candidate index, and merge_flag represents a merging flag. NumMergeCand represents the size of a merging block candidate list. In Embodiment 2, NumMergeCand is set at the total number of usable-for-merging candidates calculated in the process flow shown in FIG. 23.

In Embodiment 2, when the motion compensation size of a current block is smaller than or equal to a bi-prediction-prohibited size, a prediction image is thus generated using a motion vector and a reference picture index for uni-prediction of a merging block candidate which is bi-predictive. With this, a bitstream coded with increased efficiency using a limited memory bandwidth can be decoded appropriately.

The block decoded based on a prediction image generated using a motion vector and a reference picture index for uni-prediction instead of those for bi-prediction may be used as a neighboring block of a following block to be decoded. In this case, the image decoding apparatus 200 keeps motion vectors and reference picture indices for bi-prediction of the neighboring block so that a bitstream with increased coding efficiency can be appropriately decoded.

Optionally, the image decoding apparatus 200 may perform following processes on an assumption that the block decoded using a motion vector and a reference picture index for uni-prediction instead of those for bi-prediction as described above has only the motion vector and reference picture index for uni-prediction.

For example, the image decoding apparatus 200 calculates a deblocking filter intensity in deblocking on an assumption that the block decoded using a motion vector and a reference picture index for uni-prediction has only the motion vector and reference picture index for uni-prediction. As a result, the image decoding apparatus 200 calculates the filter intensity based on the motion vector and reference picture index for uni-prediction.

It should be noted that the case described in Embodiment 2 is not limiting in which a prediction image is generated using a motion vector and a reference picture index for uni-prediction of a merging block candidate when a merging block candidate is bi-predictive and the motion compensation size of a current block is smaller than or equal to a bi-prediction-prohibited size as shown in FIG. 25.

For example, as in FIG. 20 described in Embodiment 1, when a merging block candidate is bi-predictive and the motion compensation size of a current block to be decoded is smaller than or equal to a bi-prediction-prohibited size, the inter prediction control unit 209 may determine whether or not it is possible to generate, from values of pixels at the same integer position in the same picture, a bi-predictive prediction image for which the merging block candidate is used. When the result of the determination is true, the inter prediction control unit 209 causes the inter prediction unit 208 to generate a prediction image using the motion vector and a reference picture index for uni-prediction of the merging block candidate. When the result of the determination is false, the inter prediction control unit 209 may cause the inter prediction unit 208 to generate a prediction image using a motion vector and a reference picture index for uni-prediction (or motion vectors and reference picture indices for bi-prediction) of the merging block candidate.

Generally, when it is possible to generate a prediction image for each of the two prediction directions of bi-prediction from values of pixels at the same integer position in the same picture using a motion compensation filter, the prediction image can be generated using a reference picture for uni-prediction read from memory. When this is the case, a bitstream coded with increased efficiency using a limited memory bandwidth can be decoded appropriately without need for prohibiting bi-prediction.

In Embodiment 2, the total number of usable-for-merging candidates can be calculated by incrementing the total number of usable-for-merging candidates by one each time a merging block candidate is determined as a co-located merging block, regardless of whether or not the co-located merging block is a usable-for-merging candidate. Then, bit sequences to be assigned to merging block candidate indices are determined according to the total number of usable-for-merging candidates calculated in this manner. Optionally, for example, the total number of usable-for-merging candidates calculated may be calculated by incrementing the total number of usable-for-merging candidates by one for each merging block candidate regardless of whether or not the merging block candidate is a co-located merging block in Step S214 in FIG. 23. Bit sequences are assigned to merging block candidate indices using the total number of usable-for-merging candidates fixed at a maximum value N of the total number of merging block candidates.

In other words, merging block candidate indices may be decoded using the size of a merging block candidate list fixed at a maximum value N of the total number of merging block candidates on the assumption that merging block candidates are all usable-for-merging candidates.

For example, in Embodiment 2, the maximum value N of the total number of merging block candidates is 5 (neighboring block A, neighboring block B, co-located merging block, neighboring block C, and neighboring block D). In this case, merging block candidate indices may be decoded using the size of a merging block candidate list fixedly set at “5”.

It is therefore possible for the variable-length decoding unit 201 to decode a merging block candidate index in a bitstream without referencing information on a neighboring block or on a co-located block. In this case, for example, Step S214 and Step S215 shown in FIG. 23 can be skipped so that the computational complexity for the variable-length decoding unit 201 can be reduced.

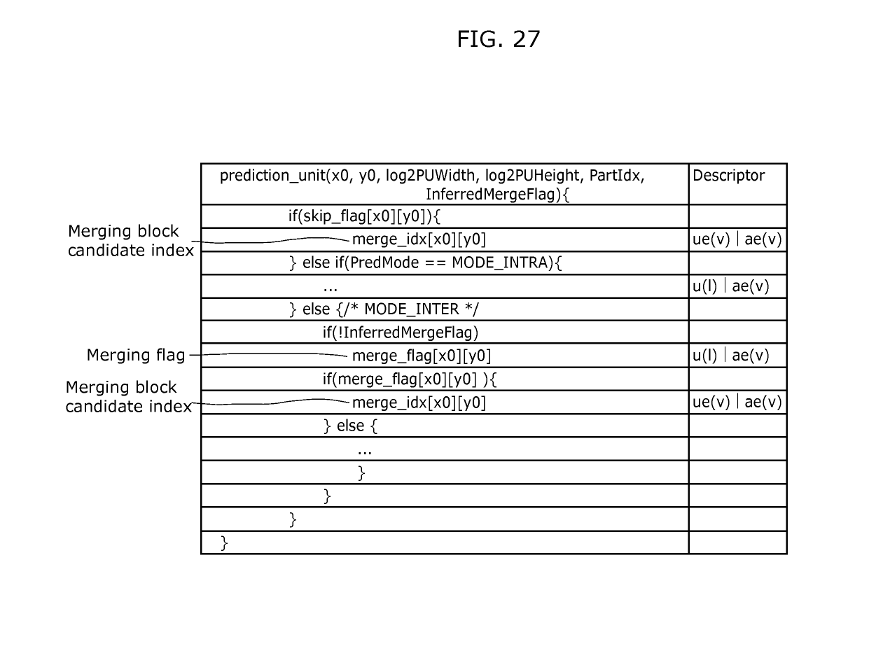

FIG. 27 shows exemplary syntax in the case where the size of a merging block candidate list is fixed at a maximum value of the total number of merging block candidates.

As can be seen in FIG. 27, NumMergeCand can be omitted from syntax when the size of a merging block candidate list is fixed at a maximum value of the total number of merging block candidates.

Then, the image decoding apparatus 200 may determine a maximum value N of the total number of motion vector predictor candidates using a value embedded in a sequence parameter set (SPS), a picture parameter set (PPS), a slice header, or the like.

This makes it possible to change the maximum number N of the total number of motion vector predictor candidates appropriately for each picture to be coded, so that computational complexity can be reduced and a bitstream coded with increased efficiency can be appropriately decoded.

For example, when a current picture to be decoded is a picture for which no co-located block is referenced (a B-picture or a P-picture for which an I-picture is referenced), a maximum value of the total number of motion vector predictor candidates is set at four (a neighboring block A, a neighboring block B, a neighboring block C, and a neighboring block D). When a current picture to be decoded is a picture for which a co-located block is referenced, a maximum value of the total number of motion vector predictor candidates is set at five (a neighboring block A, a neighboring block B, a co-located block, a neighboring block C, and a neighboring block D). Then, the set value is embedded in a sequence parameter set (SPS), a picture parameter set (PPS), a slice header, or the like. When decoding a bitstream in which such a value is embedded, the image decoding apparatus 200 decodes a maximum value N of the total number of motion vector predictor candidates in a sequence parameter set (SPS), a picture parameter set (PPS), a slice header, or the like, and decodes a motion vector predictor index using the maximum value N.

### Embodiment 3

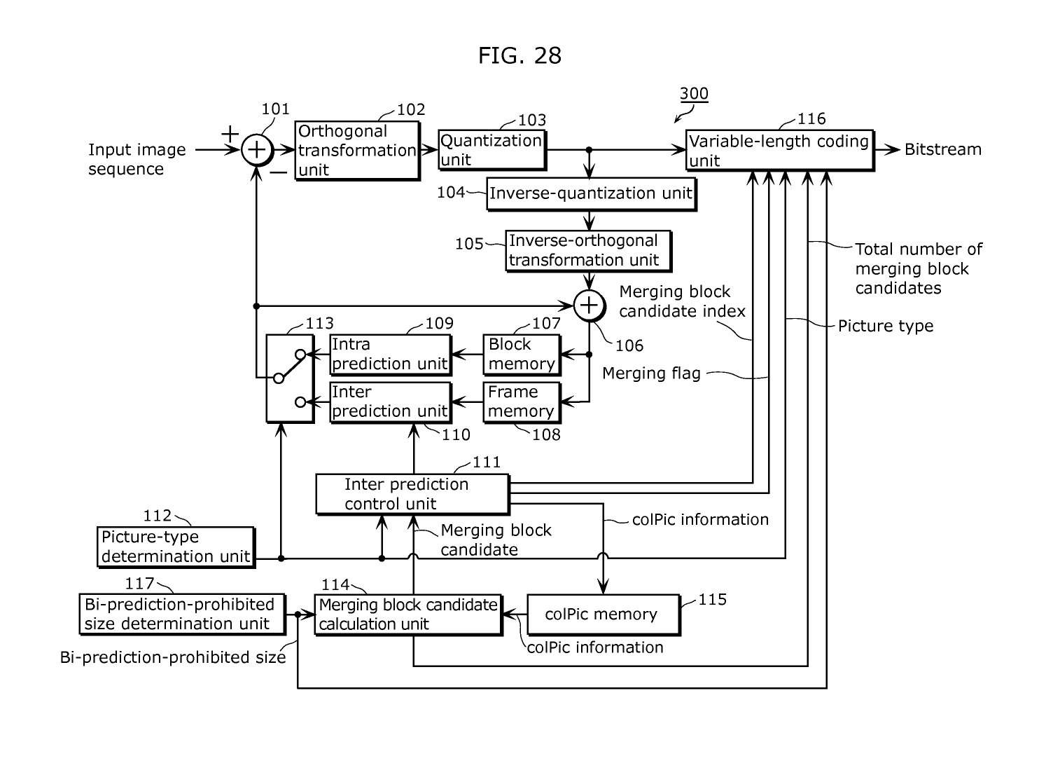

FIG. 28 is a block diagram showing a configuration of an image coding apparatus 300 in which an image coding method according to Embodiment 3 is used. Embodiment 3 is different from Embodiment 1 only in that a merging block candidate is calculated according to a bi-prediction-prohibited size (or a merging block candidate list is generated according to a bi-prediction-prohibited size), therefore description of common points is omitted.

As shown in FIG. 28, the image coding apparatus 300 includes a subtractor 101, an orthogonal transformation unit 102, a quantization unit 103, an inverse-quantization unit 104, an inverse-orthogonal-transformation unit 105, an adder 106, block memory 107, frame memory 108, an intra prediction unit 109, an inter prediction unit 110, an inter prediction control unit 111, a picture-type determination unit 112, a switch 113, a merging block candidate calculation unit 114, colPic memory 115, a variable-length coding unit 116, and a bi-prediction-prohibited size determination unit 117

The bi-prediction-prohibited size determination unit 117 determines a motion compensation size for which bi-prediction is prohibited in the same manner as shown in FIG. 14 and outputs the determined bi-prediction-prohibited size to the merging block candidate calculation unit 114 and the variable-length coding unit 116.

For example, the merging block candidate calculation unit 114 derives merging block candidates for the merging mode using neighboring blocks and colPic information of a current block in a manner according to the bi-prediction-prohibited size. The colPic information is stored in the colPic memory, indicating information on a co-located block of the current block, such as a motion vector. Furthermore, the merging block candidate calculation unit 114 calculates the total number of the merging block candidates in the same manner as shown in FIG. 15. Furthermore, the merging block candidate calculation unit 114 assigns merging block candidate indices to the derived merging block candidates. Then, the merging block candidate calculation unit 114 transmits the merging block candidates and merging block candidate indices to the inter prediction control unit 111. Furthermore, the merging block candidate calculation unit 114 transmits the calculated total number of usable-for-merging candidates to the variable-length coding unit 116.

The inter prediction control unit 111 performs inter prediction using a prediction image (or a prediction mode) which yields the smallest prediction error among an inter prediction image generated using a motion vector derived by motion estimation and inter prediction images generated using motion vectors derived in the merging mode. Furthermore, the inter prediction control unit 111 transmits a merging flag indicating whether or not the selected prediction mode is the merging mode to the variable-length coding unit 116. Furthermore, the inter prediction control unit 111 transmits a merging block candidate index corresponding to the determined merging block candidate to the variable-length coding unit 116 when the selected prediction mode is the merging mode. Furthermore, the inter prediction control unit 111 transmits colPic information including a motion vector of the current block to the colPic memory 115.

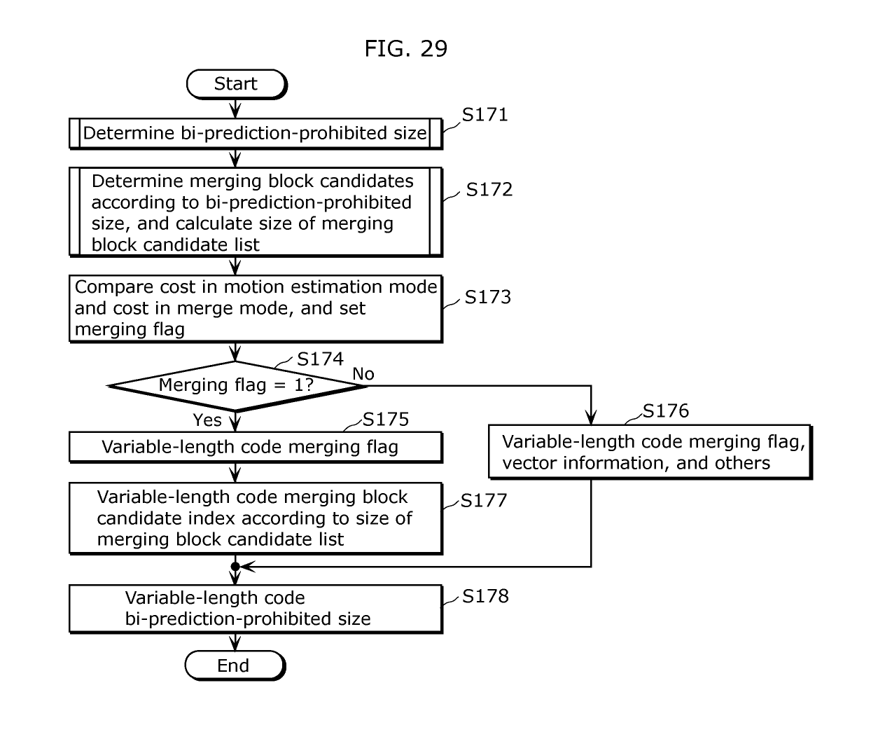

FIG. 29 is a flowchart showing processing operations of the image coding apparatus 300 according to Embodiment 3.

In Step S171, the bi-prediction-prohibited size determination unit 117 determines a motion compensation size for which use of bi-prediction is prohibited. The determination is made in the same manner as in Step S101 in FIG. 12.

In Step S172, the merging block candidate calculation unit 114 derives merging block candidates from neighboring blocks and a co-located block of a current block using a method according to the bi-prediction-prohibited size, which will be described later. Furthermore, the merging block candidate calculation unit 114 calculates the size of a merging block candidate list.

For example, in the case shown in FIG. 3, the merging block candidate calculation unit 114 selects the neighboring blocks A to D as merging block candidates. Furthermore, the merging block candidate calculation unit 114 calculates, as a merging block candidate, a co-located merging block having a motion vector, a reference picture index, and a prediction direction which are calculated from the motion vector of a co-located block using the time prediction mode.

The merging block candidate calculation unit 114 assigns merging block candidate indices to the respective merging block candidates as shown in (a) in FIG. 13. Next, the merging block candidate calculation unit 114 removes unusable-for-merging candidates and identical candidates and adding new candidates to calculate a merging block candidate list as shown in (b) in FIG. 13 and the size of the merging block candidate list.

Shorter codes are assigned to merging block candidate indices of smaller values. In other words, the smaller the value of a merging block candidate index, the smaller the amount of information necessary for indicating the merging block candidate index.

On the other hand, the larger the value of a merging block candidate index, the larger the amount of information necessary for the merging block candidate index. Therefore, coding efficiency will be increased when merging block candidate indices of smaller values are assigned to merging block candidates which are more likely to have motion vectors of higher accuracy and reference picture indices of higher accuracy.

Therefore, the merging block candidate calculation unit 114 may count the total number of times of selection of each merging block candidates as a merging block, and assign merging block candidate indices of smaller values to blocks with a larger total number of the times. Specifically, this can be achieved by specifying a merging block selected from neighboring blocks and assigning a merging block candidate index of a smaller value to the specified merging block when a current block is coded.

When a merging block candidate does not have information such as a motion vector (for example, when the merging block is a block coded by intra prediction, it is located outside the boundary of a picture or the boundary of a slice, or it is yet to be coded), the merging block candidate is unusable for coding.

In Embodiment 1, such a merging block candidate unusable for coding is referred to as an unusable-for-merging candidate, and a merging block candidate usable for coding is referred to as a usable-for-merging candidate. In addition, among a plurality of merging block candidates, a merging block candidate identical in motion vector, reference picture index, and prediction direction with any other merging block is referred to as an identical candidate.

In the case shown in FIG. 3, the neighboring block C is an unusable-for-merging candidate because it is a block coded by intra prediction. The neighboring block D is an identical candidate because it is identical in motion vector, reference picture index, and prediction direction with the neighboring block A.

In Step S173, the inter prediction control unit 111 selects a prediction mode based on comparison between prediction error of a prediction image generated using a motion vector derived by motion estimation and prediction error of a prediction image generated using a motion vector obtained from a merging block candidate. When the selected prediction mode is the merging mode, the inter prediction control unit 111 sets the merging flag to 1, and when not, the inter prediction control unit 111 sets the merging flag to 0.

In Step S174, whether or not the merging flag is 1 (that is, whether or not the selected prediction mode is the merging mode) is determined.

When the result of the determination in Step S174 is true (S174, Yes), the variable-length coding unit 116 attaches the merging flag to a bitstream in Step S175. Subsequently, in Step S177, the variable-length coding unit 116 assigns bit sequences according to the size of the merging block candidate list as shown in FIG. 5 to the merging block candidate indices of merging block candidates to be used for coding. Then, the variable-length coding unit 116 performs variable-length coding on the assigned bit sequence.

When the result of the determination in Step S174 is false (S174, No), the variable-length coding unit 116 attaches information on a merging flag and a motion estimation vector mode to a bitstream in Step S176.

In Step S178, the variable-length coding unit 116 performs variable-length coding on the bi-prediction-prohibited size and attaches the bi-prediction-prohibited size to the bitstream. The bi-prediction-prohibited size is attached as size information to an SPS, a PPS, a slice header or the like in a bitstream. The bi-prediction-prohibited size to be attached to an SPS, a PPS, a slice header or the like in a bitstream may be information in any form which indicates a motion compensation size for which bi-prediction is prohibited.

In Embodiment 3, a merging block candidate index having a value of “0” is assigned to the neighboring block A as shown in (a) in FIG. 13. A merging block candidate index having a value of “1” is assigned to the neighboring block B. A merging block candidate index having a value of “2” is assigned to the co-located merging block. A merging block candidate index having a value of “3” is assigned to the neighboring block C. A merging block candidate index having a value of “4” is assigned to the neighboring block D.

It should be noted that the merging block candidate indices having such a value may be assigned otherwise. For example, when a new candidate is added, the variable-length coding unit 116 may assign smaller values to preexistent merging block candidates and a larger value to the new candidate. In other words, the variable-length coding unit 116 may assign a merging block candidate index of a smaller value to a preexistent merging block candidate in priority to a new candidate.

Furthermore, merging block candidates are not limited to the blocks at the positions of the neighboring blocks A, B, C, and D. For example, a neighboring block located above the lower left neighboring block D can be used as a merging block candidate. Furthermore, it is not necessary to use all the neighboring blocks as merging block candidates. For example, it is also possible to use only the neighboring blocks A and B as merging block candidates.

Furthermore, although the variable-length coding unit 116 attaches a merging block candidate index to a bitstream in Step S177 in FIG. 29 in Embodiment 3, attaching such a merging block candidate index to a bitstream is not always necessary. For example, the variable-length coding unit 116 need not attach a merging block candidate index to a bitstream when the size of the merging block candidate list is “1”. The amount of information on the merging block candidate index is thereby reduced.

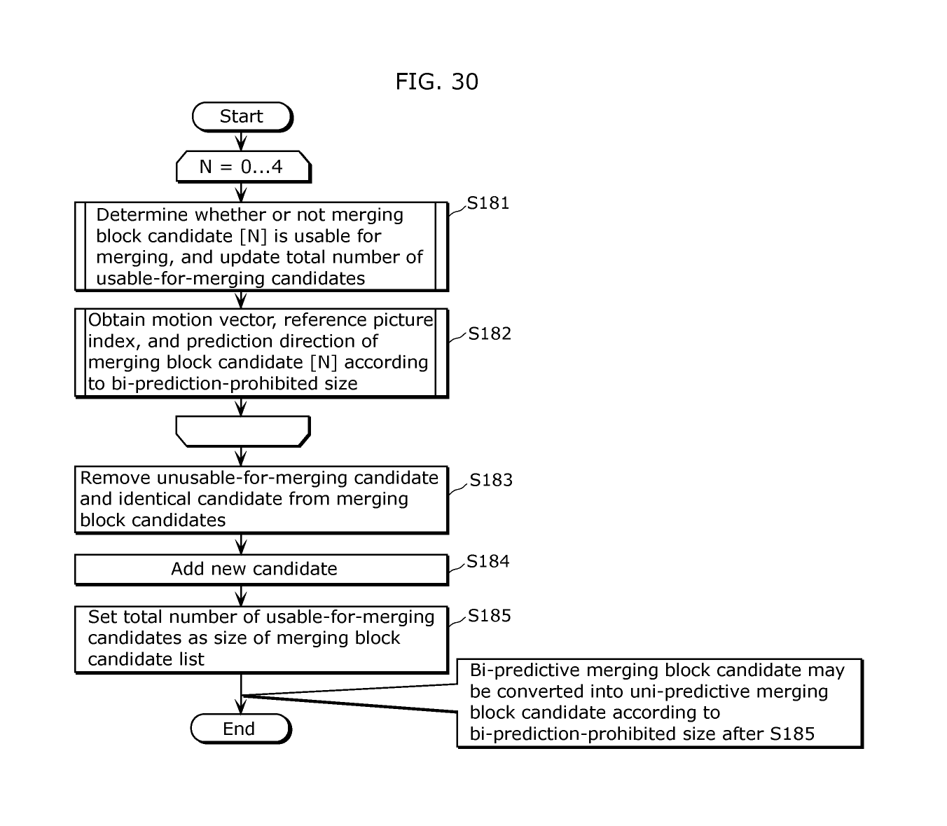

FIG. 30 is a flowchart showing details of the process in Step S172 in FIG. 29. Specifically, FIG. 30 illustrates a method of calculating merging block candidates and the size of a merging block candidate list. FIG. 30 will be described below.

In Step S181, the merging block candidate calculation unit 114 determines whether or not a merging block candidate [N] is a usable-for-merging candidate. Then, the merging block candidate calculation unit 114 updates the total number of usable-for-merging candidates according to the result of the determination.

Here, N denotes an index value indicating a merging block candidate. In Embodiment 1, N takes values from 0 to 4. Specifically, the neighboring block A in FIG. 3 is assigned to a merging block candidate [0]. The neighboring block B in FIG. 3 is assigned to a merging block candidate [1]. The co-located merging block is assigned to a merging block candidate [2]. The neighboring block C in FIG. 3 is assigned to a merging block candidate [3]. The neighboring block D in FIG. 3 is assigned to a merging block candidate [4].

In Step S182, the merging block candidate calculation unit 114 obtains the motion vector, reference picture index, and prediction direction of the merging block candidate [N] using a method according to a bi-prediction-prohibited size, and adds them to a merging block candidate list.

In Step S183, the merging block candidate calculation unit 114 searches the merging block candidate list for an unusable-for-merging candidate and an identical candidate, and removes the unusable-for-merging candidate and the identical candidate from the merging block candidate list as shown in FIG. 13.

In Step S184, the merging block candidate calculation unit 114 adds a new candidate to the merging block candidate list. Here, when a new candidate is added, the merging block candidate calculation unit 114 may reassign merging block candidate indices so that the merging block candidate indices of smaller values are assigned to preexistent merging block candidates in priority to the new candidate. In other words, the merging block candidate calculation unit 114 may reassign the merging block candidate indices so that a merging block candidate index of a larger value is assigned to the new candidate. The amount of code of merging block candidate indices is thereby reduced.

In Step S185, the merging block candidate calculation unit 114 sets the total number of usable-for-merging candidates calculated in Step S181 as the size of the merging block candidate list. In the example shown in FIG. 13, the calculated number of usable-for-merging candidates is “4”, and the size of the merging block candidate list is set at “4”.

The new candidate in Step S184 is a candidate newly added to merging block candidates when the total number of merging block candidates is smaller than the total number of usable-for-merging candidates. Examples of such a new candidate include a neighboring block located above the lower-left neighboring block D in FIG. 3, a block corresponding to any of neighboring blocks A, B, C, and D of a co-located block. Furthermore, examples of such a new candidate further include a block having a motion vector, a reference picture index, a prediction direction, and the like which are statistically obtained for the whole or a certain region of a reference picture. Thus, when the total number of merging block candidates is smaller than the total number of usable-for-merging candidates, the merging block candidate calculation unit 114 adds a new candidate having a new motion vector, a new reference picture index, and a new prediction direction so that coding efficiency can be increased.

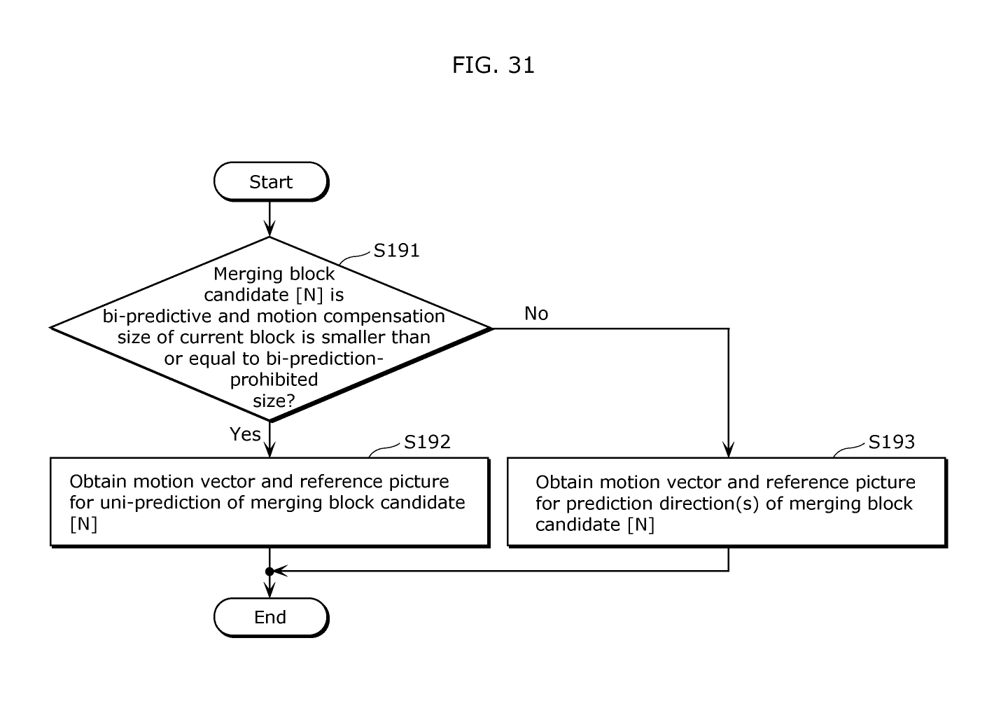

FIG. 31 is a flowchart showing details of the process in Step S182 in FIG. 30. Specifically, FIG. 31 illustrates a method of obtaining a motion vector, a reference picture index, and a prediction direction of a merging block candidate [N] according to a bi-prediction-prohibited size. FIG. 31 will be described below.

In Step S191, the merging block candidate calculation unit 114 determines whether it is true or false that a merging block candidate [N] is bi-predictive and the motion compensation size of the current block is smaller than or equal to a bi-prediction-prohibited size.

When the result of the determination in Step S191 is true (S191, Yes), in Step S192, the merging block candidate calculation unit 114 obtains a motion vector and a reference picture index for uni-prediction of the merging block candidate [N] (for example, a motion vector and a reference picture index for the prediction direction 0), and adds the obtained motion vector and reference picture index to a merging block candidate list. The merging block candidate calculation unit 114 may use a motion vector and a reference picture index for the prediction direction 1 as a motion vector and a reference picture index for uni-prediction instead of the motion vector and reference picture index for the prediction direction 0. Alternatively, the merging block candidate calculation unit 114 may generate a motion vector and a reference picture index for uni-prediction from motion vectors and reference picture indices for two prediction directions using any method, for example, a method of generating a motion vector and a reference picture index for uni-prediction by calculating a mean vector and the like from motion vectors and reference picture indices for the prediction direction 0 and prediction direction 1.

When the result of the determination in Step S191 is false (S191, No), in Step S193, the merging block candidate calculation unit 114 obtains a motion vector and a reference picture index for uni-prediction (or motion vectors and reference picture indices for bi-prediction) of the merging block candidate [N], and adds them to a merging block candidate list. Specifically, when the merging block candidate is bi-predictive, the merging block candidate calculation unit 114 adds motion vectors and reference picture indices for bi-prediction to a merging block candidate list. When the merging block candidate is uni-predictive, the merging block candidate calculation unit 114 adds a motion vector and a reference picture index for uni-prediction to a merging block candidate list.

In this manner, when the motion compensation size of a current block is smaller than or equal to a bi-prediction-prohibited size, the image coding apparatus 300 in Embodiment 3 generates a merging block candidate list using a motion vector and a reference picture index for uni-prediction of a merging block candidate regardless of whether the merging block candidate is bi-predictive or uni-predictive. With this, a merging block candidate to be used for coding of a current block is selected from a merging block candidate list in which all merging block candidates are uni-predictive. As a result, it is possible to increase coding efficiency using a limited memory bandwidth.

In Embodiment 3, a prediction direction, a motion vector, and a reference picture index are obtained from a merging block candidate [N] according to a bi-prediction-prohibited size in Step S182 in FIG. 30. The present disclosure is not limited to this. For example, the merging block candidate calculation unit 114 may determine whether or not the motion compensation size of a current block to be coded is smaller than or equal to the bi-prediction-prohibited size after Step S185 in FIG. 30, and convert motion vectors and reference picture indices for bi-prediction of a bi-predictive merging block candidate in the merging block candidate list into a motion vector and a reference picture index for uni-prediction. For example, this may be performed by converting bi-prediction into uni-prediction for a prediction direction 0 and setting a motion vector and a reference picture index for a prediction direction 1 to null values. Alternatively, this may be performed by converting bi-prediction into uni-prediction for a prediction direction 1 and setting a motion vector and a reference picture index for a prediction direction 0 to null values.

It should be noted that the case described in Embodiment 3 is not limiting in which when a merging block candidate is bi-predictive and the motion compensation size of a current block to be coded is smaller than or equal to a bi-prediction-prohibited size, a motion vector and a reference picture index for uni-prediction of the merging block candidate are obtained as shown in FIG. 31 and added to a merging block candidate list.

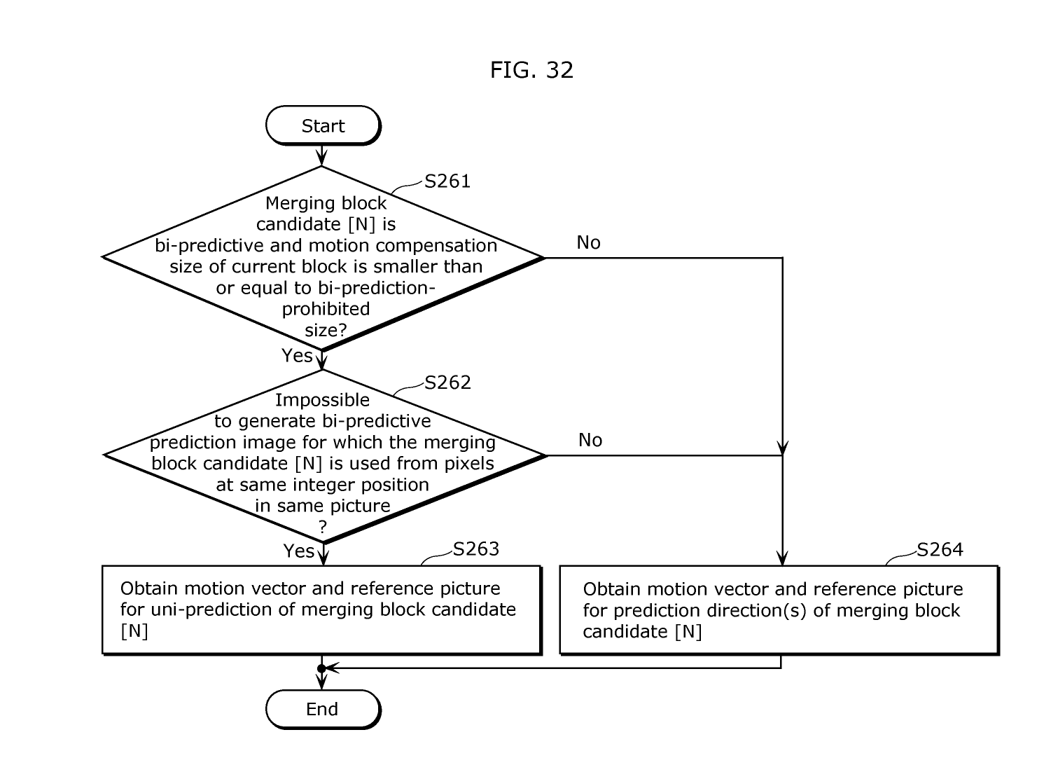

FIG. 32 is a flowchart showing details of the process in Step S182 in FIG. 30 performed in a different way. Specifically, FIG. 32 illustrates a method of obtaining a motion vector, a reference picture index, and a prediction direction of a merging block candidate [N] according to a bi-prediction-prohibited size.

For example, referring to FIG. 32, in Step S261, the merging block candidate calculation unit 114 determines whether it is true or false that a merging block candidate [N] is bi-predictive and the motion compensation size of the current block is smaller than or equal to a bi-prediction-prohibited size.

When the result of the determination in Step S261 is true (Step S261, Yes), in Step S262, the merging block candidate calculation unit 114 further determines whether it is true or false that it is impossible to generate, from values of a pixel at the same integer position in the same picture, a bi-predictive prediction image for which the merging block candidate is used. When the result of the determination in Step S262 is true (Step S262, Yes), the merging block candidate calculation unit 114 obtains a motion vector and a reference picture index for uni-prediction of the merging block candidate in Step S263 and adds them to a merging block candidate list. When the result of the determination in Step S261 or Step S262 is false (S261 or S262, No), the merging block candidate calculation unit 114 obtains a motion vector and a reference picture index for uni-prediction (or motion vectors and reference picture indices for bi-prediction) of the merging block candidate, and adds them to a merging block candidate list.

Generally, when it is possible to generate a prediction image for each of the two prediction directions of bi-prediction from values of pixels at the same integer position in the same picture using a motion compensation filter, the prediction image can be generated using a reference picture for uni-prediction read from memory. When this is the case, coding efficiency can be increased and memory bandwidth can be limited without prohibiting bi-prediction.

### Embodiment 4

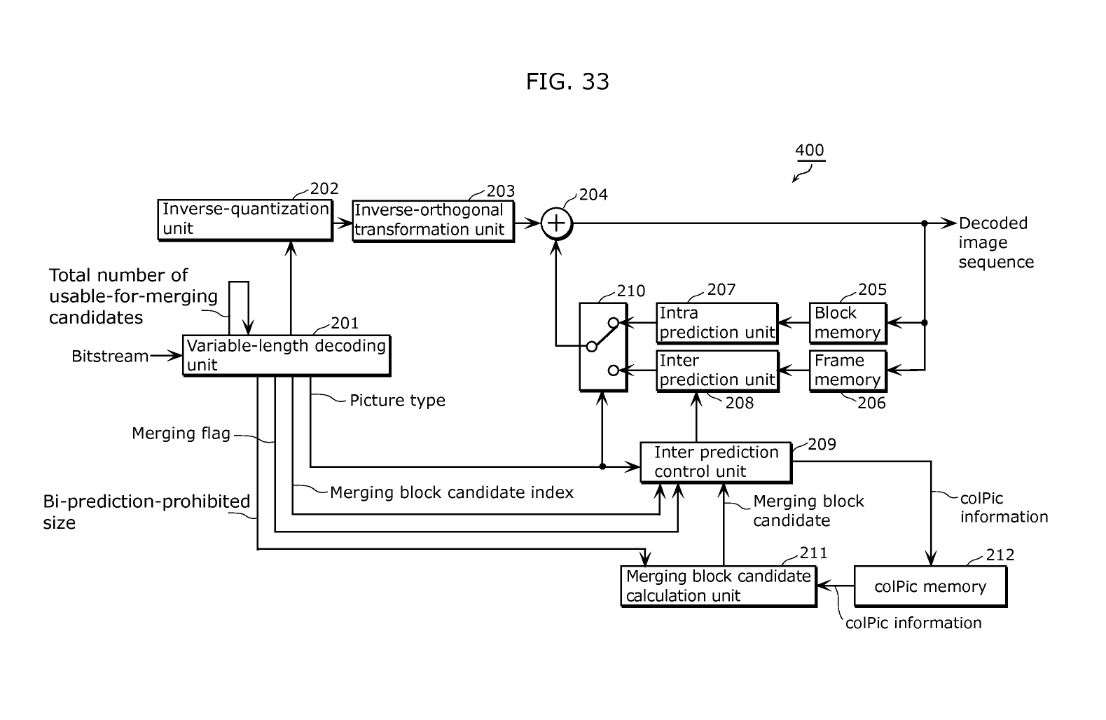

FIG. 33 is a block diagram showing a configuration of an image decoding apparatus 400 in which the image decoding method according to Embodiment 3 is used. Embodiment 4 is different from Embodiment 2 only in that a merging block candidate is calculated according to a bi-prediction-prohibited size (or a merging block candidate list is generated according to a bi-prediction-prohibited size), therefore description of common points are omitted.

As shown in FIG. 33, the image decoding apparatus 400 includes a variable-length decoding unit 201, an inverse-quantization unit 202, an inverse-orthogonal-transformation unit 203, an adder 204, block memory 205, frame memory 206, an intra prediction unit 207, an inter prediction unit 208, an inter prediction control unit 209, a switch 210, a merging block candidate calculation unit 211, and colPic memory 212.

The variable-length decoding unit 201 obtains picture-type information, a merging flag, a quantized coefficient, and a bi-prediction-prohibited size by performing variable-length decoding on an input bitstream. Furthermore, the variable-length decoding unit 201 obtains a merging block candidate index by performing variable-length decoding in the same manner as shown in FIG. 23.

The merging block candidate calculation unit 211 derives merging block candidates for the merging mode from motion vectors and others of neighboring blocks of a current block to be decoded and a motion vector and others of a co-located block (colPic information) stored in the colPic memory 212, using a method described later according to a bi-prediction-prohibited size. Furthermore, the merging block candidate calculation unit 211 assigns merging block candidate indices to the derived merging block candidates, and transmits the merging block candidates and merging block candidate indices to the inter prediction control unit 209.

When the merging flag decoded is “0”, the inter prediction control unit 209 causes the inter prediction unit 208 to generate an inter prediction image using information for motion vector estimation mode. When the merging flag is “1”, the inter prediction control unit 209 determines, based on a decoded merging block candidate index, a motion vector, a reference picture index, and a prediction direction for use in inter prediction from a plurality of merging block candidates. Then, the inter prediction control unit 209 causes the inter prediction unit 208 to generate an inter prediction image using the determined motion vector, reference picture index, and prediction direction. Furthermore, the inter prediction control unit 209 transfers colPic information including the motion vector of the current block to the colPic memory 212.

Finally, the adder 204 generates decoded image data by adding prediction image data and prediction error data.

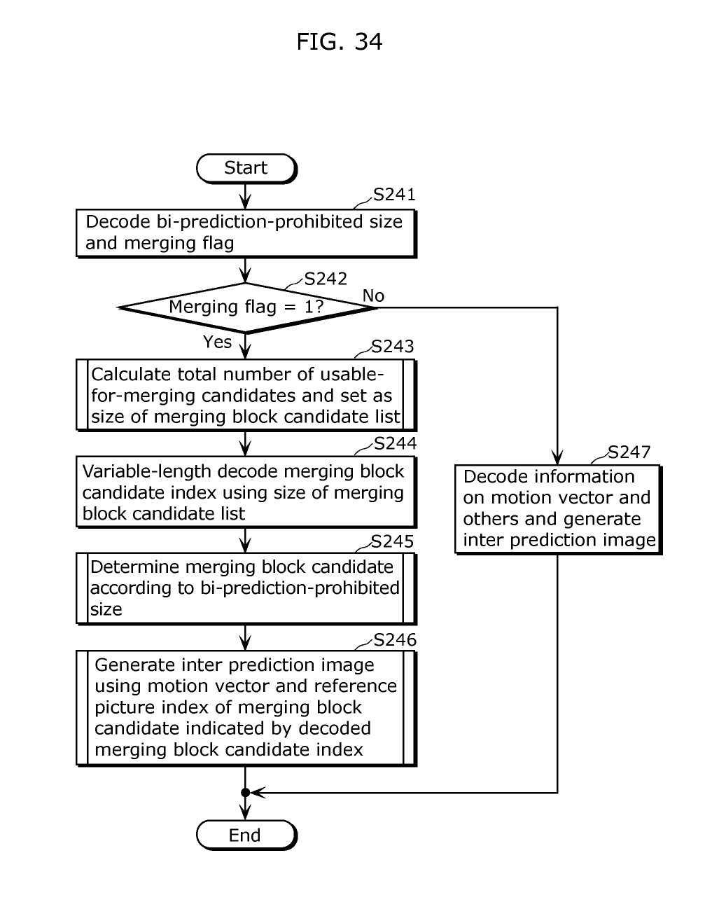

FIG. 34 is a flowchart showing processing operations of the image decoding apparatus 400 according to Embodiment 4.

In Step S241, the variable-length decoding unit 201 decodes a bi-prediction-prohibited size and a merging flag.

When the merging flag is “1” in Step S242 (S242, Yes), in Step S243, the merging block candidate calculation unit 211 calculates the total number of usable-for-merging candidates in the same manner as shown in FIG. 23. Then, the merging block candidate calculation unit 211 sets the calculated number of usable-for-merging candidates as the size of a merging block candidate list.

In Step S244, the variable-length decoding unit 201 performs variable-length decoding on a merging block candidate index included in a bitstream using the size of the merging block candidate list.

In Step S245, the merging block candidate calculation unit 211 generates merging block candidates from neighboring blocks and a co-located block of a current block to be decoded in the same manner as shown in FIG. 30 according to a bi-prediction-prohibited size.

In Step S246, the inter prediction control unit 209 causes the inter prediction unit 208 to generate an inter prediction image using the motion vector, reference picture index, and prediction direction of the merging block candidate indicated by the decoded merging block candidate index.

When the merging flag is “0” in Step S242 (S242, No), in Step S247, the inter prediction unit 208 generates an inter prediction image using information for motion vector estimation mode decoded by the variable-length decoding unit 201.

Alternatively, when the size of a merging block candidate list calculated in Step S243 is “1”, a merging block candidate index may be estimated to be “0” without being decoded.

In Embodiment 4, when the motion compensation size of a current block is smaller than or equal to a bi-prediction-prohibited size, a merging block candidate list is thus generated using a motion vector and a reference picture index for uni-prediction of a merging block candidate which is bi-predictive. With this, a merging block candidate to be used for decoding of a current block is selected from a merging block candidate list in which all merging block candidates are uni-predictive. As a result, it is possible to appropriately decode a bitstream coded with increased efficiency using a limited memory bandwidth.

It should be noted that the case described in Embodiment 4 is not limiting in which a prediction direction, a motion vector, and a reference picture index are obtained from a merging block candidate [N] according to a bi-prediction-prohibited size. Alternatively, as with the determination performed in Step S185 in FIG. 30 merging block candidate calculation unit 211 may determine whether or not a motion compensation size of a current block to be decoded is smaller than or equal to a bi-prediction-prohibited size after a merging block candidate list is generated. When the result of the determination is true, the merging block candidate calculation unit 211 converts, into a motion vector and a reference picture index for uni-prediction, motion vectors and reference picture indices for bi-prediction of a merging block candidate in the merging block candidate list. For example, the merging block candidate calculation unit 211 may convert bi-prediction into uni-prediction for a prediction direction 0 and set a motion vector and a reference picture index for a prediction direction 1 to null values. Alternatively, the merging block candidate calculation unit 211 may convert bi-prediction into uni-prediction for a prediction direction 1 and set a motion vector and a reference picture index for a prediction direction 0 to null values.

It should be noted that the case described in Embodiment 4 is not limiting in which when a merging block candidate is bi-predictive and the motion compensation size of a current block to be decoded is smaller than or equal to a bi-prediction-prohibited size, a motion vector and a reference picture index for uni-prediction of the merging block candidate are obtained as shown in FIG. 31 and added to a merging block candidate list. For example, as in FIG. 32 described in Embodiment 3, when a merging block candidate is bi-predictive and the motion compensation size of a current block to be decoded is smaller than or equal to a bi-prediction-prohibited size, the merging block candidate calculation unit 211 may determine whether or not it is possible to generate, from values of pixels at the same integer position in the same picture, a bi-predictive prediction image for which the merging block candidate is used. When the result of the determination is true, the merging block candidate calculation unit 211 obtains a motion vector and a reference picture index for uni-prediction of the merging block candidate and adds them to the merging block candidate list. When the result of the determination is false, the merging block candidate calculation unit 211 may obtain a motion vector and a reference picture index for uni-prediction (or motion vectors and reference picture indices for bi-prediction) of the merging block candidate and add them to the merging block candidate list. Generally, when it is possible to generate a prediction image for each of the two prediction directions of bi-prediction from values of pixels at the same integer position in the same picture using a motion compensation filter, the prediction image can be generated using a reference picture for uni-prediction read from memory. When this is the case, a bitstream coded with increased efficiency using a limited memory bandwidth can be decoded appropriately without need for prohibiting bi-prediction.

Although the image coding apparatus and image decoding apparatus according to one or more aspects of the present disclosure have been described based on Embodiments 1 to 4, the present disclosure is not limited to these embodiments. Those skilled in the art will readily appreciate that many modifications of the exemplary embodiments or embodiments in which the constituent elements of the exemplary embodiments are combined are possible without materially departing from the novel teachings and advantages described in the present disclosure. All such modifications and embodiments are also within scopes of one or more aspects of the present disclosure.

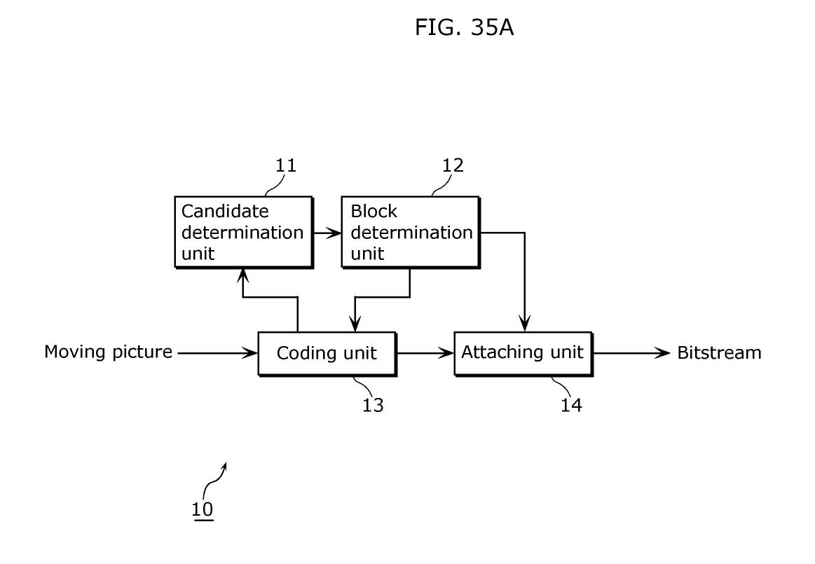

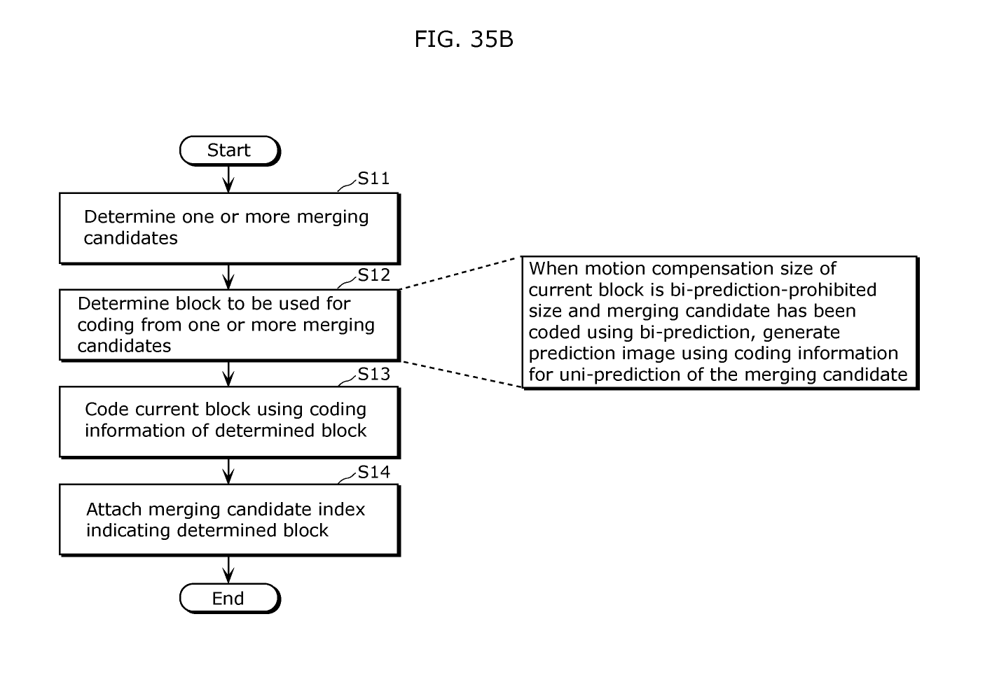

FIG. 35A is a block diagram showing a configuration of an image coding apparatus according to an aspect of the present disclosure.

In an image coding apparatus 10, which merges, into coding information of a current block to be coded in a moving picture, coding information of a coded block which is one of blocks in the moving picture and is other than the current block, to code the current block.

The coding information includes a motion vector and a reference picture index of each block. The image coding apparatus 10 includes a candidate determination unit 11, a block determination unit 12, a coding unit 13, and an attaching unit 14. The candidate determination unit 11 corresponds to the merging block candidate calculation unit 114 in Embodiment 1 or 3. The block determination unit 12 corresponds to the inter prediction unit 110 and the inter prediction control unit 111 in Embodiment 1 or 3. The coding unit 13 corresponds to, for example, the inter prediction unit 110 and the subtractor 101 in Embodiment 1 or 3.

The attaching unit 14 corresponds to the variable-length coding unit 116 in Embodiment 1 or 3.

FIG. 35B is a flowchart showing processing performed by the image coding apparatus 10.

First, the candidate determination unit 11 determines one or more usable-for-merging blocks as merging candidates, based on a spatial position or a temporal position of a current block to be coded (S11). Next, the block determination unit 12 generates, for each of the merging candidates, a prediction image of the current block using coding information of the merging candidate, and compares costs of the prediction images to determine a block to be used for coding the current block from the one or more merging candidates (S12). Next, the coding unit 13 codes the current block using coding information of the block determined by the block determination unit 12 to generate a bitstream including the coded block (S13). Then, the attaching unit 14 attaches, to the bitstream, a merging candidate index indicating the block determined by the block determination unit 12 (S14).

In Step 12, when the motion compensation size of the current block is a bi-prediction-prohibited size and the one or more merging candidates include a merging candidate coded using bi-prediction with reference to two pictures, the block determination unit 12 generates a prediction image of the current block using coding information for uni-prediction of the merging candidate coded using bi-prediction instead of coding information for the bi-prediction of the merging candidate coded using bi-prediction. The uni-prediction is performed with reference to one picture.

It should be noted that the merging candidate, bi-prediction-prohibited size, and merging candidate index corresponds to the merging block candidate, bi-prediction-prohibited size, and the merging block candidate index, respectively, in Embodiments 1 to 4.

With this, when the motion compensation size of a current block to be coded is a bi-prediction-prohibited size and the one or more merging candidates include a merging candidate coded using bi-prediction, a prediction image of the current block is generated using coding information for uni-prediction of a merging candidate coded using bi-prediction instead of coding information for bi-prediction of the merging candidate coded using bi-prediction. For example, when the motion compensation size of a current block to be coded is a minimum size, only a motion vector and a reference picture index for the prediction direction 0 included in coding information for bi-prediction of a merging candidate are used for generating a prediction image of the current block. In other words, the motion vector and reference picture index for the prediction direction 1 included in the coding information for bi-prediction of the merging candidate are not used for generating a prediction image of the current block. As a result, a necessary memory bandwidth can be reduced and coding efficiency can be increased by using the merging mode.

Although the bi-prediction-prohibited size is determined in Embodiments 1 and 3, the bi-prediction-prohibited size may be a fixed size and be shared with the image decoding apparatus without such determining. With this, the bi-prediction-prohibited size determination unit 117 in Embodiments 1 and 3 can be omitted, so that the configuration of the image coding apparatuses 100 and 300 are simplified.

The coding information for uni-prediction of a merging candidate which the block determination unit 12 uses for generating a prediction image of a current block instead of coding information for bi-prediction of the merging candidate in Step S12 may be generated any time before the generating of a prediction image.

Specifically, coding information for bi-prediction listed in a merging block candidate list may be converted into coding information for uni-prediction after the merging block candidate list is generated as in Embodiment 1. In this case, in Step S11, a list which lists coding information of each of the one or more determined merging candidates (merging block candidate list) is generated. Next, in Step S12, when the one or more determined merging candidates include a merging candidate coded using uni-prediction, a prediction image of the current block is generated using the coding information which is listed in the list and is for the uni-prediction of the merging candidate coded using uni-prediction. When the one or more determined merging candidates include a merging candidate coded using bi-prediction, coding information which is listed in the list and is for the bi-prediction of the merging candidate coded using bi-prediction is converted into coding information for uni-prediction of the merging candidate coded using bi-prediction, and then a prediction image of the current block is generated using the coding information for the uni-prediction of the merging candidate coded using bi-prediction.

Furthermore, as in Embodiment 2, coding information for bi-prediction may be converted into coding information for uni-prediction in advance, and then a merging block candidate list including the coding information for uni-prediction may be generated. In this case, in Step S11, when the one or more merging candidates include a merging candidate coded using bi-prediction, coding information for the bi-prediction of the merging candidate is converted into coding information for uni-prediction. As a result of this, a list (merging block candidate list) is generated which lists coding information of each of the one or more determined merging candidates and includes no coding information for bi-prediction is generated. Next, in Step S12, a prediction image of a current block is generated for each merging candidate in the list using the coding information of the merging candidate.

The coding information for bi-prediction may be converted into either coding information (a motion vector and a reference picture index) for the prediction direction 0 or coding information (a motion vector and a reference picture index) for the prediction direction 1 as in Embodiments 1 and 3. Furthermore, the coding information for uni-prediction resulting from the conversion may include only coding information for the prediction direction 0 or the prediction direction 2.

Specifically, when uni-prediction is available in two types of first uni-prediction (prediction for the prediction direction 0) and second uni-prediction (prediction for the prediction direction 1) distinguished according to a predetermined condition, coding information for bi-prediction of a merging candidate coded using bi-prediction includes coding information for the first uni-prediction and coding information for the second uni-predication. When the one or more merging candidates include a plurality of merging candidates coded using bi-prediction, in Step S11 or Step S12, only the coding information for the first uni-prediction or the coding information for the second uni-prediction included in coding information for bi-prediction of the merging candidates is used for generating prediction images of the current block.

In Embodiments 1 and 3, it is determined whether it is true or false that the merging block candidate is bi-predictive and the motion compensation size of the current block is smaller than or equal to a bi-prediction-prohibited size. In other words, the image coding method performed by the image coding apparatus 10 includes determining whether it is true or false that the motion compensation size of the current block is a bi-prediction-prohibited size and the one or more merging block candidates include a merging candidate coded using bi-prediction. In the determining, as in Embodiments 1 to 4, when the motion compensation size of the current block is smaller than or equal to a predetermined size, it is determined that the motion compensation size of the current block is a bi-prediction-prohibited size. Here, in the determining, when the sum of a width and a height of a current block is equal to a predetermined value (for example, a value of 12), the motion compensation size of the current block is determined as a bi-prediction-prohibited size. In the determining, when a current block has a size of 4×8 pixels or 8×4 pixels, it is determined that the motion compensation size of the current block is a bi-prediction-prohibited size. Alternatively, in the determining, when a current block has a size which is the smallest one or a predetermined one of predetermined motion compensation sizes, it may be determined that the motion compensation size of the current block is a bi-prediction-prohibited size.

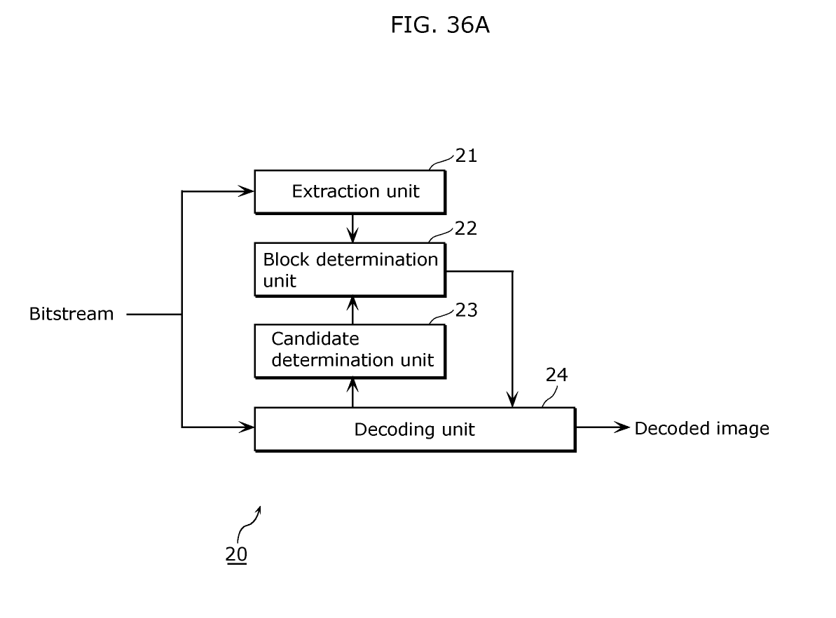

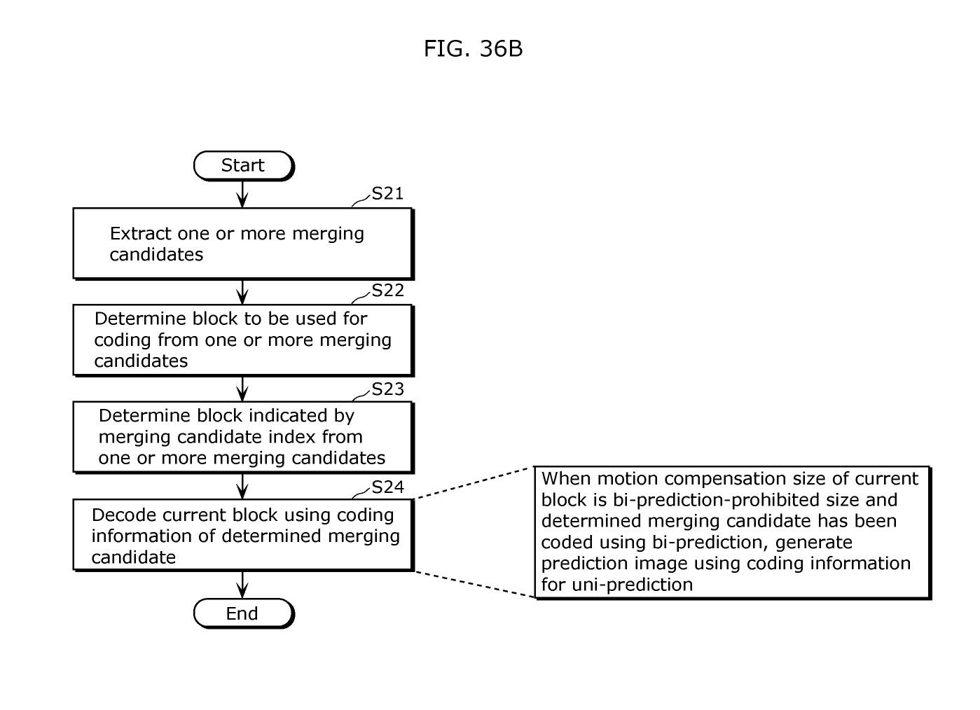

FIG. 36A is a block diagram showing a configuration of an image decoding apparatus according to an aspect of the present disclosure.

In the image decoding apparatus 20, which merges, into coding information of a current block to be decoded in a bitstream, coding information of a decoded block which is one of blocks in the bitstream and is other than the current block to decode the current block. The coding information includes a motion vector and a reference picture index of each block. The image decoding apparatus 20 includes an extraction unit 21, a candidate determination unit 23, a block determination unit 22, and a decoding unit 24.

The extraction unit 21 corresponds to the variable-length decoding unit 201 in Embodiment 2 or Embodiment 4, and the decoding unit 24 corresponds to the inter prediction unit 208 and the adder 204 in Embodiment 2 or Embodiment 4. Furthermore, the candidate determination unit 23 corresponds to the merging block candidate calculation unit 211 in Embodiment 2 or Embodiment 4. The block determination unit 22 corresponds to the inter prediction unit 208 and the inter prediction control unit 209 in Embodiment 2 or 4.

FIG. 36B is a flowchart showing processing performed by the image decoding apparatus 20.

First, the extraction unit 21 extracts a merging candidate index from a bitstream (S21). Next, the candidate determination unit 23 determines one or more usable-for-merging blocks as merging candidates, based on a spatial position or a temporal position of a current block to be decoded (S22). Next, the block determination unit 22 determines, from the one or more determined usable-for-merging blocks, a block to be indicated by the merging candidate index extracted by an extraction unit 21 (S23). Next, the decoding unit 24 generates a prediction image of the current block using coding information of the block determined by the block determination unit 22, and decodes the current block using the prediction image to generate a decoded image including a decoded block (S24).

In Step S24, when the motion compensation size of the current block is a bi-prediction-prohibited size and the block determined by the block determination unit 22 has been decoded using bi-prediction with reference to two pictures, the decoding unit 24 generates a predication image of the current block using coding information for uni-prediction of the merging candidate decoded using bi-prediction instead of coding information for the bi-prediction of the merging candidate decoded using bi-prediction. The uni-prediction is performed with reference to one picture.

This makes it possible to appropriately decode a bitstream coded by the image coding apparatus 10 with increased efficiency using a limited memory bandwidth.

Each of the structural elements in each of the above-described embodiments may be configured in the form of an exclusive hardware product, or may be realized by executing a software program suitable for the structural element. The constituent elements may be implemented by a program execution unit such as a CPU or a processor which reads and executes a software program recorded on a recording medium such as a hard disk or a semiconductor memory. Here, examples of the software program which implements the image coding apparatus or the image decoding apparatus in the embodiments include a program as follows.

Specifically, the program causes a computer to execute a method of merging, into coding information of a current block to be coded in a moving picture, coding information of a coded block which is one of blocks in the moving picture and is other than the current block, to code the current block, the coding information including a motion vector and a reference picture index. The image coding method includes: determining one or more blocks usable for the merging as one or more merging candidates, based on a spatial position or a temporal position of the current block; generating, for each of the merging candidates, a prediction image of the current block using coding information of the merging candidate and comparing costs of the prediction images to determine a block to be used for coding the current block from the one or more merging candidates; coding the current block using the coding information of the block determined in the generating of a prediction image to generate a bitstream including the coded current block; and attaching, to the bitstream, a merging candidate index indicating the block determined in the generating of a prediction image, wherein in the generating of a prediction image, when a motion compensation size of the current block is a bi-prediction-prohibited size and the one or more merging candidates include a merging candidate coded using bi-prediction with reference to two pictures, the prediction image of the current block is generated using coding information for uni-prediction of the merging candidate coded using bi-prediction instead of coding information for the bi-prediction of the merging candidate coded using bi-prediction, the uni-prediction being performed with reference to one picture.

According to another aspect of the present disclosure, the program causes a computer to execute a method of merging, into coding information of a current block to be decoded in a bitstream, coding information of a decoded block which is one of blocks in the bitstream and is other than the current block, to decode the current block, the coding information including a motion vector and a reference picture index. The image decoding method includes: extracting a merging candidate index from the bitstream; determining one or more blocks usable for the merging as one or more merging candidates, based on a spatial position or a temporal position of the current block; determining, from the one or more determined merging candidates, a block indicated by the merging candidate index extracted in the extracting; generating a prediction image of the current block using coding information of the block determined in the determining of a block, and decoding the current block using the prediction image to generate a decoded image including the decoded current block, wherein in the generating of a prediction image, when a motion compensation size of the current block is a bi-prediction-prohibited size and the block determined in the determining of a block has been decoded using bi-prediction with reference to two pictures, the prediction image of the current block is generated using coding information for uni-prediction of the block decoded using bi-prediction instead of coding information for the bi-prediction of the block decoded using bi-prediction, the uni-prediction being performed with reference to one picture.

### Embodiment 5

The processing described in each of embodiments can be simply implemented in an independent computer system, by recording, in a recording medium, a program for implementing the configurations of the moving picture coding method (image coding method) and the moving picture decoding method (image decoding method) described in each of embodiments. The recording media may be any recording media as long as the program can be recorded, such as a magnetic disk, an optical disk, a magnetic optical disk, an IC card, and a semiconductor memory.

Hereinafter, the applications to the moving picture coding method (image coding method) and the moving picture decoding method (image decoding method) described in each of embodiments and systems using thereof will be described. The system has a feature of having an image coding and decoding apparatus that includes an image coding apparatus using the image coding method and an image decoding apparatus using the image decoding method. Other configurations in the system can be changed as appropriate depending on the cases.

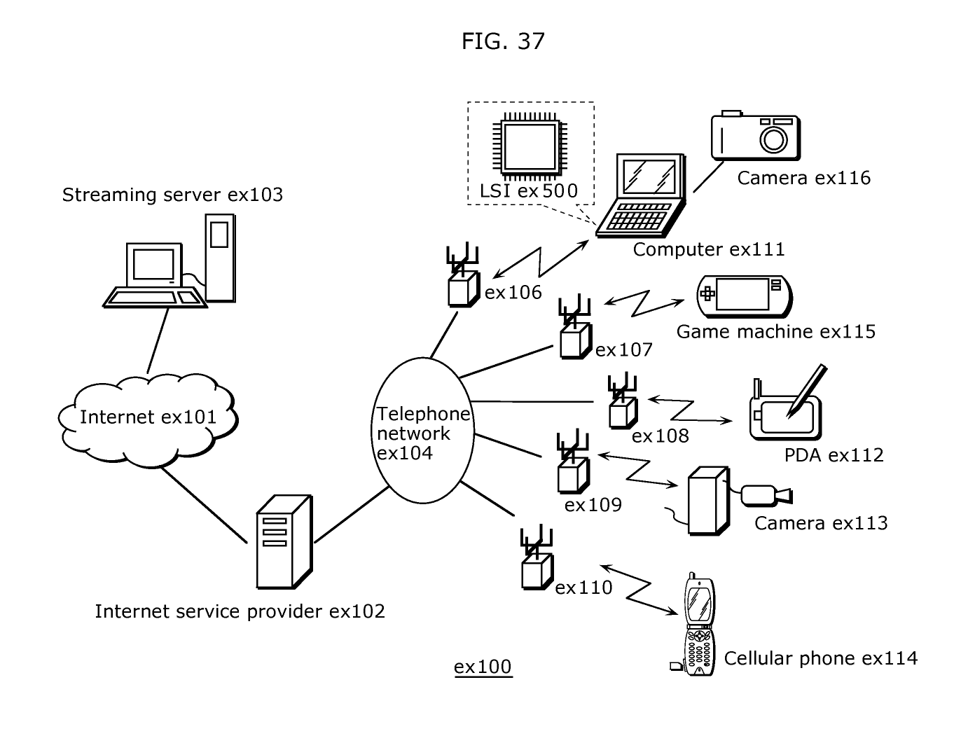

FIG. 37 illustrates an overall configuration of a content providing system ex100 for implementing content distribution services. The area for providing communication services is divided into cells of desired size, and base stations ex106, ex107, ex108, ex109, and ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex104, as well as the base stations ex106 to ex110, respectively.

However, the configuration of the content providing system ex100 is not limited to the configuration shown in FIG. 37, and a combination in which any of the elements are connected is acceptable. In addition, each device may be directly connected to the telephone network ex104, rather than via the base stations ex106 to ex110 which are the fixed wireless stations. Furthermore, the devices may be interconnected to each other via a short distance wireless communication and others.

The camera ex113, such as a digital video camera, is capable of capturing video. A camera ex116, such as a digital camera, is capable of capturing both still images and video. Furthermore, the cellular phone ex114 may be the one that meets any of the standards such as Global System for Mobile Communications (GSM) (registered trademark), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. In such a distribution, a content (for example, video of a music live show) captured by the user using the camera ex113 is coded as described above in each of embodiments (i.e., the camera functions as the image coding apparatus according to an aspect of the present disclosure), and the coded content is transmitted to the streaming server ex103. On the other hand, the streaming server ex103 carries out stream distribution of the transmitted content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data (i.e., functions as the image decoding apparatus according to an aspect of the present disclosure).

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and video captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for encoding and decoding video may be integrated into some type of a recording medium (such as a CD-ROM, a flexible disk, and a hard disk) that is readable by the computer ex111 and others, and the coding and decoding processes may be performed using the software. Furthermore, when the cellular phone ex114 is equipped with a camera, the video data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients may receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

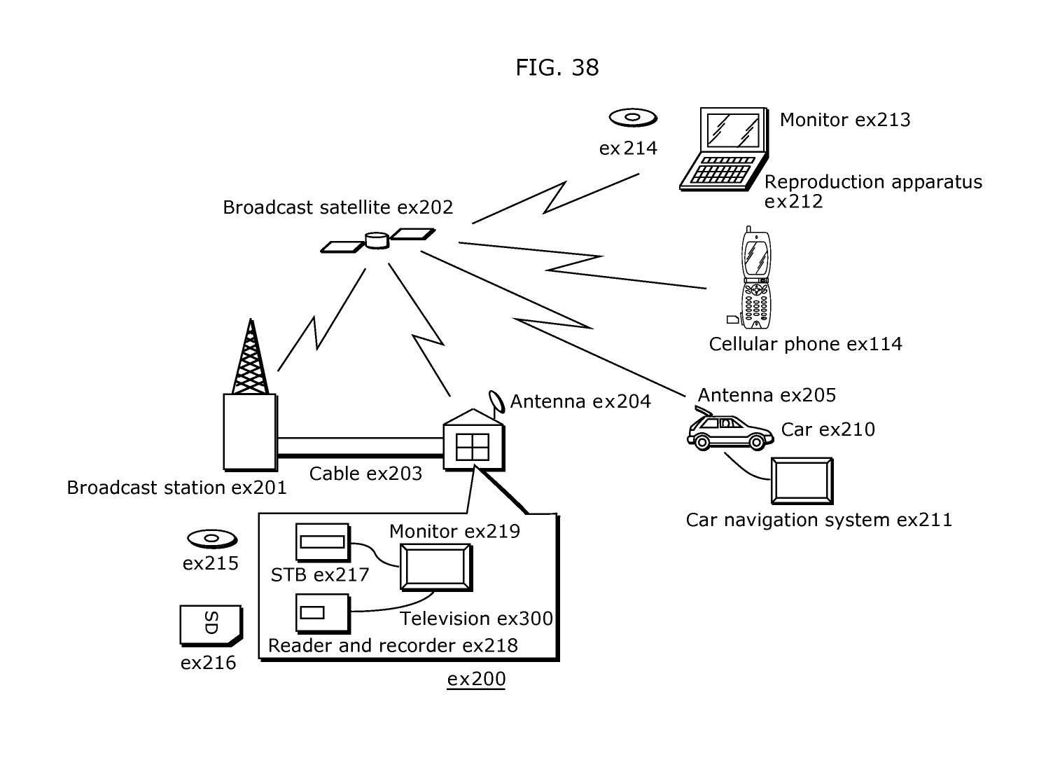

Aside from the example of the content providing system ex100, at least one of the moving picture coding apparatus (image coding apparatus) and the moving picture decoding apparatus (image decoding apparatus) described in each of embodiments may be implemented in a digital broadcasting system ex200 illustrated in FIG. 38. More specifically, a broadcast station ex201 communicates or transmits, via radio waves to a broadcast satellite ex202, multiplexed data obtained by multiplexing audio data and others onto video data. The video data is data coded by the moving picture coding method described in each of embodiments (i.e., data coded by the image coding apparatus according to an aspect of the present disclosure). Upon receipt of the multiplexed data, the broadcast satellite ex202 transmits radio waves for broadcasting. Then, a home-use antenna ex204 with a satellite broadcast reception function receives the radio waves. Next, a device such as a television (receiver) ex300 and a set top box (STB) ex217 decodes the received multiplexed data, and reproduces the decoded data (i.e., functions as the image decoding apparatus according to an aspect of the present disclosure).

Furthermore, a reader/recorder ex218 (i) reads and decodes the multiplexed data recorded on a recording medium ex215, such as a DVD and a BD, or (i) codes video signals in the recording medium ex215, and in some cases, writes data obtained by multiplexing an audio signal on the coded data. The reader/recorder ex218 can include the moving picture decoding apparatus or the moving picture coding apparatus as shown in each of embodiments. In this case, the reproduced video signals are displayed on the monitor ex219, and can be reproduced by another device or system using the recording medium ex215 on which the multiplexed data is recorded. It is also possible to implement the moving picture decoding apparatus in the set top box ex217 connected to the cable ex203 for a cable television or to the antenna ex204 for satellite and/or terrestrial broadcasting, so as to display the video signals on the monitor ex219 of the television ex300. The moving picture decoding apparatus may be implemented not in the set top box but in the television ex300.

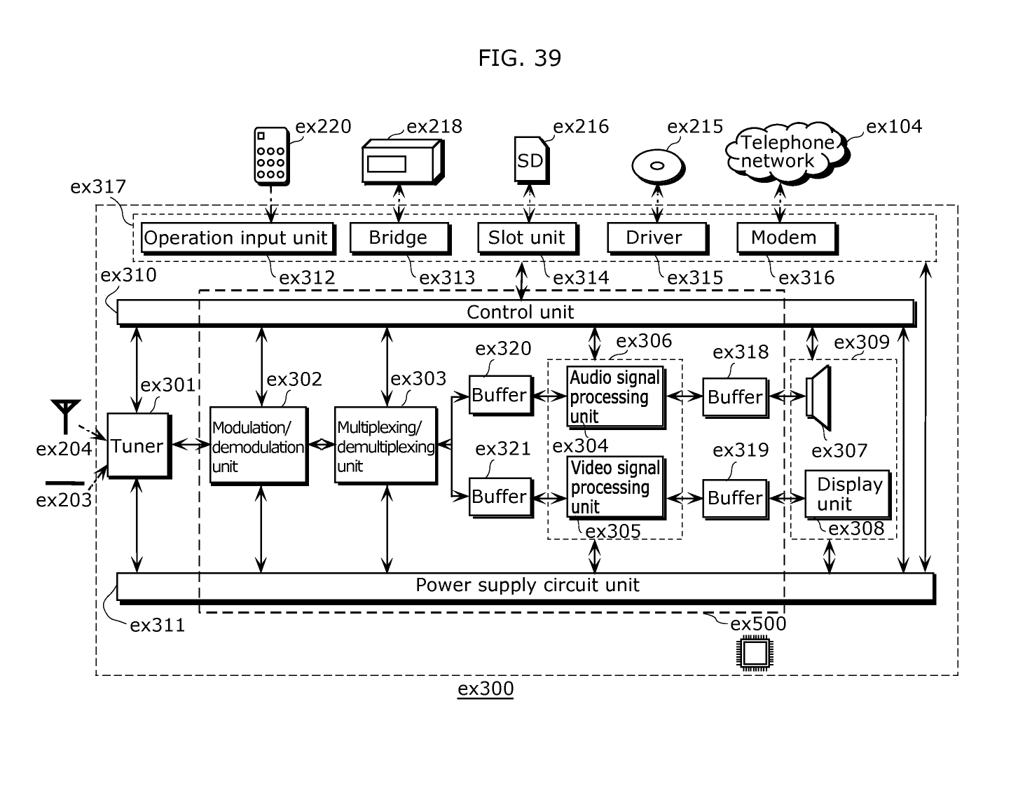

FIG. 39 illustrates the television (receiver) ex300 that uses the moving picture coding method and the moving picture decoding method described in each of embodiments. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data coded by a signal processing unit ex306 into data.

The television ex300 further includes: a signal processing unit ex306 including an audio signal processing unit ex304 and a video signal processing unit ex305 that decode audio data and video data and code audio data and video data, respectively (which function as the image coding apparatus and the image decoding apparatus according to the aspects of the present disclosure); and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, the configuration in which the television ex300 decodes multiplexed data obtained from outside through the antenna ex204 and others and reproduces the decoded data will be described. In the television ex300, upon a user operation through a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read multiplexed data not through a broadcast and others but from the recording media ex215 and ex216, such as a magnetic disk, an optical disk, and a SD card. Next, a configuration in which the television ex300 codes an audio signal and a video signal, and transmits the data outside or writes the data on a recording medium will be described. In the television ex300, upon a user operation through the remote controller ex220 and others, the audio signal processing unit ex304 codes an audio signal, and the video signal processing unit ex305 codes a video signal, under control of the control unit ex310 using the coding method described in each of embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, data may be stored in a buffer so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be capable of only receiving, decoding, and providing outside data but not the coding, multiplexing, and providing outside data.

Furthermore, when the reader/recorder ex218 reads or writes multiplexed data from or on a recording medium, one of the television ex300 and the reader/recorder ex218 may decode or encode the multiplexed data, and the television ex300 and the reader/recorder ex218 may share the decoding or encoding.

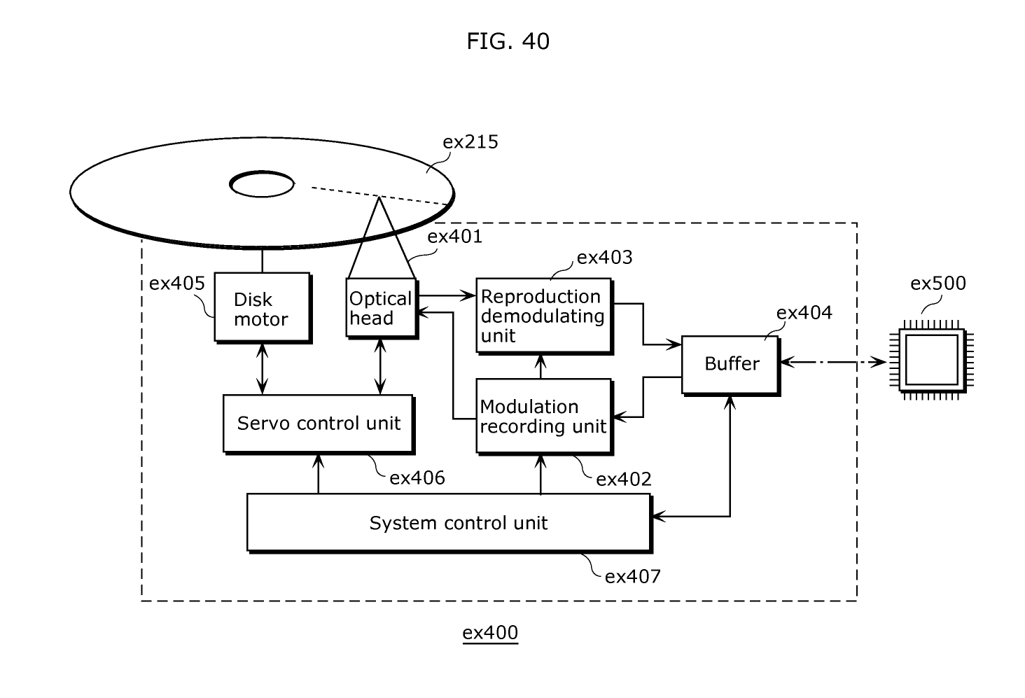

As an example, FIG. 40 illustrates a configuration of an information reproducing/recording unit ex400 when data is read or written from or on an optical disk. The information reproducing/recording unit ex400 includes constituent elements ex401, ex402, ex403, ex404, ex405, ex406, and ex407 to be described hereinafter. The optical head ex401 irradiates a laser spot in a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. The disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

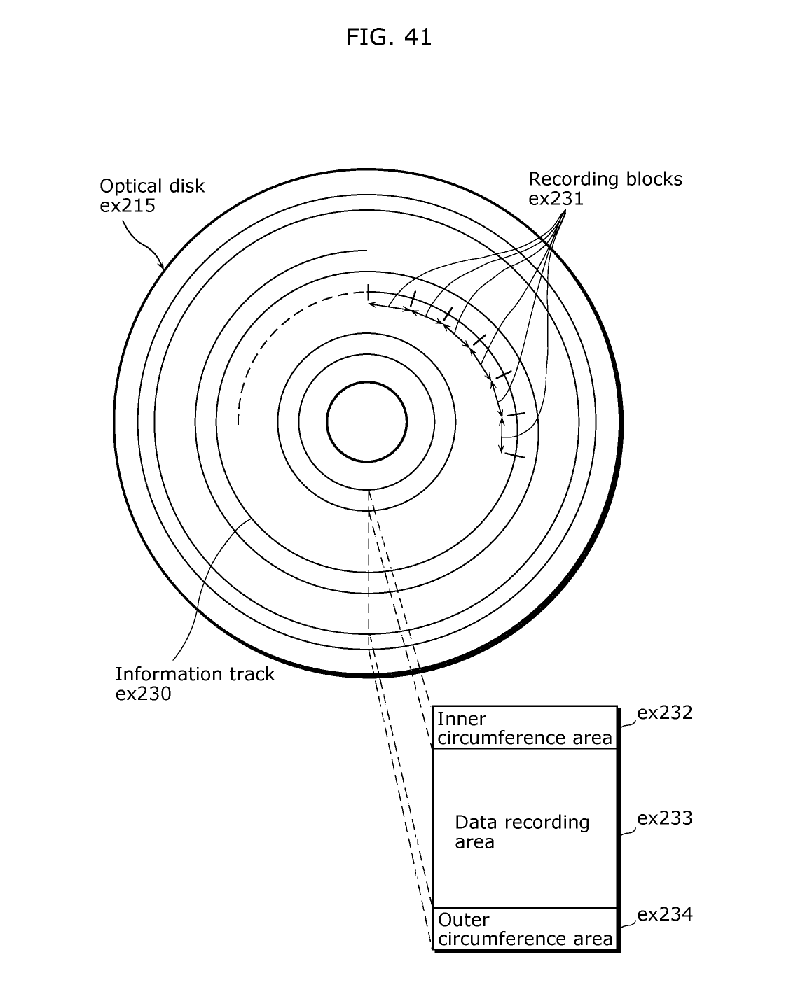

FIG. 41 illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio, coded video data, or multiplexed data obtained by multiplexing the coded audio and video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and for recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be a configuration, for example, including a GPS receiving unit from the configuration illustrated in FIG. 39. The same will be true for the configuration of the computer ex111, the cellular phone ex114, and others.

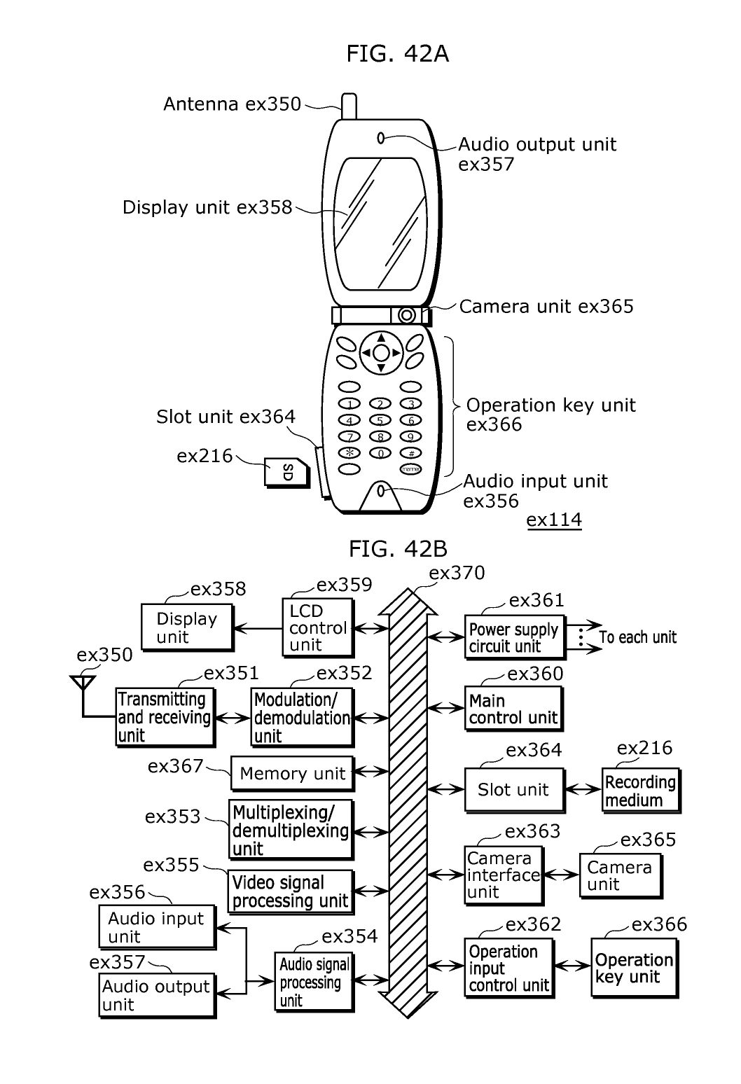

FIG. 42A illustrates the cellular phone ex114 that uses the moving picture coding method and the moving picture decoding method described in embodiments. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including an operation key unit ex366; an audio output unit ex357 such as a speaker for output of audio; an audio input unit ex356 such as a microphone for input of audio; a memory unit ex367 for storing captured video or still pictures, recorded audio, encoded or decoded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 42B. In the cellular phone ex114, a main control unit ex360 designed to control overall each unit of the main body including the display unit ex358 as well as the operation key unit ex366 is connected mutually, via a synchronous bus ex370, to a power supply circuit unit ex361, an operation input control unit ex362, a video signal processing unit ex355, a camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key or a power key is turned ON by a user's operation, the power supply circuit unit ex361 supplies the respective units with power from a battery pack so as to activate the cell phone ex114.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350. Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex357.

Furthermore, when an e-mail in data communication mode is transmitted, text data of the e-mail inputted by operating the operation key unit ex366 and others of the main body is sent out to the main control unit ex360 via the operation input control unit ex362. The main control unit ex360 causes the modulation/demodulation unit ex352 to perform spread spectrum processing on the text data, and the transmitting and receiving unit ex351 performs the digital-to-analog conversion and the frequency conversion on the resulting data to transmit the data to the base station ex110 via the antenna ex350. When an e-mail is received, processing that is approximately inverse to the processing for transmitting an e-mail is performed on the received data, and the resulting data is provided to the display unit ex358.

When video, still images, or video and audio in data communication mode is or are transmitted, the video signal processing unit ex355 compresses and codes video signals supplied from the camera unit ex365 using the moving picture coding method shown in each of embodiments (i.e., functions as the image coding apparatus according to the aspect of the present disclosure), and transmits the coded video data to the multiplexing/demultiplexing unit ex353. In contrast, during when the camera unit ex365 captures video, still images, and others, the audio signal processing unit ex354 codes audio signals collected by the audio input unit ex356, and transmits the coded audio data to the multiplexing/demultiplexing unit ex353.

The multiplexing/demultiplexing unit ex353 multiplexes the coded video data supplied from the video signal processing unit ex355 and the coded audio data supplied from the audio signal processing unit ex354, using a predetermined method. Then, the modulation/demodulation unit (modulation/demodulation circuit unit) ex352 performs spread spectrum processing on the multiplexed data, and the transmitting and receiving unit ex351 performs digital-to-analog conversion and frequency conversion on the data so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bit stream and an audio data bit stream, and supplies the video signal processing unit ex355 with the coded video data and the audio signal processing unit ex354 with the coded audio data, through the synchronous bus ex370. The video signal processing unit ex355 decodes the video signal using a moving picture decoding method corresponding to the moving picture coding method shown in each of embodiments (i.e., functions as the image decoding apparatus according to the aspect of the present disclosure), and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, a terminal such as the cellular phone ex114 probably have 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the moving picture coding method and the moving picture decoding method in each of embodiments can be used in any of the devices and systems described. Thus, the advantages described in each of embodiments can be obtained.

Furthermore, various modifications and revisions can be made in any of the embodiments in the present disclosure.

### Embodiment 6

Video data can be generated by switching, as necessary, between (i) the moving picture coding method or the moving picture coding apparatus shown in each of embodiments and (ii) a moving picture coding method or a moving picture coding apparatus in conformity with a different standard, such as MPEG-2, MPEG-4 AVC, and VC-1.

Here, when a plurality of video data that conforms to the different standards is generated and is then decoded, the decoding methods need to be selected to conform to the different standards. However, since to which standard each of the plurality of the video data to be decoded conform cannot be detected, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the moving picture coding method and by the moving picture coding apparatus shown in each of embodiments will be hereinafter described. The multiplexed data is a digital stream in the MPEG-2 Transport Stream format.

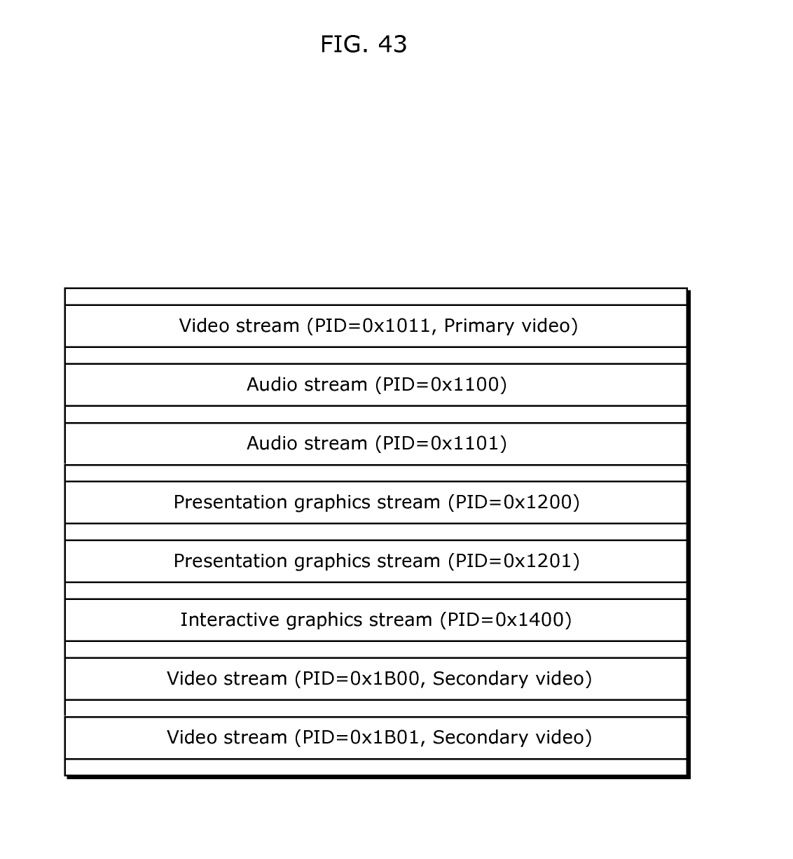

FIG. 43 illustrates a structure of the multiplexed data. As illustrated in FIG. 43, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of the movie. Here, the primary video is normal video to be displayed on a screen, and the secondary video is video to be displayed on a smaller window in the primary video. Furthermore, the interactive graphics stream represents an interactive screen to be generated by arranging the GUI components on a screen. The video stream is coded in the moving picture coding method or by the moving picture coding apparatus shown in each of embodiments, or in a moving picture coding method or by a moving picture coding apparatus in conformity with a conventional standard, such as MPEG-2, MPEG-4 AVC, and VC-1. The audio stream is coded in accordance with a standard, such as Dolby-AC-3, Dolby Digital Plus, MLP, DTS, DTS-HD, and linear PCM.

Each stream included in the multiplexed data is identified by PID. For example, 0x1011 is allocated to the video stream to be used for video of a movie, 0x1100 to 0x111F are allocated to the audio streams, 0x1200 to 0x121F are allocated to the presentation graphics streams, 0x1400 to 0x141F are allocated to the interactive graphics streams, 0x1B00 to 0x1B1F are allocated to the video streams to be used for secondary video of the movie, and 0x1A00 to 0x1A1F are allocated to the audio streams to be used for the secondary audio to be mixed with the primary audio.

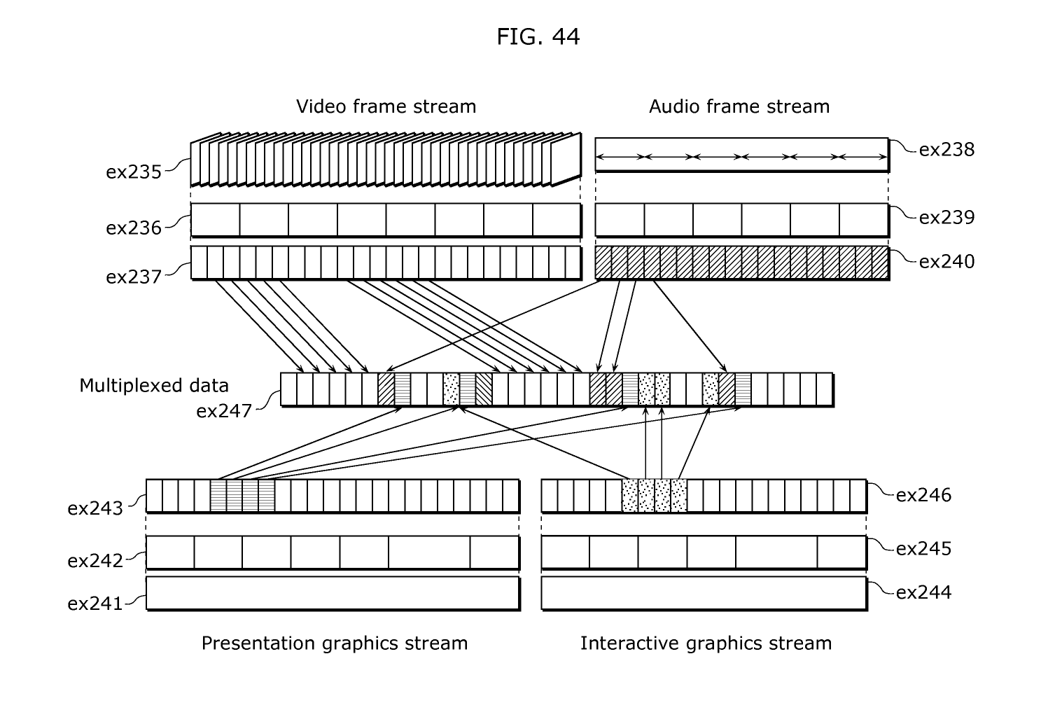

FIG. 44 schematically illustrates how data is multiplexed. First, a video stream ex235 composed of video frames and an audio stream ex238 composed of audio frames are transformed into a stream of PES packets ex236 and a stream of PES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

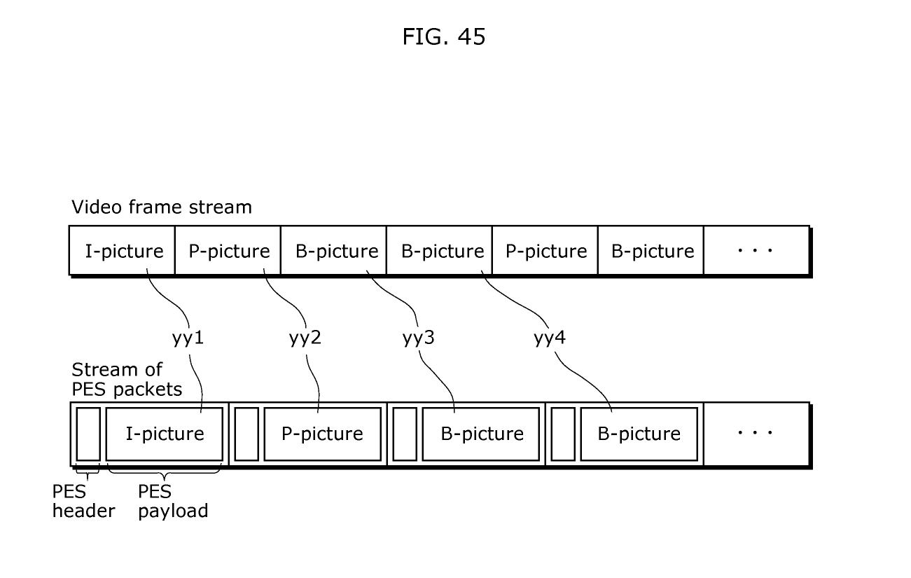

FIG. 45 illustrates how a video stream is stored in a stream of PES packets in more detail. The first bar in FIG. 45 shows a video frame stream in a video stream. The second bar shows the stream of PES packets. As indicated by arrows denoted as yy1, yy2, yy3, and yy4 in FIG. 45, the video stream is divided into pictures as I pictures, B pictures, and P pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

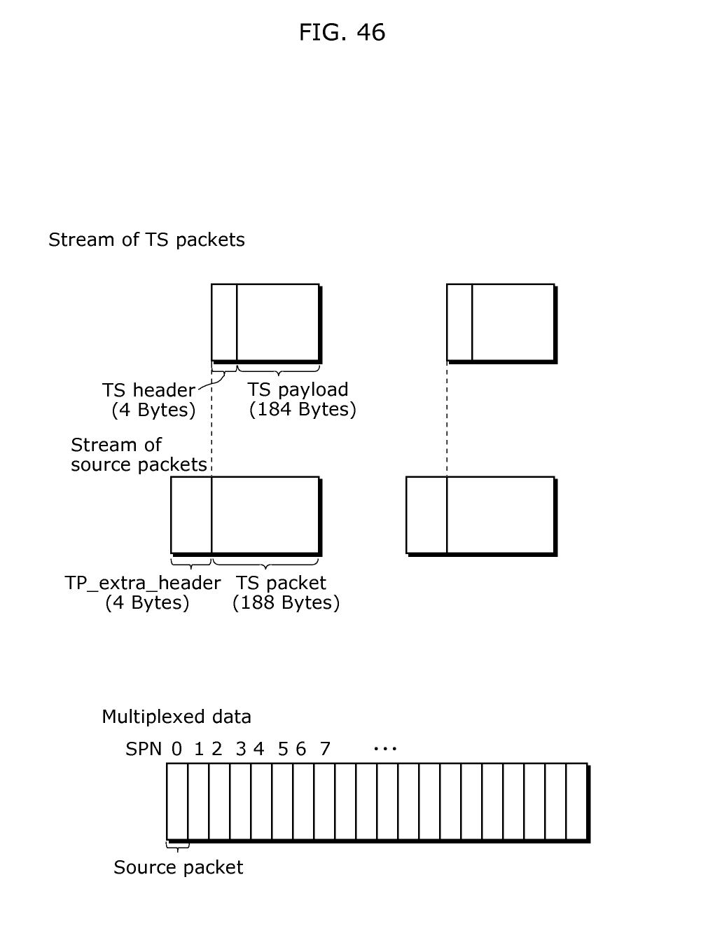

FIG. 46 illustrates a format of TS packets to be finally written on the multiplexed data. Each of the TS packets is a 188-byte fixed length packet including a 4-byte TS header having information, such as a PID for identifying a stream and a 184-byte TS payload for storing data. The PES packets are divided, and stored in the TS payloads, respectively. When a BD ROM is used, each of the TS packets is given a 4-byte TP_Extra_Header, thus resulting in 192-byte source packets. The source packets are written on the multiplexed data. The TP_Extra_Header stores information such as an Arrival_Time_Stamp (ATS). The ATS shows a transfer start time at which each of the TS packets is to be transferred to a PID filter. The source packets are arranged in the multiplexed data as shown at the bottom of FIG. 46. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information of the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

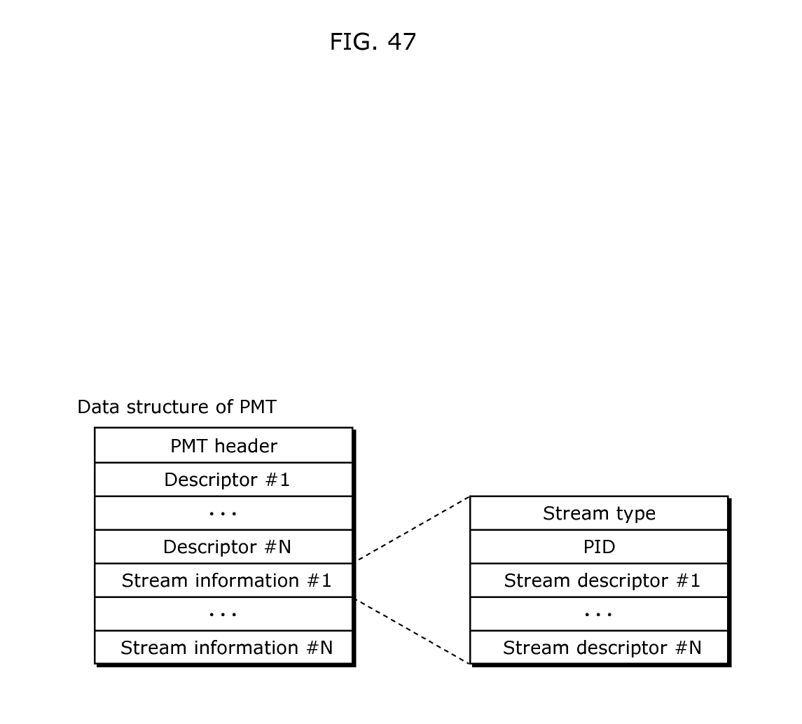

FIG. 47 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data.

When the multiplexed data is recorded on a recording medium and others, it is recorded together with multiplexed data information files.

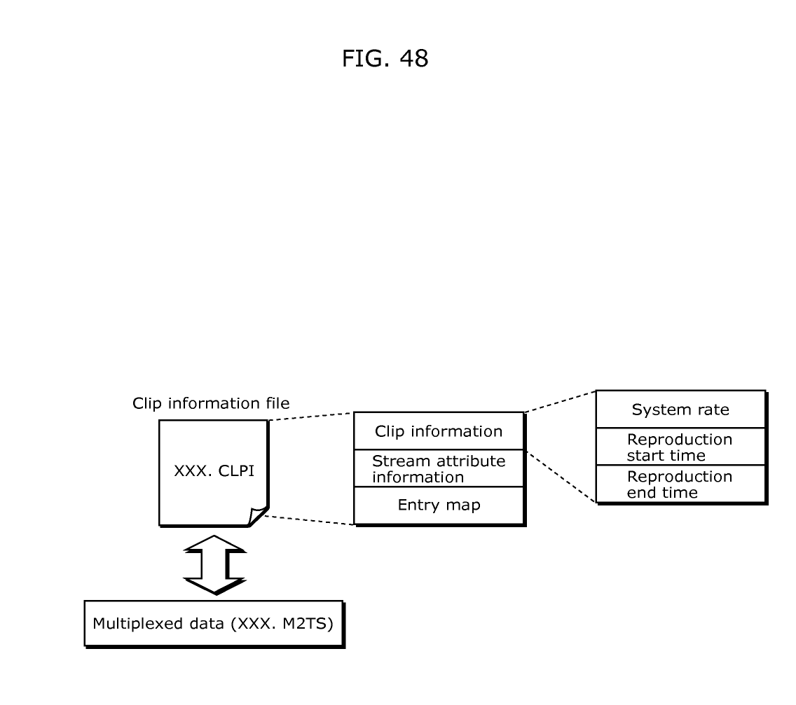

Each of the multiplexed data information files is management information of the multiplexed data as shown in FIG. 48. The multiplexed data information files are in one to one correspondence with the multiplexed data, and each of the files includes multiplexed data information, stream attribute information, and an entry map.

As illustrated in FIG. 48, the multiplexed data information includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

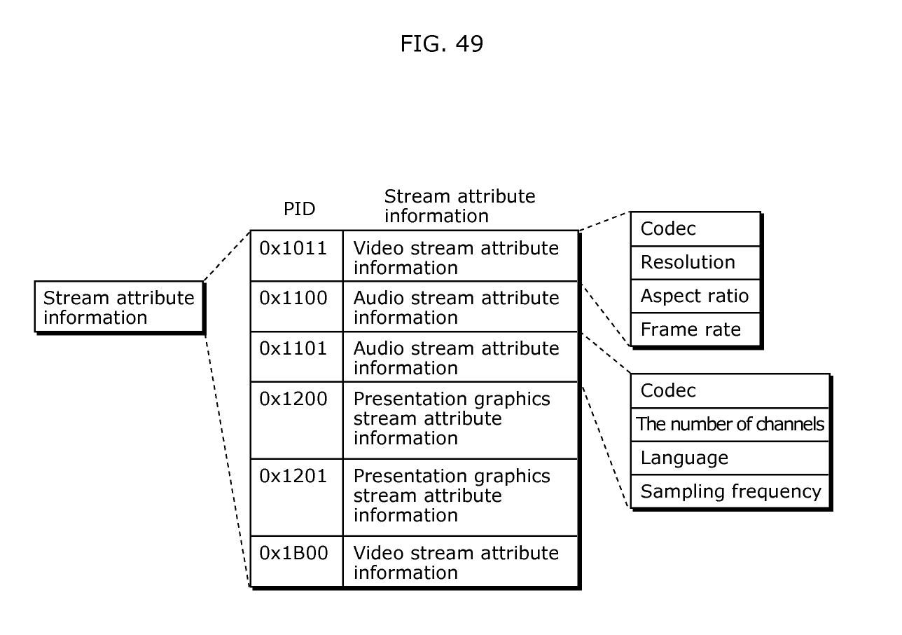

As shown in FIG. 49, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information including what kind of compression codec is used for compressing the audio stream, how many channels are included in the audio stream, which language the audio stream supports, and how high the sampling frequency is. The video stream attribute information and the audio stream attribute information are used for initialization of a decoder before the player plays back the information.

In the present embodiment, the multiplexed data to be used is of a stream type included in the PMT. Furthermore, when the multiplexed data is recorded on a recording medium, the video stream attribute information included in the multiplexed data information is used. More specifically, the moving picture coding method or the moving picture coding apparatus described in each of embodiments includes a step or a unit for allocating unique information indicating video data generated by the moving picture coding method or the moving picture coding apparatus in each of embodiments, to the stream type included in the PMT or the video stream attribute information. With the configuration, the video data generated by the moving picture coding method or the moving picture coding apparatus described in each of embodiments can be distinguished from video data that conforms to another standard.

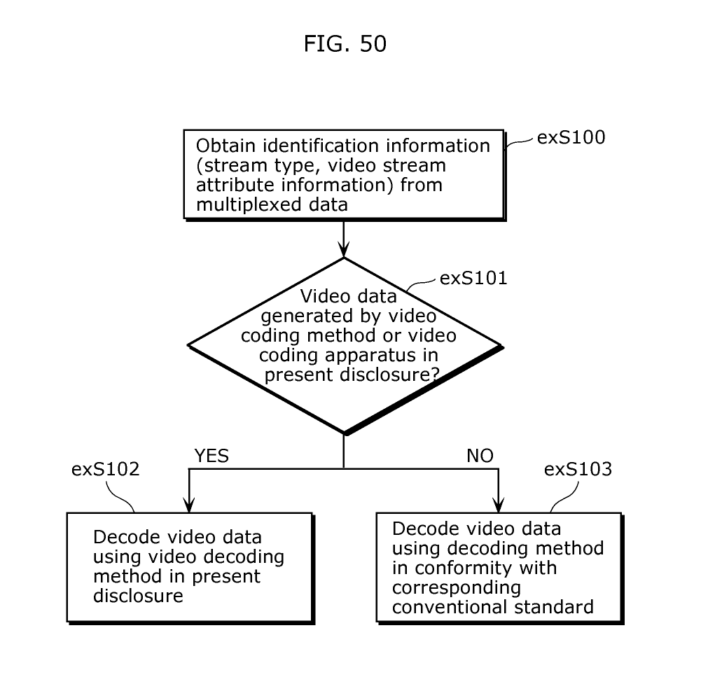

Furthermore, FIG. 50 illustrates steps of the moving picture decoding method according to the present embodiment. In Step exS100, the stream type included in the PMT or the video stream attribute information included in the multiplexed data information is obtained from the multiplexed data. Next, in Step exS101, it is determined whether or not the stream type or the video stream attribute information indicates that the multiplexed data is generated by the moving picture coding method or the moving picture coding apparatus in each of embodiments. When it is determined that the stream type or the video stream attribute information indicates that the multiplexed data is generated by the moving picture coding method or the moving picture coding apparatus in each of embodiments, in Step exS102, decoding is performed by the moving picture decoding method in each of embodiments. Furthermore, when the stream type or the video stream attribute information indicates conformance to the conventional standards, such as MPEG-2, MPEG-4 AVC, and VC-1, in Step exS103, decoding is performed by a moving picture decoding method in conformity with the conventional standards.

As such, allocating a new unique value to the stream type or the video stream attribute information enables determination whether or not the moving picture decoding method or the moving picture decoding apparatus that is described in each of embodiments can perform decoding. Even when multiplexed data that conforms to a different standard is input, an appropriate decoding method or apparatus can be selected. Thus, it becomes possible to decode information without any error. Furthermore, the moving picture coding method or apparatus, or the moving picture decoding method or apparatus in the present embodiment can be used in the devices and systems described above.

### Embodiment 7

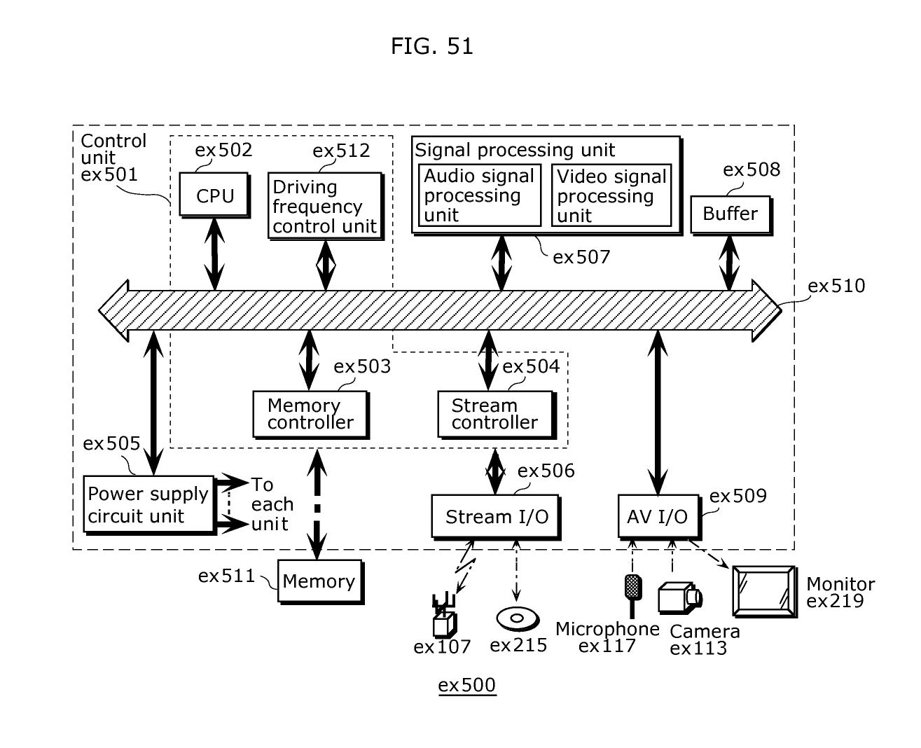

Each of the moving picture coding method, the moving picture coding apparatus, the moving picture decoding method, and the moving picture decoding apparatus in each of embodiments is typically achieved in the form of an integrated circuit or a Large Scale Integrated (LSI) circuit. As an example of the LSI, FIG. 51 illustrates a configuration of the LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when coding is performed, the LSI ex500 receives an AV signal from a microphone ex117, a camera ex113, and others through an AV 10 ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the processing amount and speed to be transmitted to a signal processing unit ex507. Then, the signal processing unit ex507 codes an audio signal and/or a video signal. Here, the coding of the video signal is the coding described in each of embodiments. Furthermore, the signal processing unit ex507 sometimes multiplexes the coded audio data and the coded video data, and a stream IQ ex506 provides the multiplexed data outside. The provided multiplexed data is transmitted to the base station ex107, or written on the recording medium ex215. When data sets are multiplexed, the data should be temporarily stored in the buffer ex508 so that the data sets are synchronized with each other.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

Furthermore, although the control unit ex501 includes the CPU ex502, the memory controller ex503, the stream controller ex504, the driving frequency control unit ex512, the configuration of the control unit ex501 is not limited to such. For example, the signal processing unit ex507 may further include a CPU. Inclusion of another CPU in the signal processing unit ex507 can improve the processing speed. Furthermore, as another example, the CPU ex502 may serve as or be a part of the signal processing unit ex507, and, for example, may include an audio signal processing unit. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose.

In the future, with advancement in semiconductor technology, a brand-new technology may replace LSI. The functional blocks can be integrated using such a technology. The possibility is that the present disclosure is applied to biotechnology.

### Embodiment 8

When video data generated in the moving picture coding method or by the moving picture coding apparatus described in each of embodiments is decoded, compared to when video data that conforms to a conventional standard, such as MPEG-2, MPEG-4 AVC, and VC-1 is decoded, the processing amount probably increases. Thus, the LSI ex500 needs to be set to a driving frequency higher than that of the CPU ex502 to be used when video data in conformity with the conventional standard is decoded. However, when the driving frequency is set higher, there is a problem that the power consumption increases.

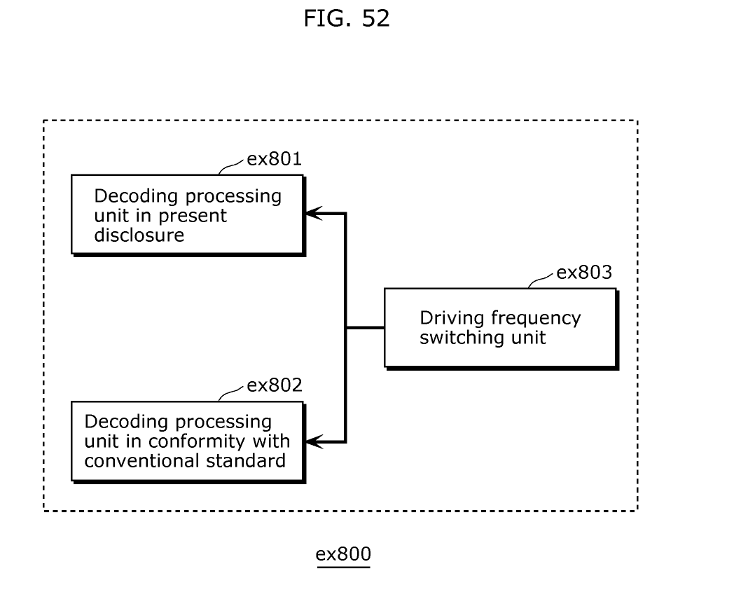

In order to solve the problem, the moving picture decoding apparatus, such as the television ex300 and the LSI ex500 is configured to determine to which standard the video data conforms, and switch between the driving frequencies according to the determined standard. FIG. 52 illustrates a configuration ex800 in the present embodiment. A driving frequency switching unit ex803 sets a driving frequency to a higher driving frequency when video data is generated by the moving picture coding method or the moving picture coding apparatus described in each of embodiments. Then, the driving frequency switching unit ex803 instructs a decoding processing unit ex801 that executes the moving picture decoding method described in each of embodiments to decode the video data. When the video data conforms to the conventional standard, the driving frequency switching unit ex803 sets a driving frequency to a lower driving frequency than that of the video data generated by the moving picture coding method or the moving picture coding apparatus described in each of embodiments. Then, the driving frequency switching unit ex803 instructs the decoding processing unit ex802 that conforms to the conventional standard to decode the video data.

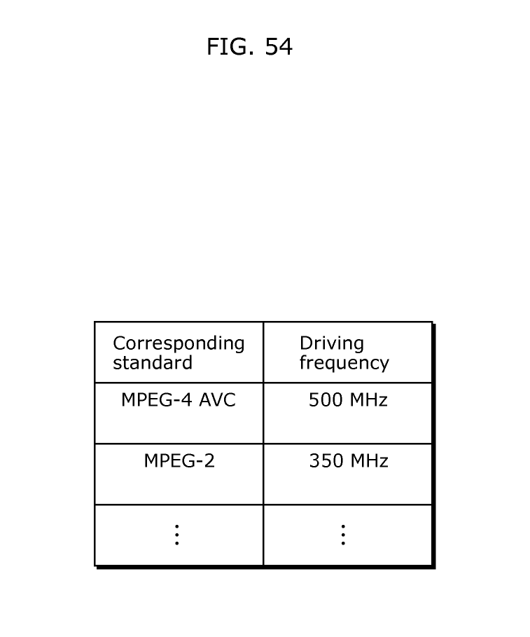

More specifically, the driving frequency switching unit ex803 includes the CPU ex502 and the driving frequency control unit ex512 in FIG. 51. Here, each of the decoding processing unit ex801 that executes the moving picture decoding method described in each of embodiments and the decoding processing unit ex802 that conforms to the conventional standard corresponds to the signal processing unit ex507 in FIG. 51. The CPU ex502 determines to which standard the video data conforms. Then, the driving frequency control unit ex512 determines a driving frequency based on a signal from the CPU ex502. Furthermore, the signal processing unit ex507 decodes the video data based on the signal from the CPU ex502. For example, the identification information described in Embodiment 6 is probably used for identifying the video data. The identification information is not limited to the one described in Embodiment 6 but may be any information as long as the information indicates to which standard the video data conforms. For example, when which standard video data conforms to can be determined based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 54. The driving frequency can be selected by storing the look-up table in the buffer ex508 and in an internal memory of an LSI, and with reference to the look-up table by the CPU ex502.

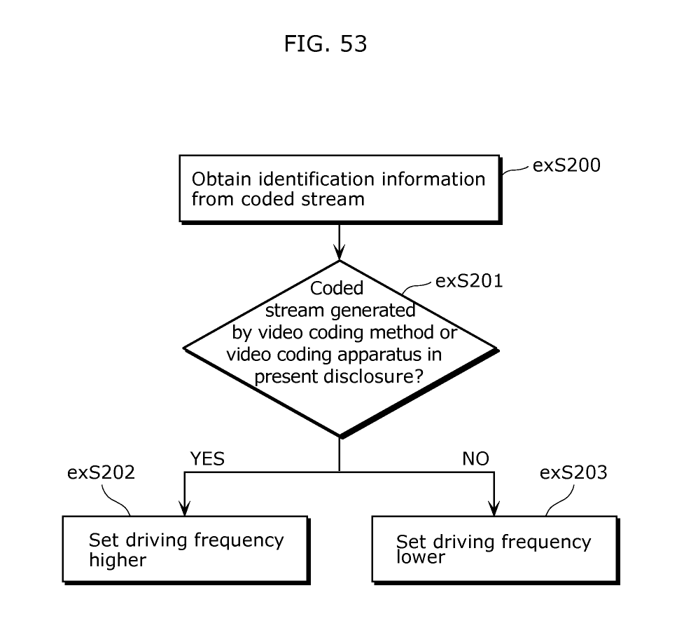

FIG. 53 illustrates steps for executing a method in the present embodiment. First, in Step exS200, the signal processing unit ex507 obtains identification information from the multiplexed data. Next, in Step exS201, the CPU ex502 determines whether or not the video data is generated by the coding method and the coding apparatus described in each of embodiments, based on the identification information. When the video data is generated by the moving picture coding method and the moving picture coding apparatus described in each of embodiments, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, MPEG-4 AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the moving picture coding method and the moving picture coding apparatus described in each of embodiment.

Furthermore, along with the switching of the driving frequencies, the power conservation effect can be improved by changing the voltage to be applied to the LSI ex500 or an apparatus including the LSI ex500. For example, when the driving frequency is set lower, the voltage to be applied to the LSI ex500 or the apparatus including the LSI ex500 is probably set to a voltage lower than that in the case where the driving frequency is set higher.

Furthermore, when the processing amount for decoding is larger, the driving frequency may be set higher, and when the processing amount for decoding is smaller, the driving frequency may be set lower as the method for setting the driving frequency. Thus, the setting method is not limited to the ones described above. For example, when the processing amount for decoding video data in conformity with MPEG-4 AVC is larger than the processing amount for decoding video data generated by the moving picture coding method and the moving picture coding apparatus described in each of embodiments, the driving frequency is probably set in reverse order to the setting described above.

Furthermore, the method for setting the driving frequency is not limited to the method for setting the driving frequency lower. For example, when the identification information indicates that the video data is generated by the moving picture coding method and the moving picture coding apparatus described in each of embodiments, the voltage to be applied to the LSI ex500 or the apparatus including the LSI ex500 is probably set higher. When the identification information indicates that the video data conforms to the conventional standard, such as MPEG-2, MPEG-4 AVC, and VC-1, the voltage to be applied to the LSI ex500 or the apparatus including the LSI ex500 is probably set lower. As another example, when the identification information indicates that the video data is generated by the moving picture coding method and the moving picture coding apparatus described in each of embodiments, the driving of the CPU ex502 does not probably have to be suspended. When the identification information indicates that the video data conforms to the conventional standard, such as MPEG-2, MPEG-4 AVC, and VC-1, the driving of the CPU ex502 is probably suspended at a given time because the CPU ex502 has extra processing capacity. Even when the identification information indicates that the video data is generated by the moving picture coding method and the moving picture coding apparatus described in each of embodiments, in the case where the CPU ex502 has extra processing capacity, the driving of the CPU ex502 is probably suspended at a given time. In such a case, the suspending time is probably set shorter than that in the case where when the identification information indicates that the video data conforms to the conventional standard, such as MPEG-2, MPEG-4 AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

### Embodiment 9

There are cases where a plurality of video data that conforms to different standards, is provided to the devices and systems, such as a television and a cellular phone. In order to enable decoding the plurality of video data that conforms to the different standards, the signal processing unit ex507 of the LSI ex500 needs to conform to the different standards. However, the problems of increase in the scale of the circuit of the LSI ex500 and increase in the cost arise with the individual use of the signal processing units ex507 that conform to the respective standards.

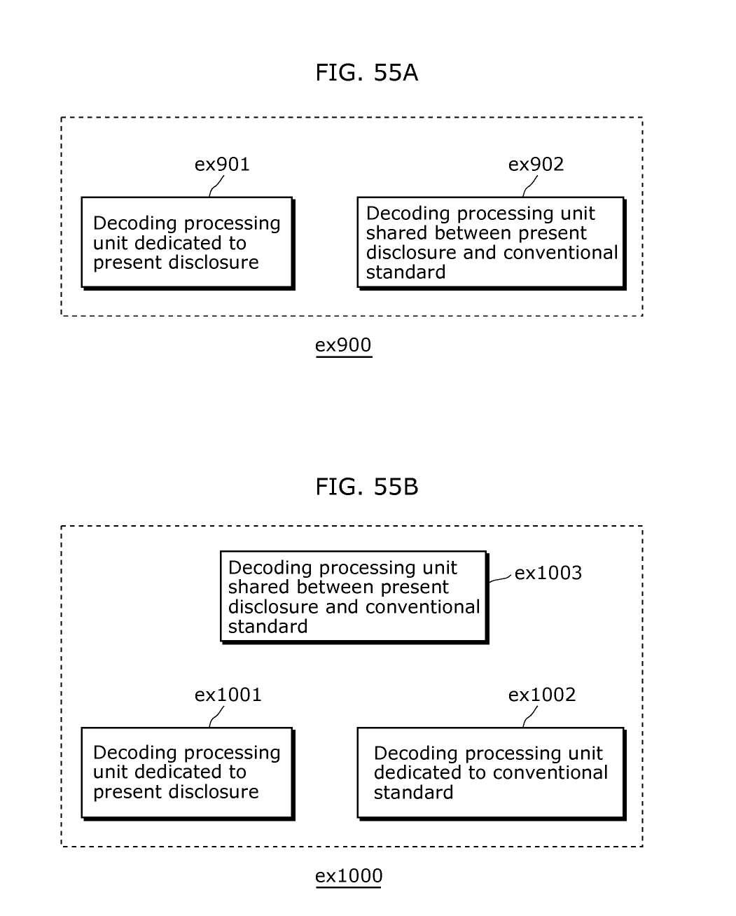

In order to solve the problem, what is conceived is a configuration in which the decoding processing unit for implementing the moving picture decoding method described in each of embodiments and the decoding processing unit that conforms to the conventional standard, such as MPEG-2, MPEG-4 AVC, and VC-1 are partly shared. Ex900 in FIG. 55A shows an example of the configuration. For example, the moving picture decoding method described in each of embodiments and the moving picture decoding method that conforms to MPEG-4 AVC have, partly in common, the details of processing, such as entropy coding, inverse quantization, deblocking filtering, and motion compensated prediction. The details of processing to be shared probably include use of a decoding processing unit ex902 that conforms to MPEG-4 AVC. In contrast, a dedicated decoding processing unit ex901 is probably used for other processing unique to an aspect of the present disclosure. Since the aspect of the present disclosure is characterized by inverse quantization in particular, for example, the dedicated decoding processing unit ex901 is used for inverse quantization. Otherwise, the decoding processing unit is probably shared for one of the entropy decoding, deblocking filtering, and motion compensation, or all of the processing. The decoding processing unit for implementing the moving picture decoding method described in each of embodiments may be shared for the processing to be shared, and a dedicated decoding processing unit may be used for processing unique to that of MPEG-4 AVC.

Furthermore, ex1000 in FIG. 55B shows another example in that processing is partly shared. This example uses a configuration including a dedicated decoding processing unit ex1001 that supports the processing unique to an aspect of the present disclosure, a dedicated decoding processing unit ex1002 that supports the processing unique to another conventional standard, and a decoding processing unit ex1003 that supports processing to be shared between the moving picture decoding method according to the aspect of the present disclosure and the conventional moving picture decoding method. Here, the dedicated decoding processing units ex1001 and ex1002 are not necessarily specialized for the processing according to the aspect of the present disclosure and the processing of the conventional standard, respectively, and may be the ones capable of implementing general processing. Furthermore, the configuration of the present embodiment can be implemented by the LSI ex500.

As such, reducing the scale of the circuit of an LSI and reducing the cost are possible by sharing the decoding processing unit for the processing to be shared between the moving picture decoding method according to the aspect of the present disclosure and the moving picture decoding method in conformity with the conventional standard.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The image coding method and image decoding method according to an aspect of the present disclosure is advantageously applicable to a moving picture coding method and a moving picture decoding method.

1. An image coding method of merging, into coding information of a current block to be coded in a moving picture, coding information of a coded block which is one of blocks in the moving picture and is other than the current block, to code the current block, the coding information including a motion vector and a reference picture index, the method comprising:
determining one or more blocks usable for the merging as one or more merging candidates, based on a spatial position or a temporal position of the current block;
generating, for each of the merging candidates, a prediction image of the current block using coding information of the merging candidate and comparing costs of the prediction images to determine a block to be used for coding the current block from the one or more merging candidates;
coding the current block using the coding information of the block determined in the generating of a prediction image to generate a bitstream including the coded current block; and
attaching, to the bitstream, a merging candidate index indicating the block determined in the generating of a prediction image,
wherein in the generating of a prediction image, when a motion compensation size of the current block is a bi-prediction-prohibited size and the one or more merging candidates include a merging candidate coded using bi-prediction with reference to two pictures, the prediction image of the current block is generated using coding information for uni-prediction of the merging candidate coded using bi-prediction instead of coding information for the bi-prediction of the merging candidate coded using bi-prediction, the uni-prediction being performed with reference to one picture.

2. The image coding method according to claim 1,
wherein in the determining of one or more blocks as one or more merging candidates,
a list which lists coding information of each of the one or more determined merging candidates is generated, and
in the generating of a prediction image,
when the one or more determined merging candidates include a merging candidate coded using uni-prediction, the prediction image of the current block is generated using the coding information which is listed in the list and is for the uni-prediction of the merging candidate coded using uni-prediction, and
when the one or more determined merging candidates include a merging candidate coded using bi-prediction, the coding information which is listed in the list and is for the bi-prediction of the merging candidate coded using bi-prediction is converted into coding information for uni-prediction of the merging candidate coded using bi-prediction, and the prediction image of the current block is generated using the coding information for uni-prediction of the merging candidate coded using bi-prediction.

3. The image coding method according to claim 1,
wherein in the determining of one or more blocks as one or more merging candidates,
when the determined one or more merging candidates include a merging candidate coded using bi-prediction, coding information for the bi-prediction of the merging candidate coded using bi-prediction is converted into coding information for uni-prediction of the merging candidate coded using bi-prediction to generate a list which lists coding information of each of the one or more determined merging candidates and in which the coding information for the bi-prediction is not included, and
in the generating of a prediction image,
the prediction image of the current block is generated for each of the merging candidates using the coding information of the merging candidate listed in the list.

4. The image coding method according to claim 1,
wherein when the uni-prediction is available in two types of first uni-prediction and second uni-prediction distinguished according to a predetermined condition, the coding information for the bi-prediction of the merging candidate coded using bi-prediction includes coding information for the first uni-prediction and coding information for the second uni-prediction, and
when the one or more merging candidates includes a plurality of the merging candidates coded using bi-prediction,
in the determining of one or more blocks or in the generating of a prediction image, only the coding information for the first uni-prediction or the coding information for the second uni-prediction of included in coding information for bi-prediction of the plurality of the merging candidates is used for the generating of the prediction images of the current block.

5. The image coding method according to claim 1,
further comprising
determining whether it is true or false that the motion compensation size of the current block is the bi-prediction-prohibited size and the one or more merging candidates include a merging candidate coded using bi-prediction,
wherein in the determining of whether it is true or false,
it is determined that the motion compensation size of the current block is the bi-prediction-prohibited size when the motion compensation size of the current block is smaller than or equal to a predetermined size.

6. The image coding method according to claim 5,
wherein in the determining of whether it is true or false,
it is determined that the motion compensation size of the current block is the bi-prediction-prohibited size when a sum of a width and a height of the current block is equal to a predetermined value.

7. The image coding method according to claim 6,
wherein in the determining of whether it is true or false,
it is determined that the motion compensation size of the current block is the bi-prediction-prohibited size when the motion compensation size of the current block is a size of 4×8 pixels or a size of 8×4 pixels.

8. An image decoding method of merging, into coding information of a current block to be decoded in a bitstream, coding information of a decoded block which is one of blocks in the bitstream and is other than the current block, to decode the current block, the coding information including a motion vector and a reference picture index, the method comprising:
extracting a merging candidate index from the bitstream;
determining one or more blocks usable for the merging as one or more merging candidates, based on a spatial position or a temporal position of the current block;
determining, from the one or more determined merging candidates, a block indicated by the merging candidate index extracted in the extracting;
generating a prediction image of the current block using coding information of the block determined in the determining of a block, and decoding the current block using the prediction image to generate a decoded image including the decoded current block,
wherein in the generating of a prediction image, when a motion compensation size of the current block is a bi-prediction-prohibited size and the block determined in the determining of a block has been decoded using bi-prediction with reference to two pictures, the prediction image of the current block is generated using coding information for uni-prediction of the block decoded using bi-prediction instead of coding information for the bi-prediction of the block decoded using bi-prediction, the uni-prediction being performed with reference to one picture.

9. An image coding apparatus which performs the image coding method according to claim 1.

10. An image decoding apparatus which performs the image decoding method according to claim 8.

11. An image coding and decoding apparatus comprising:
an image coding apparatus which merges, into coding information of a current block to be coded in a moving picture, coding information of a coded block which is one of blocks in the moving picture and is other than the current block, to code the current block, the coding information including a motion vector and a reference picture index; and
the image decoding apparatus according to claim 10 which decodes the moving picture coded by the image coding apparatus,
the image coding apparatus including:
a candidate determination unit configured to determine one or more blocks usable for the merging as one or more merging candidates, based on a spatial position or a temporal position of the current block;
a block determination unit configured to generate, for each of the merging candidates, a prediction image of the current block using coding information of the merging candidate and compare costs of the prediction images to determine a block to be used for coding the current block from the one or more merging candidates;
a coding unit configured to code the current block using the coding information of the block determined by the block determination unit to generate a bitstream including the coded current block; and
an attaching unit configured to attach, to the bitstream, a merging candidate index indicating the block determined by the block determination unit,
wherein when a motion compensation size of the current block is a bi-prediction-prohibited size and the one or more merging candidates include a merging candidate coded using bi-prediction with reference to two pictures, the block determination unit is configured to generate the prediction image of the current block using coding information for uni-prediction of the merging candidate coded using bi-prediction instead of coding information for the bi-prediction of the merging candidate coded using bi-prediction, the uni-prediction being performed with reference to one picture.
